(19) United States
(12) Patent Application Publication
(10) Pub. No.: US 2026/0339308 A1
(43) Pub. Date: Oct. 29, 2026

(54) SYSTEMS AND METHODS FOR RETRIEVAL-AUGMENTED-GENERATION BASED INTELLIGENCE EXTRACTION FROM UNSTRUCTURED DATA FOR ANOMALY DETECTION

(71) Applicant: SAS Institute Inc., Cary, NC (US)

(72) Inventor: Saurabh Mishra, Cary, NC (US)

(73) Assignee: SAS Institute Inc., Cary, NC (US)

(21) Appl. No.: 19/441,171

(22) Filed: Jan. 6, 2026

Related U.S. Application Data
(60) Provisional application No. 63/796,139, filed on Apr. 28, 2025.

(51) Int. Cl. G05B 23/02

(52) U.S. Cl. CPC G05B 23/0229; G05B 23/027

(57) ABSTRACT

A system, method, and computer-program product includes obtaining sensor data captured by a set of sensors associated with an industrial asset, generating, by an anomaly detection algorithm, an asset alert that indicates the industrial asset is operating or will operate in an anomalous state based on the anomaly detection algorithm assessing the sensor data, extracting, from the asset alert, alert metadata indicative of an operating state of the industrial asset at a time the anomaly detection algorithm generated the asset alert, and adapting the asset alert to an enriched asset alert that includes one or more components of the industrial asset contributing to the anomalous state and one or more recommended asset maintenance tasks.

### CROSS-REFERENCE TO RELATED APPLICATIONS

This application claims the benefit of U.S. Provisional Application No. 63/796,139, filed on 28 Apr. 2025, which is incorporated in its entirety by this reference.

### TECHNICAL FIELD

This invention relates generally to the machine-learning field, and more specifically, to new and useful systems and methods for generating, enriching, and processing machine-interpretable diagnostic information derived from anomaly detection models to support automated assessment and remediation of anomalous operating states of industrial assets.

### BACKGROUND

In traditional industrial monitoring environments, systems rely on streams of sensor data to evaluate the operational health of equipment deployed in manufacturing plants, energy facilities, and other industrial settings. However, existing monitoring systems frequently generate limited diagnostic information when detecting abnormal behavior.

Therefore, there is a need in the art for improved systems and methods that enhance the interpretability and diagnostic utility of outputs generated during industrial monitoring. The embodiments of the present application provide technical solutions that address, at least, the needs described above, as well as the deficiencies of the state of the art.

### BRIEF SUMMARY OF THE EMBODIMENTS

In one embodiment, a computer-program product including a non-transitory machine-readable storage medium storing computer instructions that, when executed by one or more processors, perform operations including obtaining sensor data captured by a set of sensors associated with an industrial asset; generating, by an anomaly detection algorithm, an asset alert that indicates the industrial asset is operating or will operate in an anomalous state based on the anomaly detection algorithm assessing the sensor data; extracting, from the asset alert, alert metadata indicative of an operating state of the industrial asset at a time the anomaly detection algorithm generated the asset alert; in response to extracting the alert metadata from the asset alert: constructing an asset diagnostic prompt that includes the alert metadata and a set of model instructions instructing a large language model to perform a diagnostic assessment of the anomalous state; querying one or more asset maintenance data collections based on an embedding value of the asset diagnostic prompt; retrieving, from the one or more asset maintenance data collections, a set of asset maintenance data items related to the asset diagnostic prompt in response to the querying of the one or more asset maintenance data collections; and generating, based on providing the asset diagnostic prompt and the set of asset maintenance data items to the large language model, an asset diagnostic inference that includes (i) one or more components of the industrial asset contributing to the anomalous state and (ii) one or more recommended asset maintenance tasks for mitigating the anomalous state; and adapting the asset alert to an enriched asset alert that includes the one or more components of the industrial asset contributing to the anomalous state and the one or more recommended asset maintenance tasks. In one embodiment, the computer instructions, when executed by the one or more processors, perform operations further comprising after configuring the natural language-to-search query machine learning model: receiving a natural language input specifying a subject data asset retrieval request; transforming, using the natural language-to-search query machine learning model, the natural language input to a computer-executable search query encoded in the search syntax of the target data query language; and retrieving at least one data asset that satisfies the subject data asset retrieval request in response to executing the computer-executable search query.

In one embodiment, the industrial asset corresponds to a physical apparatus operably configured to perform one or more tasks in a real-world environment, the industrial asset includes a set of mechanical components, a set of electrical components, and a set of digitally controlled components that operate together to perform the one or more tasks in the real-world environment, and the one or more components of the industrial asset contributing to the anomalous state includes at least one mechanical component of the set of mechanical components or at least one electrical component of the set of electrical components.

In one embodiment, the computer instructions, when executed by the one or more processors, perform operations further comprising: in response to adapting the asset alert to the enriched asset alert, transmitting, over a computer network, the enriched asset alert to a target entity when the one or more recommended asset maintenance tasks included in the enriched asset alert fails to satisfy automated maintenance criteria.

In one embodiment, the computer instructions, when executed by the one or more processors, perform operations further comprising: assessing the one or more recommended asset maintenance tasks generated for the industrial asset against a corpus of automated maintenance task types; detecting that a maintenance task type of the one or more recommended asset maintenance tasks corresponds to a respective automated maintenance task type included in the corpus of automated maintenance task types; and in response to detecting the maintenance task type of the one or more recommended asset maintenance tasks corresponds to the respective automated maintenance task type, automatically executing, using a programmable controller of the industrial asset, the one or more recommended asset maintenance tasks generated for the industrial asset.

In one embodiment, at least one sensor of the set of sensors is operably configured to measure a target attribute of the industrial asset, the sensor data indicates that the target attribute was measured at a first value at the time the anomaly detection algorithm generated the asset alert, one of the one or more recommended asset maintenance tasks generated for the industrial asset relates to changing the target attribute of the industrial asset from the first value to a target value, and in response to executing the one of the one or more recommended asset maintenance tasks, a component setting of at least one component of the one or more components is automatically adjusted to change the target attribute of the industrial asset from operating at the first value to the target value.

In one embodiment, wherein extracting the alert metadata from the asset alert includes: instantiating a metadata selection user interface that displays a plurality of distinct pieces of alert metadata included in the asset alert when a total number of the plurality of distinct pieces of alert metadata included in the asset alert exceeds a predetermined metadata count threshold; and detecting one or more user inputs selecting a subset of the plurality of distinct pieces of alert metadata displayed on the metadata selection user interface, wherein a total number of pieces of alert metadata included in the subset is less than the total number of the plurality of distinct pieces of alert metadata included in the asset alert, wherein: the alert metadata indicative of the operating state of the industrial asset corresponds to the subset selected by the one or more user inputs; and the asset diagnostic prompt is automatically constructed in response to detecting the one or more user inputs.

In one embodiment, extracting the alert metadata from the asset alert includes: determining that the asset alert generated by the anomaly detection algorithm corresponds to a respective asset alert type of a plurality of predefined asset alert types; querying an asset alert type-to-asset diagnostic prompt data table using the respective asset alert type of the asset alert as a query parameter, wherein the asset alert type-to-asset diagnostic prompt data table associates each distinct asset alert type of the plurality of predefined asset alert types to a distinct set of prompt construction instructions; and retrieving, from the asset alert type-to-asset diagnostic prompt data table, the distinct set of prompt construction instructions corresponding to the respective asset alert type of the asset alert in response to the querying of the asset alert type-to-asset diagnostic prompt data table; and the asset diagnostic prompt is automatically constructed according to the distinct set of prompt construction instructions retrieved from the asset alert type-to-asset diagnostic prompt data table that corresponds to the respective asset alert type of the asset alert.

In one embodiment, the distinct set of prompt construction instructions retrieved from the asset alert type-to-asset diagnostic prompt data table that corresponds to the respective asset alert type of the asset alert includes: the set of model instructions that instruct the large language model to perform the diagnostic assessment of the anomalous state, and a set of metadata extraction instructions that specifies the alert metadata to extract from the asset alert.

In one embodiment, extracting the alert metadata from the asset alert includes: determining that the asset alert generated by the anomaly detection algorithm corresponds to a respective asset alert type of a plurality of predefined asset alert types; querying an asset alert type-to-asset diagnostic prompt template repository using the respective asset alert type of the asset alert as a query parameter, wherein the asset alert type-to-asset diagnostic prompt template repository associates each distinct asset alert type of the plurality of predefined asset alert types to a distinct asset diagnostic prompt template; and retrieving, from the asset alert type-to-asset diagnostic prompt template repository, the distinct asset diagnostic prompt template that corresponds to the respective asset alert type of the asset alert in response to the querying of the asset alert type-to-asset diagnostic prompt template repository; and the asset diagnostic prompt is automatically constructed based in part on the distinct asset diagnostic prompt template retrieved from the asset alert type-to-asset diagnostic prompt template repository that corresponds to the respective asset alert type of the asset alert.

In one embodiment, the distinct asset diagnostic prompt template retrieved from the asset alert type-to-asset diagnostic prompt template repository that corresponds to the respective asset alert type of the asset alert includes: the set of model instructions that instruct the large language model to perform the diagnostic assessment of the anomalous state, and a set of asset diagnostic input data fields, wherein each distinct asset diagnostic input data field of the set of asset diagnostic input data fields is associated with a respective operating characteristic of the industrial asset, and the asset diagnostic prompt is automatically constructed by inserting a corresponding sensor value included in the alert metadata into each asset diagnostic input data field of the set of asset diagnostic input data fields.

In one embodiment, the one or more asset maintenance data collections include: a maintenance manual data collection that includes a tokenized representation of one or more unstructured maintenance manuals created for the industrial asset and an embedding-based representation of the one or more unstructured maintenance manuals, a maintenance record data collection that includes a tokenized representation of a plurality of historical unstructured maintenance events performed on the industrial asset and an embedding-based representation of the plurality of historical unstructured maintenance events, and a crowd-sourced data collection that includes a tokenized representation of content sourced from one or more web-based discussion platforms associated with diagnosing, troubleshooting, and repairing the industrial asset and an embedding-based representation of the content sourced from the one or more web-based discussion platforms.

In one embodiment, the content sourced from the one or more web-based discussion platforms is not documented in the one or more unstructured maintenance manuals.

In one embodiment, the computer instructions, when executed by the one or more processors, perform operations further comprising: transmitting, using an application programming interface (API), the asset diagnostic prompt to an alert enrichment service; and in response to the alert enrichment service receiving the asset diagnostic prompt, querying the one or more asset maintenance data collections, wherein querying the one or more asset maintenance data collections includes: transmitting, to a first distinct API endpoint associated with the maintenance manual data collection, a first alert enrichment request to query the maintenance manual data collection based on the embedding value of the asset diagnostic prompt; transmitting, to a second distinct API endpoint associated with the maintenance record data collection, a second alert enrichment request to query the maintenance record data collection based on the embedding value of the asset diagnostic prompt; and transmitting, to a third distinct API endpoint associated with the crowd-sourced data collection, a third alert enrichment request to query the crowd-sourced data collection based on the embedding value of the asset diagnostic prompt.

In one embodiment, the computer instructions, when executed by the one or more processors, perform operations further comprising: in response to transmitting the first alert enrichment request to the first distinct API endpoint, retrieving a set of maintenance manual data items included in the maintenance manual data collection that relate to the asset diagnostic prompt, in response to transmitting the second alert enrichment request to the second distinct API endpoint, retrieving a set of maintenance record data items included in the maintenance record data collection that relate to the asset diagnostic prompt, and in response to transmitting the third alert enrichment request to the third distinct API endpoint, retrieving a set of crowd-sourced data items included in the crowd-sourced data collection that relate to the asset diagnostic prompt, wherein the set of asset maintenance data items related to the asset diagnostic prompt includes the set of maintenance manual data items, the set of maintenance record data items, and the set of crowd-sourced data items.

In one embodiment, the computer instructions, when executed by the one or more processors, perform operations further comprising: instantiating an asset diagnostic graphical user interface that includes: the alert metadata indicative of the operating state of the industrial asset at the time the anomaly detection algorithm generated the asset alert, the one or more components of the industrial asset contributing to the anomalous state, the one or more recommended asset maintenance tasks for mitigating the anomalous state, and a source identification data table that indicates, for each component of the one or more components of the industrial asset contributing to the anomalous state and each recommended asset maintenance task of the one or more recommended asset maintenance tasks for mitigating the anomalous state, a respective asset maintenance data collection of the one or more asset maintenance data collections used by the large language model to predict that specific component or recommended asset maintenance task.

In one embodiment, the computer instructions, when executed by the one or more processors, perform operations further comprising: receiving, at a digital assistant interface of the asset diagnostic graphical user interface, a natural language query specifying a maintenance-related question associated with the industrial asset; querying the one or more asset maintenance data collections based on an embedding value of the natural language query; retrieving, from the one or more asset maintenance data collections, a corpus of maintenance data items related to the natural language query in response to the querying of the one or more asset maintenance data collections based on the embedding value of the natural language query; generating, based on providing the natural language query and the corpus of maintenance data items to the large language model, a response to the natural language query; and displaying the response generated by the large language model within the digital assistant interface of the asset diagnostic graphical user interface.

In one embodiment, the asset diagnostic inference further includes one or more strings of text specifying a set of suspected root causes contributing to the anomalous state, and the asset diagnostic graphical user interface further includes the set of suspected root causes.

In one embodiment, the computer instructions, when executed by the one or more processors, perform operations further comprising: generating a digital work order in response to assessing the enriched asset alert, wherein: the digital work order includes one or more asset maintenance tasks that, when performed on the industrial asset, mitigates the anomalous state associated with the industrial asset, and a specified time window within which the one or more asset maintenance tasks are to be performed on the industrial asset, and in response to generating the digital work order, transmitting, over a computer network, the digital work order to a target entity to perform the one or more asset maintenance tasks.

In one embodiment, the computer instructions, when executed by the one or more processors, perform operations further comprising: foregoing adapting the asset alert to the enriched asset alert when the asset diagnostic inference generated by the large language model is routed to a second large language model, wherein the second large language model is different than the large language model that generated the asset diagnostic inference; routing, to the second large language model, the asset diagnostic inference generated by the large language model; generating, by the second large language model, a revised asset diagnostic inference in response to the second large language model assessing the asset diagnostic inference generated by the large language model; and augmenting the asset alert to an augmented asset alert based on the revised asset diagnostic inference generated by the second large language model.

In one embodiment, the revised asset diagnostic inference includes a revised set of components contributing to the anomalous state when compared to the one or more components included in the asset diagnostic inference generated by the large language model, the augmented asset alert includes the revised set of components, and transmitting, over a computer network, the augmented asset alert to a target entity.

In one embodiment, the revised set of components includes one of an additional set of components, a reduced set of components, and a different set of components when compared to the one or more components included in the asset diagnostic inference generated by the large language model.

In one embodiment, the revised asset diagnostic inference includes a revised set of recommended asset maintenance tasks for mitigating the anomalous state when compared to the one or more recommended asset maintenance tasks included in the asset diagnostic inference generated by the large language model, the augmented asset alert includes the revised set of recommended asset maintenance tasks, and transmitting, over a computer network, the augmented asset alert to a target entity.

In one embodiment, the revised set of recommended asset maintenance tasks includes one of an additional set of recommended asset maintenance tasks, a reduced set of recommended asset maintenance tasks, and a different set of recommended asset maintenance tasks when compared to the one or more recommended asset maintenance tasks included in the asset diagnostic inference generated by the large language model.

In one embodiment, the computer instructions, when executed by the one or more processors, perform operations further comprising: in response to adapting the asset alert to the enriched asset alert, transmitting, in real-time or near real-time, the enriched asset alert to a target entity.

In one embodiment, a computer-implemented method comprises: at a first stage of a predictive maintenance pipeline: receiving sensor data captured by a set of sensors associated with an industrial asset; generating, by an anomaly detection application of the predictive maintenance pipeline, an asset alert that indicates the industrial asset is operating or will operate in an anomalous state based on the anomaly detection application assessing the sensor data; and in response to the anomaly detection application generating the asset alert, routing the asset alert to an alert diagnostic and maintenance planning application of the predictive maintenance pipeline; at a second stage of the predictive maintenance pipeline: constructing, by the alert diagnostic and maintenance planning application, an asset diagnostic prompt in response to routing the asset alert to the alert diagnostic and maintenance planning application; and invoking, by the alert diagnostic and maintenance planning application, a retrieval-augmented-generation (RAG) service of the predictive maintenance pipeline using an application programming interface (API); and at a third stage of the predictive maintenance pipeline: retrieving, by the RAG service, a set of asset maintenance data items related to the asset diagnostic prompt in response to querying one or more asset maintenance data collections; generating, based on providing the asset diagnostic prompt and the set of asset maintenance data items to a large language model of the RAG service, an asset diagnostic inference that includes (i) one or more components of the industrial asset contributing to the anomalous state and (ii) one or more recommended asset maintenance tasks for mitigating the anomalous state; and adapting, by the RAG service, the asset alert to an enriched asset alert that includes the one or more components of the industrial asset contributing to the anomalous state and the one or more recommended asset maintenance task.

In one embodiment, the computer-implemented method further includes, in response to adapting the asset alert to the enriched asset alert, transmitting, using the API, the enriched asset alert to the alert diagnostic and maintenance planning application of the predictive maintenance pipeline.

In one embodiment, constructing the asset diagnostic prompt includes extracting alert metadata from the asset alert that is indicative of an operating state of the industrial asset at a time the anomaly detection application generated the asset alert, the asset diagnostic prompt includes at least a set of model instructions instructing the large language model to perform a diagnostic assessment of the anomalous state associated with the industrial asset and the alert metadata extracted from the asset alert, the querying of the one or more asset maintenance data collections is commenced in response to the alert diagnostic and maintenance planning application invoking the RAG service, and the RAG service automatically queries the one or more asset maintenance data collections based on an embedding value of the asset diagnostic prompt.

In one embodiment, a computer-program product comprising a non-transitory machine-readable storage medium storing computer instructions that, when executed by one or more processors, perform operations comprising: obtaining raw sensor data captured by a set of sensors monitoring an industrial asset; generating, by an anomaly detection algorithm, an asset alert that indicates the industrial asset is operating or will operate in an anomalous state based on the anomaly detection algorithm assessing the raw sensor data; extracting, from the asset alert, alert metadata indicative of an operating state of the industrial asset at a time the anomaly detection algorithm generated the asset alert; in response to extracting the alert metadata from the asset alert: constructing an asset diagnostic prompt that includes the alert metadata and a set of model instructions instructing a large language model to perform a diagnostic assessment of the anomalous state; querying one or more asset maintenance data collections based on an embedding value of the asset diagnostic prompt; retrieving, from the one or more asset maintenance data collections, a set of asset maintenance data items related to the asset diagnostic prompt in response to the querying of the one or more asset maintenance data collections; and generating, based on providing the asset diagnostic prompt and the set of asset maintenance data items to the large language model, an asset diagnostic inference that includes (i) one or more components of the industrial asset contributing to the anomalous state and (ii) one or more recommended asset maintenance tasks for mitigating the anomalous state; and adapting the asset alert to an enriched asset alert that includes the one or more components of the industrial asset contributing to the anomalous state and the one or more recommended asset maintenance tasks.

In one embodiment, a computer-implemented system includes one or more processors; a memory; a computer-readable medium operably coupled to the one or more processors, the computer-readable medium having computer-readable instructions stored thereon that, when executed by the one or more processors, cause a computing device to perform operations comprising: obtaining sensor data captured by a set of sensors associated with an industrial asset; generating, by an anomaly detection algorithm, an asset alert that indicates the industrial asset is operating or will operate in an anomalous state based on the anomaly detection algorithm assessing the sensor data; extracting, from the asset alert, alert metadata indicative of an operating state of the industrial asset at a time the anomaly detection algorithm generated the asset alert; in response to extracting the alert metadata from the asset alert: constructing an asset diagnostic prompt that includes the alert metadata and a set of model instructions instructing a large language model to perform a diagnostic assessment of the anomalous state; querying one or more asset maintenance data collections based on an embedding value of the asset diagnostic prompt; retrieving, from the one or more asset maintenance data collections, a set of asset maintenance data items related to the asset diagnostic prompt in response to the querying of the one or more asset maintenance data collections; and generating, based on providing the asset diagnostic prompt and the set of asset maintenance data items to the large language model, an asset diagnostic inference that includes (i) one or more components of the industrial asset contributing to the anomalous state and (ii) one or more recommended asset maintenance tasks for mitigating the anomalous state; and adapting the asset alert to an enriched asset alert that includes the one or more components of the industrial asset contributing to the anomalous state and the one or more recommended asset maintenance tasks.

### BRIEF DESCRIPTION OF THE FIGURES

FIG. 1 illustrates a block diagram that provides an illustration of the hardware components of a computing system, according to some embodiments of the present technology;

FIG. 2 illustrates an example network including an example set of devices communicating with each other over an exchange system and via a network, according to some embodiments of the present technology;

FIG. 3 illustrates a representation of a conceptual model of a communications protocol system, according to some embodiments of the present technology;

FIG. 4 illustrates a communications grid computing system including a variety of control and worker nodes, according to some embodiments of the present technology;

FIG. 5 illustrates a flow chart showing an example process for adjusting a communications grid or a work project in a communications grid after a failure of a node, according to some embodiments of the present technology;

FIG. 6 illustrates a portion of a communications grid computing system including a control node and a worker node, according to some embodiments of the present technology;

FIG. 7 illustrates a flow chart showing an example process for executing a data analysis or processing project, according to some embodiments of the present technology;

FIG. 8 illustrates a block diagram including components of an Event Stream Processing Engine (ESPE), according to embodiments of the present technology;

FIG. 9 illustrates a flow chart showing an example process including operations performed by an event stream processing engine, according to some embodiments of the present technology;

FIG. 10 illustrates an ESP system interfacing between a publishing device and multiple event subscribing devices, according to embodiments of the present technology;

FIG. 11 illustrates a flow chart of an example of a process for generating and using a machine-learning model according to some aspects, according to embodiments of the present technology;

FIG. 12 illustrates an example of a machine-learning model as a neural network, according to embodiments of the present technology;

FIG. 13 illustrates various aspects of the use of containers as a mechanism to allocate processing, storage and/or other resources of a processing system to the performance of various analyses, according to embodiments of the present technology;

FIGS. 14 and 14A illustrate a flow chart showing an example process of detecting anomalous operation of an industrial asset using one or more anomaly detection models, according to some embodiments of the present technology;

FIG. 15 illustrates an example schematic of generating an asset diagnostic prompt for the industrial asset, according to some embodiments of the present technology;

FIG. 16 illustrates an example schematic of generating an enriched asset alert corresponding to the industrial asset, according to some embodiments of the present technology;

FIG. 17 illustrates an example process of execution of a recommended asset maintenance task corresponding to industrial asset, according to some embodiments of the present technology;

FIG. 18 illustrates an example process of transmitting the enriched asset alert to one or more target entities, according to some embodiments of the present technology;

FIGS. 19 and 19A illustrate example graphical user interfaces that display distinct pieces of alert metadata for a detected anomalous operation, according to some embodiments of the present technology;

FIG. 20 illustrates an example process of retrieving a distinct set of prompt construction instructions from an asset alert type-to-asset diagnostic prompt data table, according to some embodiments of the present technology;

FIG. 21 illustrates an example process of retrieving an asset diagnostic prompt template from an asset alert type-to-asset diagnostic prompt template repository, according to some embodiments of the present technology;

FIGS. 22 and 22A illustrate example enriched asset alerts, according to some embodiments of the present technology;

FIG. 23 illustrates an example asset alert graphical user interface, according to some embodiments of the present technology;

FIG. 24 illustrates an example enriched asset alert graphical user interface that at least includes a digital assistant interface, according to some embodiments of the present technology;

FIG. 25 illustrates an example process of querying multiple asset maintenance data collections to obtain a set of asset maintenance data items related to the asset diagnostic prompt, according to some embodiments of the present technology;

FIG. 26 illustrates an example schematic of generating a digital work order based on the enriched asset alert, according to some embodiments of the present technology;

FIG. 27 illustrates an example schematic of generating an augmented asset alert using multiple large language models, according to some embodiments of the present technology; and

FIG. 28 illustrates an example of an alert diagnostics and maintenance planning service, according to some embodiments of the present technology.

### DESCRIPTION OF THE PREFERRED EMBODIMENTS

The following description of the preferred embodiments of the inventions are not intended to limit the inventions to these preferred embodiments, but rather to enable any person skilled in the art to make and use these inventions.

### DETAILED DESCRIPTION

In the following description, for the purposes of explanation, specific details are set forth in order to provide a thorough understanding of embodiments of the technology. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the technology as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional operations not included in a figure. A process may correspond to a method, a function, a procedure, a subroutine, a subprogram, etc. When a process corresponds to a function, its termination can correspond to a return of the function to the calling function or the main function.

### Example Systems

Systems depicted in some of the figures may be provided in various configurations. In some embodiments, the systems may be configured as a distributed system where one or more components of the system are distributed across one or more networks in a cloud computing system.

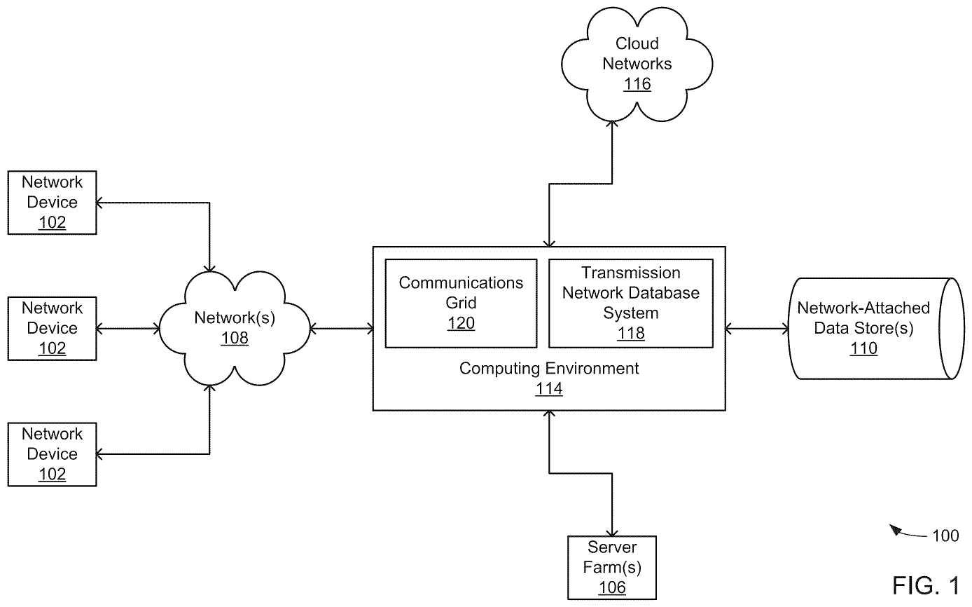

FIG. 1 is a block diagram that provides an illustration of the hardware components of a data transmission network 100, according to embodiments of the present technology. Data transmission network 100 is a specialized computer system that may be used for processing large amounts of data where a large number of computer processing cycles are required.

Data transmission network 100 may also include computing environment 114. Computing environment 114 may be a specialized computer or other machine that processes the data received within the data transmission network 100. Data transmission network 100 also includes one or more network devices 102. Network devices 102 may include client devices that attempt to communicate with computing environment 114. For example, network devices 102 may send data to the computing environment 114 to be processed, may send signals to the computing environment 114 to control different aspects of the computing environment or the data it is processing, among other reasons. Network devices 102 may interact with the computing environment 114 through a number of ways, such as, for example, over one or more networks 108. As shown in FIG. 1, computing environment 114 may include one or more other systems. For example, computing environment 114 may include a database system 118 and/or a communications grid 120.

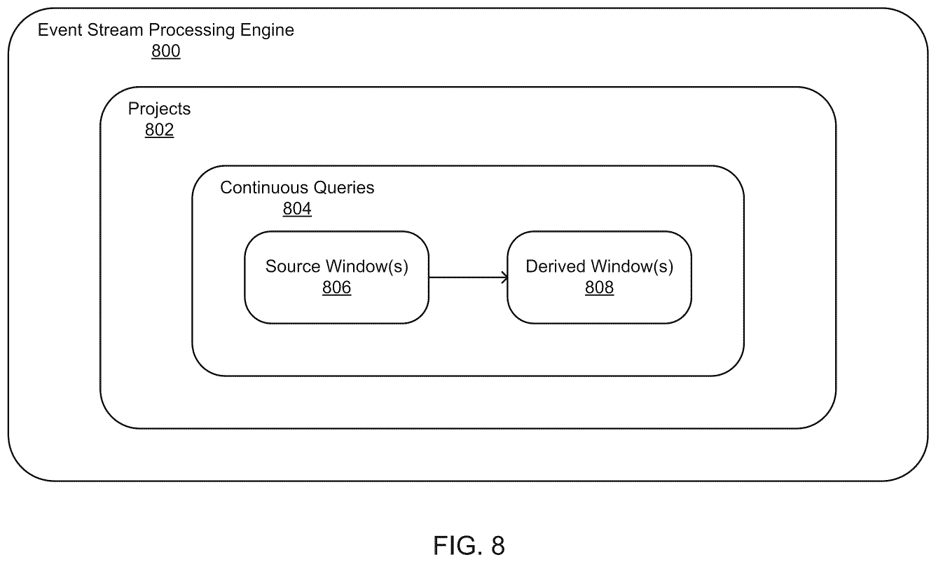

In other embodiments, network devices may provide a large amount of data, either all at once or streaming over a period of time (e.g., using event stream processing (ESP), described further with respect to FIGS. 8-10), to the computing environment 114 via networks 108. For example, network devices 102 may include network computers, sensors, databases, or other devices that may transmit or otherwise provide data to computing environment 114. For example, network devices may include local area network devices, such as routers, hubs, switches, or other computer networking devices. These devices may provide a variety of stored or generated data, such as network data or data specific to the network devices themselves. Network devices may also include sensors that monitor their environment or other devices to collect data regarding that environment or those devices, and such network devices may provide data they collect over time. Network devices may also include devices within the internet of things, such as devices within a home automation network. Some of these devices may be referred to as edge devices, and may involve edge computing circuitry. Data may be transmitted by network devices directly to computing environment 114 or to network-attached data stores, such as network-attached data stores 110 for storage so that the data may be retrieved later by the computing environment 114 or other portions of data transmission network 100.

Data transmission network 100 may also include one or more network-attached data stores 110. Network-attached data stores 110 are used to store data to be processed by the computing environment 114 as well as any intermediate or final data generated by the computing system in non-volatile memory. However, in certain embodiments, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated on-the-fly. In this non-limiting situation, the computing environment 114 may be configured to retain the processed information within memory so that responses can be generated for the user at different levels of detail as well as allow a user to interactively query against this information.

Network-attached data stores may store a variety of different types of data organized in a variety of different ways and from a variety of different sources. For example, network-attached data storage may include storage other than primary storage located within computing environment 114 that is directly accessible by processors located therein. Network-attached data storage may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory medium in which data can be stored and that does not include carrier waves and/or transitory electronic signals. Examples of a non-transitory medium may include, for example, a magnetic disk or tape, optical storage media such as compact disk or digital versatile disk, flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data, such as manufacturing data (e.g., a database containing records identifying products being manufactured with parameter data for each product, such as colors and models) or product sales databases (e.g., a database containing individual data records identifying details of individual product sales).

The unstructured data may be presented to the computing environment 114 in different forms such as a flat file or a conglomerate of data records, and may have data values and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time stamped data may be aggregated by time (e.g., into daily time period units) to generate time series data and/or structured hierarchically according to one or more dimensions (e.g., parameters, attributes, and/or variables). For example, data may be stored in a hierarchical data structure, such as a ROLAP OR MOLAP database, or may be stored in another tabular form, such as in a flat-hierarchy form.

Data transmission network 100 may also include one or more server farms 106. Computing environment 114 may route select communications or data to the one or more sever farms 106 or one or more servers within the server farms. Server farms 106 can be configured to provide information in a predetermined manner. For example, server farms 106 may access data to transmit in response to a communication. Server farms 106 may be separately housed from each other device within data transmission network 100, such as computing environment 114, and/or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time.

Data transmission network 100 may also include one or more cloud networks 116. Cloud network 116 may include a cloud infrastructure system that provides cloud services. In certain embodiments, services provided by the cloud network 116 may include a host of services that are made available to users of the cloud infrastructure system on demand. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network can dynamically scale to meet the needs of its users. The cloud network 116 may include one or more computers, servers, and/or systems. In some embodiments, the computers, servers, and/or systems that make up the cloud network 116 are different from the user's own on-premises computers, servers, and/or systems. For example, the cloud network 116 may host an application, and a user may, via a communication network such as the Internet, on demand, order and use the application.

While each device, server and system in FIG. 1 is shown as a single device, it will be appreciated that multiple devices may instead be used. For example, a set of network devices can be used to transmit various communications from a single user, or remote server 140 may include a server stack. As another example, data may be processed as part of computing environment 114.

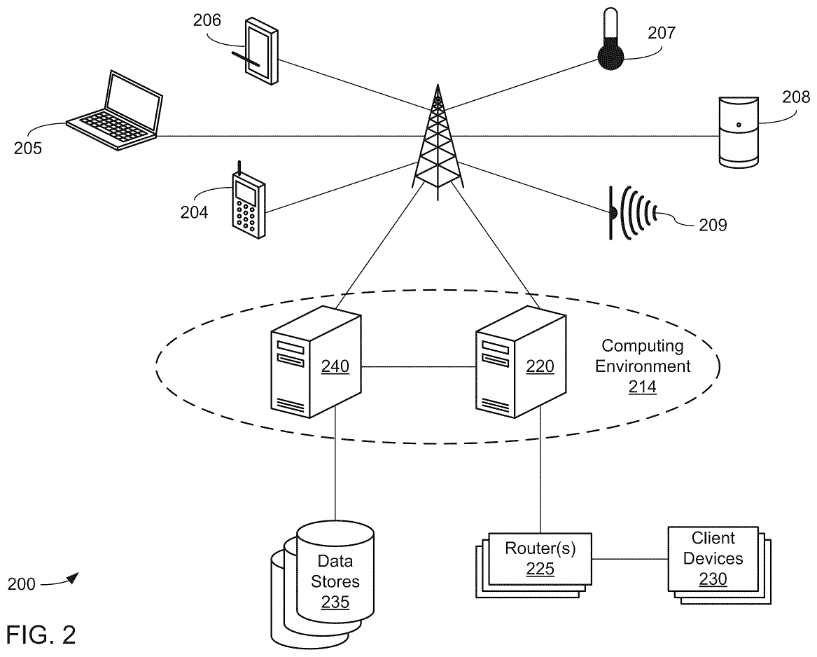

Each communication within data transmission network 100 (e.g., between client devices, between servers 106 and computing environment 114 or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a BLUETOOTH® communication channel or a BLUETOOTH® LOW Energy communication channel. A wired network may include a wired interface. The wired and/or wireless networks may be implemented using routers, access points, bridges, gateways, or the like, to connect devices in the network 114, as will be further described with respect to FIG. 2. The one or more networks 108 can be incorporated entirely within or can include an intranet, an extranet, or a combination thereof. In one embodiment, communications between two or more systems and/or devices can be achieved by a secure communications protocol, such as secure sockets layer (SSL) or transport layer security (TLS). In addition, data and/or transactional details may be encrypted.

Some aspects may utilize the Internet of Things (IoT), where things (e.g., machines, devices, phones, sensors) can be connected to networks and the data from these things can be collected and processed within the things and/or external to the things. For example, the IoT can include sensors in many different devices, and high value analytics can be applied to identify hidden relationships and drive increased efficiencies. This can apply to both big data analytics and real-time (e.g., ESP) analytics. This will be described further below with respect to FIG. 2.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The compute nodes in the grid-based computing system 120 and the transmission network database system 118 may share the same processor hardware, such as processors that are located within computing environment 114.

FIG. 2 illustrates an example network including an example set of devices communicating with each other over an exchange system and via a network, according to embodiments of the present technology. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). The communication can be routed to another network device, such as network devices 205-209, via base station 210. The communication can also be routed to computing environment 214 via base station 210. For example, network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, and electrical current, among others. The sensors may be mounted to various components used as part of a variety of different types of systems (e.g., an oil drilling operation). The network devices may detect and record data related to the environment that it monitors and transmit that data to computing environment 214.

As noted, one type of system that may include various sensors that collect data to be processed and/or transmitted to a computing environment according to certain embodiments includes an oil drilling system. For example, the one or more drilling operation sensors may include surface sensors that measure a hook load, a fluid rate, a temperature and a density in and out of the wellbore, a standpipe pressure, a surface torque, a rotation speed of a drill pipe, a rate of penetration, a mechanical specific energy, etc. and downhole sensors that measure a rotation speed of a bit, fluid densities, downhole torque, downhole vibration (axial, tangential, lateral), a weight applied at a drill bit, an annular pressure, a differential pressure, an azimuth, an inclination, a dog leg severity, a measured depth, a vertical depth, a downhole temperature, etc. Besides the raw data collected directly by the sensors, other data may include parameters either developed by the sensors or assigned to the system by a client or other controlling device. For example, one or more drilling operation control parameters may control settings such as a mud motor speed to flow ratio, a bit diameter, a predicted formation top, seismic data, weather data, etc. Other data may be generated using physical models such as an earth model, a weather model, a seismic model, a bottom hole assembly model, a well plan model, an annular friction model, etc. In addition to sensor and control settings, predicted outputs, of for example, the rate of penetration, mechanical specific energy, hook load, flow in fluid rate, flow out fluid rate, pump pressure, surface torque, rotation speed of the drill pipe, annular pressure, annular friction pressure, annular temperature, equivalent circulating density, etc. may also be stored in the data warehouse.

In another example, another type of system that may include various sensors that collect data to be processed and/or transmitted to a computing environment according to certain embodiments includes a home automation or similar automated network in a different environment, such as an office space, school, public space, sports venue, or a variety of other locations. Network devices in such an automated network may include network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). For example, network device 102 may include a home automation switch that may be coupled with a home appliance. In another embodiment, a network device can allow a user to access, control, and/or configure devices, such as office-related devices (e.g., copy machine, printer, or fax machine), audio and/or video related devices (e.g., a receiver, a speaker, a projector, a DVD player, or a television), media-playback devices (e.g., a compact disc player, a CD player, or the like), computing devices (e.g., a home computer, a laptop computer, a tablet, a personal digital assistant (PDA), a computing device, or a wearable device), lighting devices (e.g., a lamp or recessed lighting), devices associated with a security system, devices associated with an alarm system, devices that can be operated in an automobile (e.g., radio devices, navigation devices), and/or the like. Data may be collected from such various sensors in raw form, or data may be processed by the sensors to create parameters or other data either developed by the sensors based on the raw data or assigned to the system by a client or other controlling device.

In another example, another type of system that may include various sensors that collect data to be processed and/or transmitted to a computing environment according to certain embodiments includes a power or energy grid. A variety of different network devices may be included in an energy grid, such as various devices within one or more power plants, energy farms (e.g., wind farm, solar farm, among others) energy storage facilities, factories, homes and businesses of consumers, among others. One or more of such devices may include one or more sensors that detect energy gain or loss, electrical input or output or loss, and a variety of other efficiencies. These sensors may collect data to inform users of how the energy grid, and individual devices within the grid, may be functioning and how they may be made more efficient.

Network device sensors may also perform processing on data it collects before transmitting the data to the computing environment 114, or before deciding whether to transmit data to the computing environment 114. For example, network devices may determine whether data collected meets certain rules, for example by comparing data or values calculated from the data and comparing that data to one or more thresholds. The network device may use this data and/or comparisons to determine if the data should be transmitted to the computing environment 214 for further use or processing.

Computing environment 214 may include machines 220 and 240. Although computing environment 214 is shown in FIG. 2 as having two machines, 220 and 240, computing environment 214 may have only one machine or may have more than two machines. The machines that make up computing environment 214 may include specialized computers, servers, or other machines that are configured to individually and/or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with devices 230 via one or more routers 225. Computing environment 214 may collect, analyze and/or store data from or pertaining to communications, client device operations, client rules, and/or user-associated actions stored at one or more data stores 235. Such data may influence communication routing to the devices within computing environment 214, how data is stored or processed within computing environment 214, among other actions.

Notably, various other devices can further be used to influence communication routing and/or processing between devices within computing environment 214 and with devices outside of computing environment 214. For example, as shown in FIG. 2, computing environment 214 may include a web server 240. Thus, computing environment 214 can retrieve data of interest, such as client information (e.g., product information, client rules, etc.), technical product details, news, current or predicted weather, and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices may receive data periodically from network device sensors as the sensors continuously sense, monitor and track changes in their environments. Devices within computing environment 214 may also perform pre-analysis on data it receives to determine if the data received should be processed as part of an ongoing project. The data received and collected by computing environment 214, no matter what the source or method or timing of receipt, may be processed over a period of time for a client to determine results data based on the client's needs and rules.

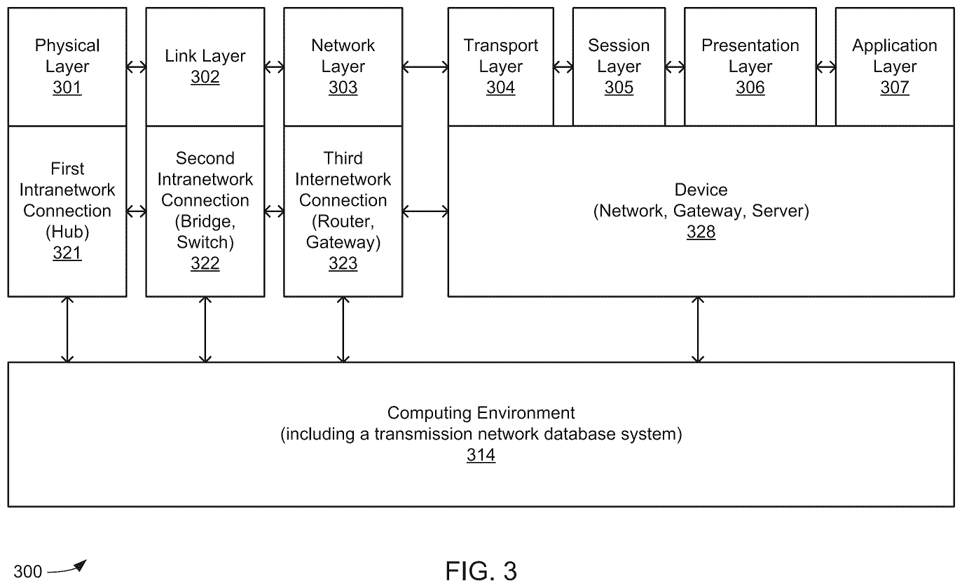

FIG. 3 illustrates a representation of a conceptual model of a communications protocol system, according to embodiments of the present technology. More specifically, FIG. 3 identifies operation of a computing environment in an Open Systems Interaction model that corresponds to various connection components. The model 300 shows, for example, how a computing environment, such as computing environment 314 (or computing environment 214 in FIG. 2) may communicate with other devices in its network, and control how communications between the computing environment and other devices are executed and under what conditions.

The model can include layers 301-307. The layers are arranged in a stack. Each layer in the stack serves the layer one level higher than it (except for the application layer, which is the highest layer), and is served by the layer one level below it (except for the physical layer, which is the lowest layer). The physical layer is the lowest layer because it receives and transmits raw bites of data, and is the farthest layer from the user in a communications system. On the other hand, the application layer is the highest layer because it interacts directly with a software application.

As noted, the model includes a physical layer 301. Physical layer 301 represents physical communication, and can define parameters of that physical communication. For example, such physical communication may come in the form of electrical, optical, or electromagnetic signals. Physical layer 301 also defines protocols that may control communications within a data transmission network.

Link layer 302 defines links and mechanisms used to transmit (i.e., move) data across a network. The link layer 302 manages node-to-node communications, such as within a grid computing environment. Link layer 302 can detect and correct errors (e.g., transmission errors in the physical layer 301). Link layer 302 can also include a media access control (MAC) layer and logical link control (LLC) layer.

Network layer 303 defines the protocol for routing within a network. In other words, the network layer coordinates transferring data across nodes in a same network (e.g., such as a grid computing environment). Network layer 303 can also define the processes used to structure local addressing within the network.

Transport layer 304 can manage the transmission of data and the quality of the transmission and/or receipt of that data. Transport layer 304 can provide a protocol for transferring data, such as, for example, a Transmission Control Protocol (TCP). Transport layer 304 can assemble and disassemble data frames for transmission. The transport layer can also detect transmission errors occurring in the layers below it.

Session layer 305 can establish, maintain, and manage communication connections between devices on a network. In other words, the session layer controls the dialogues or nature of communications between network devices on the network. The session layer may also establish checkpointing, adjournment, termination, and restart procedures.

Presentation layer 306 can provide translation for communications between the application and network layers. In other words, this layer may encrypt, decrypt and/or format data based on data types and/or encodings known to be accepted by an application or network layer.

Application layer 307 interacts directly with software applications and end users, and manages communications between them. Application layer 307 can identify destinations, local resource states or availability and/or communication content or formatting using the applications.

Intra-network connection components 321 and 322 are shown to operate in lower levels, such as physical layer 301 and link layer 302, respectively. For example, a hub can operate in the physical layer, a switch can operate in the link layer, and a router can operate in the network layer. Inter-network connection components 323 and 328 are shown to operate on higher levels, such as layers 303-307. For example, routers can operate in the network layer and network devices can operate in the transport, session, presentation, and application layers.

As noted, a computing environment 314 can interact with and/or operate on, in various embodiments, one, more, all or any of the various layers. For example, computing environment 314 can interact with a hub (e.g., via the link layer) so as to adjust which devices the hub communicates with. The physical layer may be served by the link layer, so it may implement such data from the link layer. For example, the computing environment 314 may control which devices it will receive data from. For example, if the computing environment 314 knows that a certain network device has turned off, broken, or otherwise become unavailable or unreliable, the computing environment 314 may instruct the hub to prevent any data from being transmitted to the computing environment 314 from that network device. Such a process may be beneficial to avoid receiving data that is inaccurate or that has been influenced by an uncontrolled environment. As another example, computing environment 314 can communicate with a bridge, switch, router or gateway and influence which device within the system (e.g., system 200) the component selects as a destination. In some embodiments, computing environment 314 can interact with various layers by exchanging communications with equipment operating on a particular layer by routing or modifying existing communications. In another embodiment, such as in a grid computing environment, a node may determine how data within the environment should be routed (e.g., which node should receive certain data) based on certain parameters or information provided by other layers within the model.

As noted, the computing environment 314 may be a part of a communications grid environment, the communications of which may be implemented as shown in the protocol of FIG. 3. For example, referring back to FIG. 2, one or more of machines 220 and 240 may be part of a communications grid computing environment. A gridded computing environment may be employed in a distributed system with non-interactive workloads where data resides in memory on the machines, or compute nodes. In such an environment, analytic code, instead of a database management system, controls the processing performed by the nodes. Data is co-located by pre-distributing it to the grid nodes, and the analytic code on each node loads the local data into memory. Each node may be assigned a particular task such as a portion of a processing project, or to organize or control other nodes within the grid.

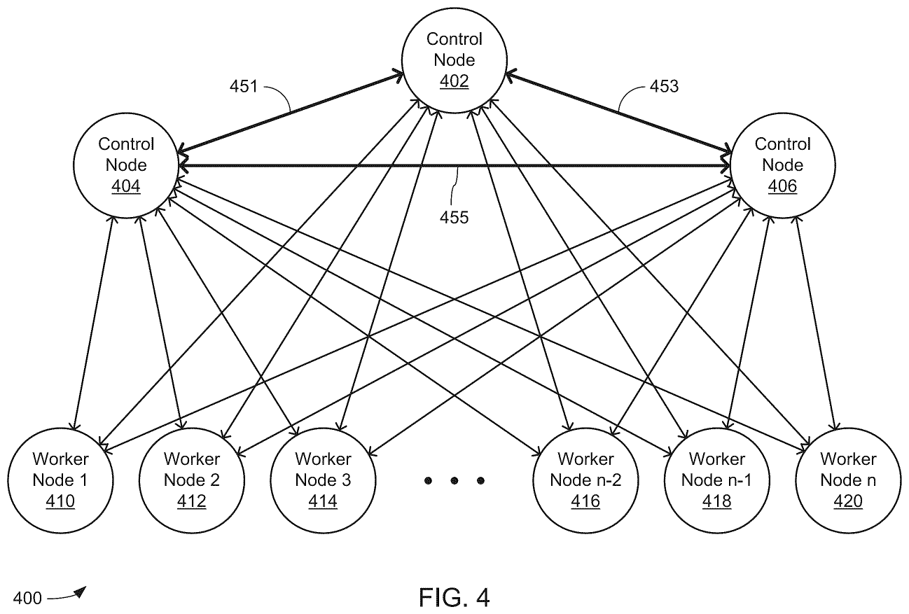

FIG. 4 illustrates a communications grid computing system 400 including a variety of control and worker nodes, according to embodiments of the present technology. Communications grid computing system 400 includes three control nodes and one or more worker nodes. Communications grid computing system 400 includes control nodes 402, 404, and 406. The control nodes are communicatively connected via communication paths 451, 453, and 455. Therefore, the control nodes may transmit information (e.g., related to the communications grid or notifications), to and receive information from each other. Although communications grid computing system 400 is shown in FIG. 4 as including three control nodes, the communications grid may include more or less than three control nodes.

Communications grid computing system (or just “communications grid”) 400 also includes one or more worker nodes. Shown in FIG. 4 are six worker nodes 410-420. Although FIG. 4 shows six worker nodes, a communications grid according to embodiments of the present technology may include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid 400 may be connected (wired or wirelessly, and directly or indirectly) to control nodes 402-406. Therefore, each worker node may receive information from the control nodes (e.g., an instruction to perform work on a project) and may transmit information to the control nodes (e.g., a result from work performed on a project). Furthermore, worker nodes may communicate with each other (either directly or indirectly). For example, worker nodes may transmit data between each other related to a job being performed or an individual task within a job being performed by that worker node. However, in certain embodiments, worker nodes may not, for example, be connected (communicatively or otherwise) to certain other worker nodes. In an embodiment, worker nodes may only be able to communicate with the control node that controls it, and may not be able to communicate with other worker nodes in the communications grid, whether they are other worker nodes controlled by the control node that controls the worker node, or worker nodes that are controlled by other control nodes in the communications grid.

A control node may connect with an external device with which the control node may communicate (e.g., a grid user, such as a server or computer, may connect to a controller of the grid). For example, a server or computer may connect to control nodes and may transmit a project or job to the node. The project may include a data set. The data set may be of any size. Once the control node receives such a project including a large data set, the control node may distribute the data set or projects related to the data set to be performed by worker nodes. Alternatively, for a project including a large data set, the data set may be received or stored by a machine other than a control node (e.g., a HADOOP® standard-compliant data node employing the HADOOP® Distributed File System, or HDFS).

Control nodes may maintain knowledge of the status of the nodes in the grid (i.e., grid status information), accept work requests from clients, subdivide the work across worker nodes, and coordinate the worker nodes, among other responsibilities. Worker nodes may accept work requests from a control node and provide the control node with results of the work performed by the worker node. A grid may be started from a single node (e.g., a machine, computer, server, etc.). This first node may be assigned or may start as the primary control node that will control any additional nodes that enter the grid.

When a project is submitted for execution (e.g., by a client or a controller of the grid) it may be assigned to a set of nodes. After the nodes are assigned to a project, a data structure (i.e., a communicator) may be created. The communicator may be used by the project for information to be shared between the project codes running on each node. A communication handle may be created on each node. A handle, for example, is a reference to the communicator that is valid within a single process on a single node, and the handle may be used when requesting communications between nodes.

A control node, such as control node 402, may be designated as the primary control node. A server, computer or other external device may connect to the primary control node. Once the control node receives a project, the primary control node may distribute portions of the project to its worker nodes for execution. For example, when a project is initiated on communications grid 400, primary control node 402 controls the work to be performed for the project in order to complete the project as requested or instructed. The primary control node may distribute work to the worker nodes based on various factors, such as which subsets or portions of projects may be completed most efficiently and in the correct amount of time. For example, a worker node may perform analysis on a portion of data that is already local (e.g., stored on) the worker node. The primary control node also coordinates and processes the results of the work performed by each worker node after each worker node executes and completes its job. For example, the primary control node may receive a result from one or more worker nodes, and the control node may organize (e.g., collect and assemble) the results received and compile them to produce a complete result for the project received from the end user.

Any remaining control nodes, such as control nodes 404 and 406, may be assigned as backup control nodes for the project. In an embodiment, backup control nodes may not control any portion of the project. Instead, backup control nodes may serve as a backup for the primary control node and take over as primary control node if the primary control node were to fail. If a communications grid were to include only a single control node, and the control node were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes, including a backup control node, may be beneficial.

To add another node or machine to the grid, the primary control node may open a pair of listening sockets, for example. A socket may be used to accept work requests from clients, and the second socket may be used to accept connections from other grid nodes. The primary control node may be provided with a list of other nodes (e.g., other machines, computers, servers) that will participate in the grid, and the role that each node will fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other machines in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it will check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. However, a hierarchy of nodes may also be determined using methods other than using the unique identifiers of the nodes. For example, the hierarchy may be predetermined, or may be assigned based on other predetermined factors.

The grid may add new machines at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404 and 406 (and, for example, to other control or worker nodes within the communications grid). Such communications may be sent periodically, at fixed time intervals, between known fixed stages of the project's execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes in the grid, unique identifiers of the nodes, or their relationships with the primary control node) and the status of a project (including, for example, the status of each worker node's portion of the project). The snapshot may also include analysis or results received from worker nodes in the communications grid. The backup control nodes may receive and store the backup data received from the primary control node. The backup control nodes may transmit a request for such a snapshot (or other information) from the primary control node, or the primary control node may send such information periodically to the backup control nodes.

As noted, the backup data may allow the backup control node to take over as primary control node if the primary control node fails without requiring the grid to start the project over from scratch. If the primary control node fails, the backup control node that will take over as primary control node may retrieve the most recent version of the snapshot received from the primary control node and use the snapshot to continue the project from the stage of the project indicated by the backup data. This may prevent failure of the project as a whole.

A backup control node may use various methods to determine that the primary control node has failed. In one example of such a method, the primary control node may transmit (e.g., periodically) a communication to the backup control node that indicates that the primary control node is working and has not failed, such as a heartbeat communication. The backup control node may determine that the primary control node has failed if the backup control node has not received a heartbeat communication for a certain predetermined period of time. Alternatively, a backup control node may also receive a communication from the primary control node itself (before it failed) or from a worker node that the primary control node has failed, for example because the primary control node has failed to communicate with the worker node.

Different methods may be performed to determine which backup control node of a set of backup control nodes (e.g., backup control nodes 404 and 406) will take over for failed primary control node 402 and become the new primary control node. For example, the new primary control node may be chosen based on a ranking or “hierarchy” of backup control nodes based on their unique identifiers. In an alternative embodiment, a backup control node may be assigned to be the new primary control node by another device in the communications grid or from an external device (e.g., a system infrastructure or an end user, such as a server or computer, controlling the communications grid). In another alternative embodiment, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative embodiment, the primary control node may transmit a communication to each of the operable worker nodes still on the communications grid that each of the worker nodes should purposefully fail also. After each of the worker nodes fail, they may each retrieve their most recent saved checkpoint of their status and re-start the project from that checkpoint to minimize lost progress on the project being executed.

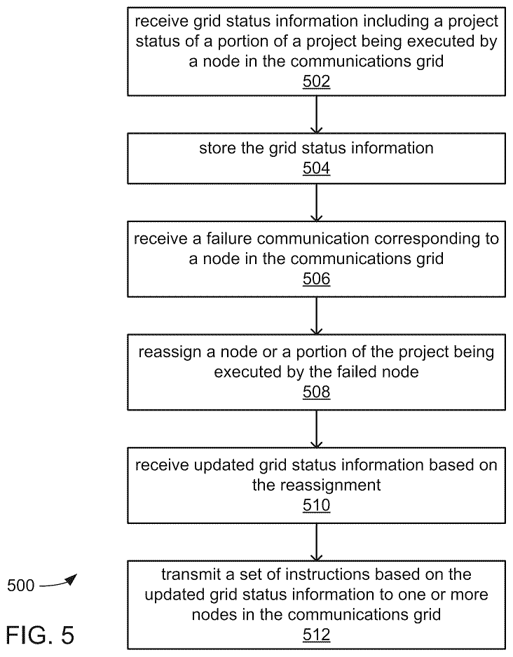

FIG. 5 illustrates a flow chart showing an example process 500 for adjusting a communications grid or a work project in a communications grid after a failure of a node, according to embodiments of the present technology. The process may include, for example, receiving grid status information including a project status of a portion of a project being executed by a node in the communications grid, as described in operation 502. For example, a control node (e.g., a backup control node connected to a primary control node and a worker node on a communications grid) may receive grid status information, where the grid status information includes a project status of the primary control node or a project status of the worker node. The project status of the primary control node and the project status of the worker node may include a status of one or more portions of a project being executed by the primary and worker nodes in the communications grid. The process may also include storing the grid status information, as described in operation 504. For example, a control node (e.g., a backup control node) may store the received grid status information locally within the control node. Alternatively, the grid status information may be sent to another device for storage where the control node may have access to the information.

The process may also include receiving a failure communication corresponding to a node in the communications grid in operation 506. For example, a node may receive a failure communication including an indication that the primary control node has failed, prompting a backup control node to take over for the primary control node. In an alternative embodiment, a node may receive a failure that a worker node has failed, prompting a control node to reassign the work being performed by the worker node. The process may also include reassigning a node or a portion of the project being executed by the failed node, as described in operation 508. For example, a control node may designate the backup control node as a new primary control node based on the failure communication upon receiving the failure communication. If the failed node is a worker node, a control node may identify a project status of the failed worker node using the snapshot of the communications grid, where the project status of the failed worker node includes a status of a portion of the project being executed by the failed worker node at the failure time.

The process may also include receiving updated grid status information based on the reassignment, as described in operation 510, and transmitting a set of instructions based on the updated grid status information to one or more nodes in the communications grid, as described in operation 512. The updated grid status information may include an updated project status of the primary control node or an updated project status of the worker node. The updated information may be transmitted to the other nodes in the grid to update their stale stored information.

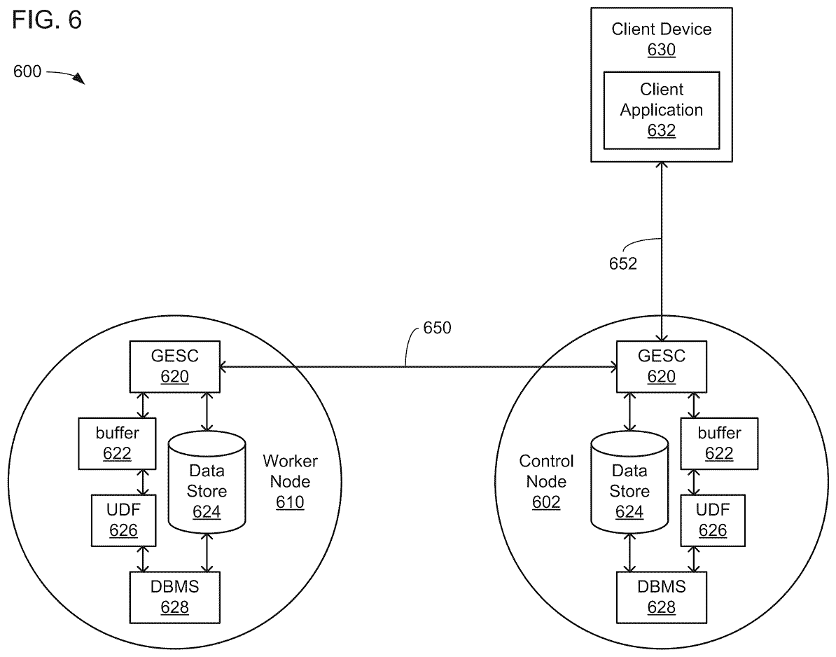

FIG. 6 illustrates a portion of a communications grid computing system 600 including a control node and a worker node, according to embodiments of the present technology. Communications grid 600 computing system includes one control node (control node 602) and one worker node (worker node 610) for purposes of illustration, but may include more worker and/or control nodes. The control node 602 is communicatively connected to worker node 610 via communication path 650. Therefore, control node 602 may transmit information (e.g., related to the communications grid or notifications), to and receive information from worker node 610 via path 650.

Similar to in FIG. 4, communications grid computing system (or just “communications grid”) 600 includes data processing nodes (control node 602 and worker node 610). Nodes 602 and 610 include multi-core data processors. Each node 602 and 610 includes a grid-enabled software component (GESC) 620 that executes on the data processor associated with that node and interfaces with buffer memory 622 also associated with that node. Each node 602 and 610 includes database management software (DBMS) 628 that executes on a database server (not shown) at control node 602 and on a database server (not shown) at worker node 610.

Each node also includes a data store 624. Data stores 624, similar to network-attached data stores 110 in FIG. 1 and data stores 235 in FIG. 2, are used to store data to be processed by the nodes in the computing environment. Data stores 624 may also store any intermediate or final data generated by the computing system after being processed, for example in non-volatile memory. However, in certain embodiments, the configuration of the grid computing environment allows its operations to be performed such that intermediate and final data results can be stored solely in volatile memory (e.g., RAM), without a requirement that intermediate or final data results be stored to non-volatile types of memory. Storing such data in volatile memory may be useful in certain situations, such as when the grid receives queries (e.g., ad hoc) from a client and when responses, which are generated by processing large amounts of data, need to be generated quickly or on-the-fly. In such a situation, the grid may be configured to retain the data within memory so that responses can be generated at different levels of detail and so that a client may interactively query against this information.

Each node also includes a user-defined function (UDF) 626. The UDF provides a mechanism for the DBMS 628 to transfer data to or receive data from the database stored in the data stores 624 that are managed by the DBMS. For example, UDF 626 can be invoked by the DBMS to provide data to the GESC for processing. The UDF 626 may establish a socket connection (not shown) with the GESC to transfer the data. Alternatively, the UDF 626 can transfer data to the GESC by writing data to shared memory accessible by both the UDF and the GESC.

The GESC 620 at the nodes 602 and 620 may be connected via a network, such as network 108 shown in FIG. 1. Therefore, nodes 602 and 620 can communicate with each other via the network using a predetermined communication protocol such as, for example, the Message Passing Interface (MPI). Each GESC 620 can engage in point-to-point communication with the GESC at another node or in collective communication with multiple GESCs via the network. The GESC 620 at each node may contain identical (or nearly identical) software instructions. Each node may be capable of operating as either a control node or a worker node. The GESC at the control node 602 can communicate, over a communication path 652, with a client deice 630. More specifically, control node 602 may communicate with client application 632 hosted by the client device 630 to receive queries and to respond to those queries after processing large amounts of data.

DBMS 628 may control the creation, maintenance, and use of database or data structure (not shown) within a nodes 602 or 610. The database may organize data stored in data stores 624. The DBMS 628 at control node 602 may accept requests for data and transfer the appropriate data for the request. With such a process, collections of data may be distributed across multiple physical locations. In this example, each node 602 and 610 stores a portion of the total data managed by the management system in its associated data store 624.

Furthermore, the DBMS may be responsible for protecting against data loss using replication techniques. Replication includes providing a backup copy of data stored on one node on one or more other nodes. Therefore, if one node fails, the data from the failed node can be recovered from a replicated copy residing at another node. However, as described herein with respect to FIG. 4, data or status information for each node in the communications grid may also be shared with each node on the grid.

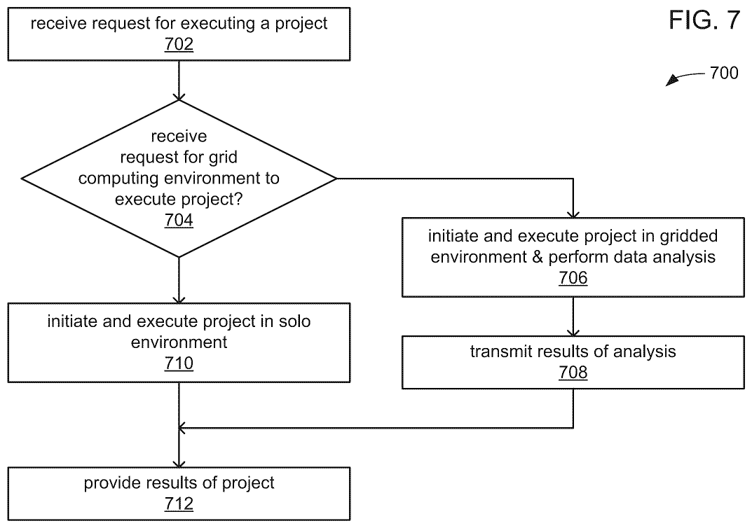

FIG. 7 illustrates a flow chart showing an example method 700 for executing a project within a grid computing system, according to embodiments of the present technology. As described with respect to FIG. 6, the GESC at the control node may transmit data with a client device (e.g., client device 630) to receive queries for executing a project and to respond to those queries after large amounts of data have been processed. The query may be transmitted to the control node, where the query may include a request for executing a project, as described in operation 702. The query can contain instructions on the type of data analysis to be performed in the project and whether the project should be executed using the grid-based computing environment, as shown in operation 704.

To initiate the project, the control node may determine if the query requests use of the grid-based computing environment to execute the project. If the determination is no, then the control node initiates execution of the project in a solo environment (e.g., at the control node), as described in operation 710. If the determination is yes, the control node may initiate execution of the project in the grid-based computing environment, as described in operation 706. In such a situation, the request may include a requested configuration of the grid. For example, the request may include a number of control nodes and a number of worker nodes to be used in the grid when executing the project. After the project has been completed, the control node may transmit results of the analysis yielded by the grid, as described in operation 708. Whether the project is executed in a solo or grid-based environment, the control node provides the results of the project, as described in operation 712.

As noted with respect to FIG. 2, the computing environments described herein may collect data (e.g., as received from network devices, such as sensors, such as network devices 204-209 in FIG. 2, and client devices or other sources) to be processed as part of a data analytics project, and data may be received in real time as part of a streaming analytics environment (e.g., ESP). Data may be collected using a variety of sources as communicated via different kinds of networks or locally, such as on a real-time streaming basis. For example, network devices may receive data periodically from network device sensors as the sensors continuously sense, monitor and track changes in their environments. More specifically, an increasing number of distributed applications develop or produce continuously flowing data from distributed sources by applying queries to the data before distributing the data to geographically distributed recipients. An event stream processing engine (ESPE) may continuously apply the queries to the data as it is received and determines which entities should receive the data. Client or other devices may also subscribe to the ESPE or other devices processing ESP data so that they can receive data after processing, based on for example the entities determined by the processing engine. For example, client devices 230 in FIG. 2 may subscribe to the ESPE in computing environment 214. In another example, event subscription devices 1024a-c, described further with respect to FIG. 10, may also subscribe to the ESPE. The ESPE may determine or define how input data or event streams from network devices or other publishers (e.g., network devices 204-209 in FIG. 2) are transformed into meaningful output data to be consumed by subscribers, such as for example client devices 230 in FIG. 2.

FIG. 8 illustrates a block diagram including components of an Event Stream Processing Engine (ESPE), according to embodiments of the present technology. ESPE 800 may include one or more projects 802. A project may be described as a second-level container in an engine model managed by ESPE 800 where a thread pool size for the project may be defined by a user. Each project of the one or more projects 802 may include one or more continuous queries 804 that contain data flows, which are data transformations of incoming event streams. The one or more continuous queries 804 may include one or more source windows 806 and one or more derived windows 808.

The ESPE may receive streaming data over a period of time related to certain events, such as events or other data sensed by one or more network devices. The ESPE may perform operations associated with processing data created by the one or more devices. For example, the ESPE may receive data from the one or more network devices 204-209 shown in FIG. 2. As noted, the network devices may include sensors that sense different aspects of their environments, and may collect data over time based on those sensed observations. For example, the ESPE may be implemented within one or more of machines 220 and 240 shown in FIG. 2. The ESPE may be implemented within such a machine by an ESP application. An ESP application may embed an ESPE with its own dedicated thread pool or pools into its application space where the main application thread can do application-specific work and the ESPE processes event streams at least by creating an instance of a model into processing objects.

The engine container is the top-level container in a model that manages the resources of the one or more projects 802. In an illustrative embodiment, for example, there may be only one ESPE 800 for each instance of the ESP application, and ESPE 800 may have a unique engine name. Additionally, the one or more projects 802 may each have unique project names, and each query may have a unique continuous query name and begin with a uniquely named source window of the one or more source windows 806. ESPE 800 may or may not be persistent.

Continuous query modeling involves defining directed graphs of windows for event stream manipulation and transformation. A window in the context of event stream manipulation and transformation is a processing node in an event stream processing model. A window in a continuous query can perform aggregations, computations, pattern-matching, and other operations on data flowing through the window. A continuous query may be described as a directed graph of source, relational, pattern matching, and procedural windows. The one or more source windows 806 and the one or more derived windows 808 represent continuously executing queries that generate updates to a query result set as new event blocks stream through ESPE 800. A directed graph, for example, is a set of nodes connected by edges, where the edges have a direction associated with them.

An event object may be described as a packet of data accessible as a collection of fields, with at least one of the fields defined as a key or unique identifier (ID). The event object may be created using a variety of formats including binary, alphanumeric, XML, etc. Each event object may include one or more fields designated as a primary identifier (ID) for the event so ESPE 800 can support operation codes (opcodes) for events including insert, update, upsert, and delete. Upsert opcodes update the event if the key field already exists; otherwise, the event is inserted. For illustration, an event object may be a packed binary representation of a set of field values and include both metadata and field data associated with an event. The metadata may include an opcode indicating if the event represents an insert, update, delete, or upsert, a set of flags indicating if the event is a normal, partial-update, or a retention generated event from retention policy management, and a set of microsecond timestamps that can be used for latency measurements.

An event block object may be described as a grouping or package of event objects. An event stream may be described as a flow of event block objects. A continuous query of the one or more continuous queries 804 transforms a source event stream made up of streaming event block objects published into ESPE 800 into one or more output event streams using the one or more source windows 806 and the one or more derived windows 808. A continuous query can also be thought of as data flow modeling.

The one or more source windows 806 are at the top of the directed graph and have no windows feeding into them. Event streams are published into the one or more source windows 806, and from there, the event streams may be directed to the next set of connected windows as defined by the directed graph. The one or more derived windows 808 are all instantiated windows that are not source windows and that have other windows streaming events into them. The one or more derived windows 808 may perform computations or transformations on the incoming event streams. The one or more derived windows 808 transform event streams based on the window type (that is operators such as join, filter, compute, aggregate, copy, pattern match, procedural, union, etc.) and window settings. As event streams are published into ESPE 800, they are continuously queried, and the resulting sets of derived windows in these queries are continuously updated.

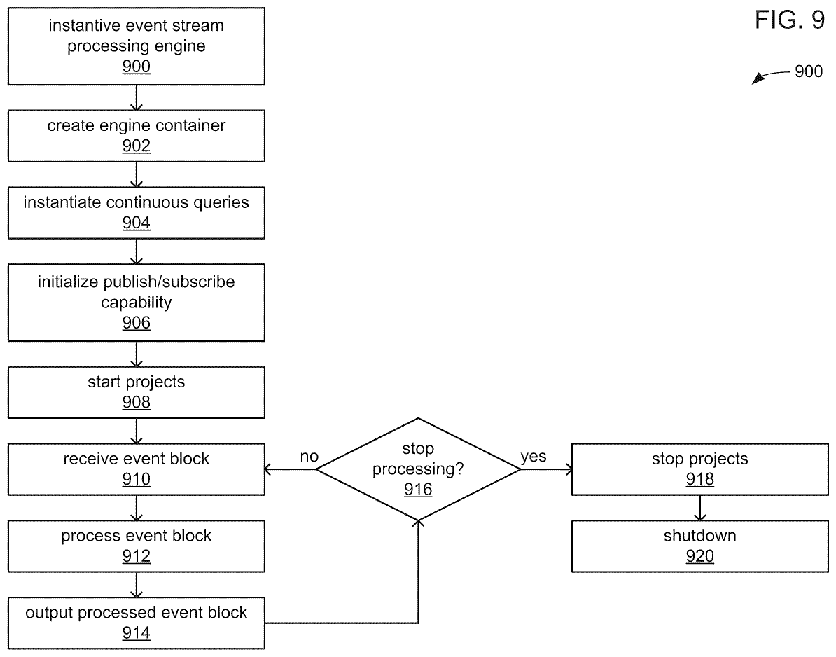

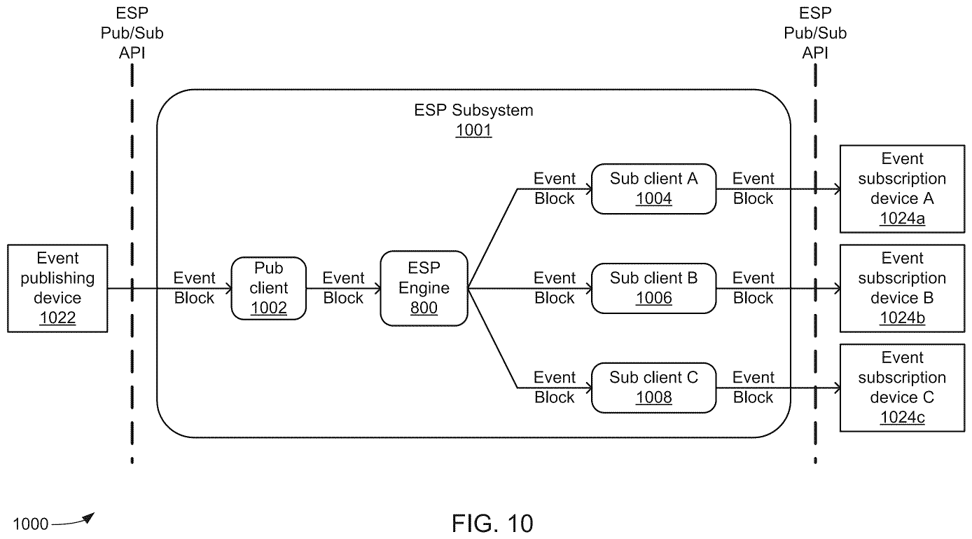

FIG. 9 illustrates a flow chart showing an example process including operations performed by an event stream processing engine, according to some embodiments of the present technology. As noted, the ESPE 800 (or an associated ESP application) defines how input event streams are transformed into meaningful output event streams. More specifically, the ESP application may define how input event streams from publishers (e.g., network devices providing sensed data) are transformed into meaningful output event streams consumed by subscribers (e.g., a data analytics project being executed by a machine or set of machines).

Within the application, a user may interact with one or more user interface windows presented to the user in a display under control of the ESPE independently or through a browser application in an order selectable by the user. For example, a user may execute an ESP application, which causes presentation of a first user interface window, which may include a plurality of menus and selectors such as drop down menus, buttons, text boxes, hyperlinks, etc. associated with the ESP application as understood by a person of skill in the art. As further understood by a person of skill in the art, various operations may be performed in parallel, for example, using a plurality of threads.

At operation 900, an ESP application may define and start an ESPE, thereby instantiating an ESPE at a device, such as machine 220 and/or 240. In an operation 902, the engine container is created. For illustration, ESPE 800 may be instantiated using a function call that specifies the engine container as a manager for the model.

In an operation 904, the one or more continuous queries 804 are instantiated by ESPE 800 as a model. The one or more continuous queries 804 may be instantiated with a dedicated thread pool or pools that generate updates as new events stream through ESPE 800. For illustration, the one or more continuous queries 804 may be created to model business processing logic within ESPE 800, to predict events within ESPE 800, to model a physical system within ESPE 800, to predict the physical system state within ESPE 800, etc. For example, as noted, ESPE 800 may be used to support sensor data monitoring and management (e.g., sensing may include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, or electrical current, etc.).

ESPE 800 may analyze and process events in motion or “event streams.” Instead of storing data and running queries against the stored data, ESPE 800 may store queries and stream data through them to allow continuous analysis of data as it is received. The one or more source windows 806 and the one or more derived windows 808 may be created based on the relational, pattern matching, and procedural algorithms that transform the input event streams into the output event streams to model, simulate, score, test, predict, etc. based on the continuous query model defined and application to the streamed data.

In an operation 906, a publish/subscribe (pub/sub) capability is initialized for ESPE 800. In an illustrative embodiment, a pub/sub capability is initialized for each project of the one or more projects 802. To initialize and enable pub/sub capability for ESPE 800, a port number may be provided. Pub/sub clients can use a host name of an ESP device running the ESPE and the port number to establish pub/sub connections to ESPE 800.

FIG. 10 illustrates an ESP system 1000 interfacing between publishing device 1022 and event subscribing devices 1024a-c, according to embodiments of the present technology. ESP system 1000 may include ESP device or subsystem 851, event publishing device 1022, an event subscribing device A 1024a, an event subscribing device B 1024b, and an event subscribing device C 1024c. Input event streams are output to ESP device 851 by publishing device 1022. In alternative embodiments, the input event streams may be created by a plurality of publishing devices. The plurality of publishing devices further may publish event streams to other ESP devices. The one or more continuous queries instantiated by ESPE 800 may analyze and process the input event streams to form output event streams output to event subscribing device A 1024a, event subscribing device B 1024b, and event subscribing device C 1024c. ESP system 1000 may include a greater or a fewer number of event subscribing devices of event subscribing devices.

Publish-subscribe is a message-oriented interaction paradigm based on indirect addressing. Processed data recipients specify their interest in receiving information from ESPE 800 by subscribing to specific classes of events, while information sources publish events to ESPE 800 without directly addressing the receiving parties. ESPE 800 coordinates the interactions and processes the data. In some cases, the data source receives confirmation that the published information has been received by a data recipient.

A publish/subscribe API may be described as a library that enables an event publisher, such as publishing device 1022, to publish event streams into ESPE 800 or an event subscriber, such as event subscribing device A 1024a, event subscribing device B 1024b, and event subscribing device C 1024c, to subscribe to event streams from ESPE 800. For illustration, one or more publish/subscribe APIs may be defined. Using the publish/subscribe API, an event publishing application may publish event streams into a running event stream processor project source window of ESPE 800, and the event subscription application may subscribe to an event stream processor project source window of ESPE 800.

The publish/subscribe API provides cross-platform connectivity and endianness compatibility between ESP application and other networked applications, such as event publishing applications instantiated at publishing device 1022, and event subscription applications instantiated at one or more of event subscribing device A 1024a, event subscribing device B 1024b, and event subscribing device C 1024c.

Referring back to FIG. 9, operation 906 initializes the publish/subscribe capability of ESPE 800. In an operation 908, the one or more projects 802 are started. The one or more started projects may run in the background on an ESP device. In an operation 910, an event block object is received from one or more computing device of the event publishing device 1022.

ESP subsystem 800 may include a publishing client 1002, ESPE 800, a subscribing client A 1004, a subscribing client B 1006, and a subscribing client C 1008. Publishing client 1002 may be started by an event publishing application executing at publishing device 1022 using the publish/subscribe API. Subscribing client A 1004 may be started by an event subscription application A, executing at event subscribing device A 1024a using the publish/subscribe API. Subscribing client B 1006 may be started by an event subscription application B executing at event subscribing device B 1024b using the publish/subscribe API. Subscribing client C 1008 may be started by an event subscription application C executing at event subscribing device C 1024c using the publish/subscribe API.

An event block object containing one or more event objects is injected into a source window of the one or more source windows 806 from an instance of an event publishing application on event publishing device 1022. The event block object may be generated, for example, by the event publishing application and may be received by publishing client 1002. A unique ID may be maintained as the event block object is passed between the one or more source windows 806 and/or the one or more derived windows 808 of ESPE 800, and to subscribing client A 1004, subscribing client B 1006, and subscribing client C 1008 and to event subscription device A 1024a, event subscription device B 1024b, and event subscription device C 1024c. Publishing client 1002 may further generate and include a unique embedded transaction ID in the event block object as the event block object is processed by a continuous query, as well as the unique ID that publishing device 1022 assigned to the event block object.

In an operation 912, the event block object is processed through the one or more continuous queries 804. In an operation 914, the processed event block object is output to one or more computing devices of the event subscribing devices 1024a-c. For example, subscribing client A 1004, subscribing client B 1006, and subscribing client C 1008 may send the received event block object to event subscription device A 1024a, event subscription device B 1024b, and event subscription device C 1024c, respectively.

ESPE 800 maintains the event block containership aspect of the received event blocks from when the event block is published into a source window and works its way through the directed graph defined by the one or more continuous queries 804 with the various event translations before being output to subscribers. Subscribers can correlate a group of subscribed events back to a group of published events by comparing the unique ID of the event block object that a publisher, such as publishing device 1022, attached to the event block object with the event block ID received by the subscriber.

In an operation 916, a determination is made concerning whether or not processing is stopped. If processing is not stopped, processing continues in operation 910 to continue receiving the one or more event streams containing event block objects from the, for example, one or more network devices. If processing is stopped, processing continues in an operation 918. In operation 918, the started projects are stopped. In operation 920, the ESPE is shutdown.

As noted, in some embodiments, big data is processed for an analytics project after the data is received and stored. In other embodiments, distributed applications process continuously flowing data in real-time from distributed sources by applying queries to the data before distributing the data to geographically distributed recipients. As noted, an event stream processing engine (ESPE) may continuously apply the queries to the data as it is received and determines which entities receive the processed data. This allows for large amounts of data being received and/or collected in a variety of environments to be processed and distributed in real time. For example, as shown with respect to FIG. 2, data may be collected from network devices that may include devices within the internet of things, such as devices within a home automation network. However, such data may be collected from a variety of different resources in a variety of different environments. In any such situation, embodiments of the present technology allow for real-time processing of such data.

Aspects of the current disclosure provide technical solutions to technical problems, such as computing problems that arise when an ESP device fails which results in a complete service interruption and potentially significant data loss. The data loss can be catastrophic when the streamed data is supporting mission critical operations such as those in support of an ongoing manufacturing or drilling operation. An embodiment of an ESP system achieves a rapid and seamless failover of ESPE running at the plurality of ESP devices without service interruption or data loss, thus significantly improving the reliability of an operational system that relies on the live or real-time processing of the data streams. The event publishing systems, the event subscribing systems, and each ESPE not executing at a failed ESP device are not aware of or effected by the failed ESP device. The ESP system may include thousands of event publishing systems and event subscribing systems. The ESP system keeps the failover logic and awareness within the boundaries of out-messaging network connector and out-messaging network device.

In one example embodiment, a system is provided to support a failover when event stream processing (ESP) event blocks. The system includes, but is not limited to, an out-messaging network device and a computing device. The computing device includes, but is not limited to, a processor and a computer-readable medium operably coupled to the processor. The processor is configured to execute an ESP engine (ESPE). The computer-readable medium has instructions stored thereon that, when executed by the processor, cause the computing device to support the failover. An event block object is received from the ESPE that includes a unique identifier. A first status of the computing device as active or standby is determined. When the first status is active, a second status of the computing device as newly active or not newly active is determined. Newly active is determined when the computing device is switched from a standby status to an active status. When the second status is newly active, a last published event block object identifier that uniquely identifies a last published event block object is determined. A next event block object is selected from a non-transitory computer-readable medium accessible by the computing device. The next event block object has an event block object identifier that is greater than the determined last published event block object identifier. The selected next event block object is published to an out-messaging network device. When the second status of the computing device is not newly active, the received event block object is published to the out-messaging network device. When the first status of the computing device is standby, the received event block object is stored in the non-transitory computer-readable medium.

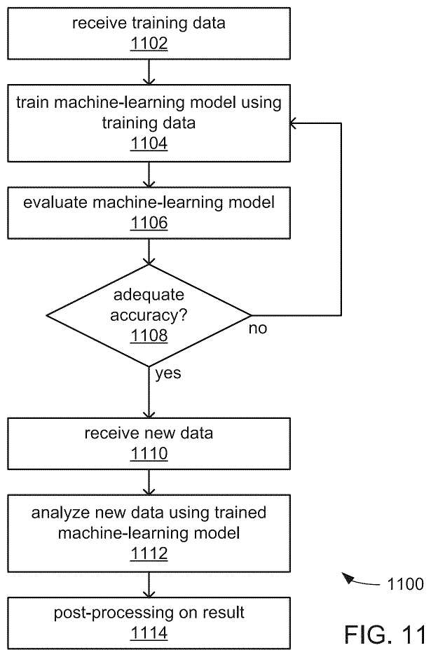

FIG. 11 is a flow chart of an example of a process for generating and using a machine-learning model according to some aspects. Machine learning is a branch of artificial intelligence that relates to mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusterers, such as k-means clusterers, mean-shift clusterers, and spectral clusterers; (v) factorizers, such as factorization machines, principal component analyzers and kernel principal component analyzers; and (vi) ensembles or other combinations of machine-learning models. In some examples, neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these.

Different machine-learning models may be used interchangeably to perform a task. Examples of tasks that can be performed at least partially using machine-learning models include various types of scoring; bioinformatics; cheminformatics; software engineering; fraud detection; customer segmentation; generating online recommendations; adaptive websites; determining customer lifetime value; search engines; placing advertisements in real time or near real time; classifying DNA sequences; affective computing; performing natural language processing and understanding; object recognition and computer vision; robotic locomotion; playing games; optimization and metaheuristics; detecting network intrusions; medical diagnosis and monitoring; or predicting when an asset, such as a machine, will need maintenance.

Any number and combination of tools can be used to create machine-learning models. Examples of tools for creating and managing machine-learning models can include SAS® Enterprise Miner, SAS® Rapid Predictive Modeler, and SAS® Model Manager, SAS Cloud Analytic Services (CAS)®, SAS Viya® of all which are by SAS Institute Inc. of Cary, North Carolina.

Machine-learning models can be constructed through an at least partially automated (e.g., with little or no human involvement) process called training. During training, input data can be iteratively supplied to a machine-learning model to enable the machine-learning model to identify patterns related to the input data or to identify relationships between the input data and output data. With training, the machine-learning model can be transformed from an untrained state to a trained state. Input data can be split into one or more training sets and one or more validation sets, and the training process may be repeated multiple times. The splitting may follow a k-fold cross-validation rule, a leave-one-out-rule, a leave-p-out rule, or a holdout rule. An overview of training and using a machine-learning model is described below with respect to the flow chart of FIG. 11.

In block 1102, training data is received. In some examples, the training data is received from a remote database or a local database, constructed from various subsets of data, or input by a user. The training data can be used in its raw form for training a machine-learning model or pre-processed into another form, which can then be used for training the machine-learning model. For example, the raw form of the training data can be smoothed, truncated, aggregated, clustered, or otherwise manipulated into another form, which can then be used for training the machine-learning model.

In block 1104, a machine-learning model is trained using the training data. The machine-learning model can be trained in a supervised, unsupervised, or semi-supervised manner. In supervised training, each input in the training data is correlated to a desired output. This desired output may be a scalar, a vector, or a different type of data structure such as text or an image. This may enable the machine-learning model to learn a mapping between the inputs and desired outputs. In unsupervised training, the training data includes inputs, but not desired outputs, so that the machine-learning model has to find structure in the inputs on its own. In semi-supervised training, only some of the inputs in the training data are correlated to desired outputs.

In block 1106, the machine-learning model is evaluated. For example, an evaluation dataset can be obtained, for example, via user input or from a database. The evaluation dataset can include inputs correlated to desired outputs. The inputs can be provided to the machine-learning model and the outputs from the machine-learning model can be compared to the desired outputs. If the outputs from the machine-learning model closely correspond with the desired outputs, the machine-learning model may have a high degree of accuracy. For example, if 90% or more of the outputs from the machine-learning model are the same as the desired outputs in the evaluation dataset, the machine-learning model may have a high degree of accuracy. Otherwise, the machine-learning model may have a low degree of accuracy. The 90% number is an example only. A realistic and desirable accuracy percentage is dependent on the problem and the data.

In some examples, if, at 1108, the machine-learning model has an inadequate degree of accuracy for a particular task, the process can return to block 1104, where the machine-learning model can be further trained using additional training data or otherwise modified to improve accuracy. However, if, at 1108. the machine-learning model has an adequate degree of accuracy for the particular task, the process can continue to block 1110.

In block 1110, new data is received. In some examples, the new data is received from a remote database or a local database, constructed from various subsets of data, or input by a user. The new data may be unknown to the machine-learning model. For example, the machine-learning model may not have previously processed or analyzed the new data.

In block 1112, the trained machine-learning model is used to analyze the new data and provide a result. For example, the new data can be provided as input to the trained machine-learning model. The trained machine-learning model can analyze the new data and provide a result that includes a classification of the new data into a particular class, a clustering of the new data into a particular group, a prediction based on the new data, or any combination of these.

In block 1114, the result is post-processed. For example, the result can be added to, multiplied with, or otherwise combined with other data as part of a job. As another example, the result can be transformed from a first format, such as a time series format, into another format, such as a count series format. Any number and combination of operations can be performed on the result during post-processing.

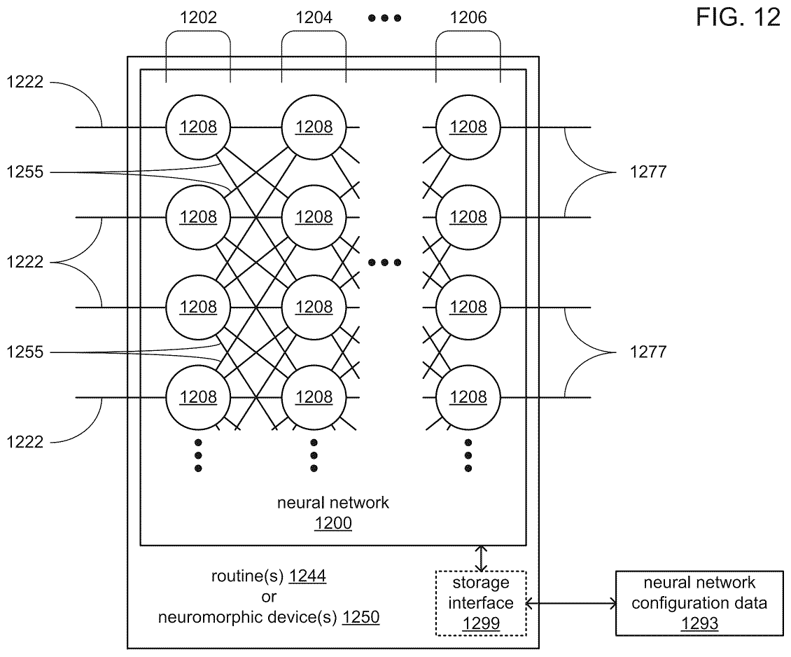

A more specific example of a machine-learning model is the neural network 1200 shown in FIG. 12. The neural network 1200 is represented as multiple layers of neurons 1208 that can exchange data between one another via connections 1255 that may be selectively instantiated thereamong. The layers include an input layer 1202 for receiving input data provided at inputs 1222, one or more hidden layers 1204, and an output layer 1206 for providing a result at outputs 1277. The hidden layer(s) 1204 are referred to as hidden because they may not be directly observable or have their inputs or outputs directly accessible during the normal functioning of the neural network 1200. Although the neural network 1200 is shown as having a specific number of layers and neurons for exemplary purposes, the neural network 1200 can have any number and combination of layers, and each layer can have any number and combination of neurons.

The neurons 1208 and connections 1255 thereamong may have numeric weights, which can be tuned during training of the neural network 1200. For example, training data can be provided to at least the inputs 1222 to the input layer 1202 of the neural network 1200, and the neural network 1200 can use the training data to tune one or more numeric weights of the neural network 1200. In some examples, the neural network 1200 can be trained using backpropagation. Backpropagation can include determining a gradient of a particular numeric weight based on a difference between an actual output of the neural network 1200 at the outputs 1277 and a desired output of the neural network 1200. Based on the gradient, one or more numeric weights of the neural network 1200 can be updated to reduce the difference therebetween, thereby increasing the accuracy of the neural network 1200. This process can be repeated multiple times to train the neural network 1200. For example, this process can be repeated hundreds or thousands of times to train the neural network 1200.

In some examples, the neural network 1200 is a feed-forward neural network. In a feed-forward neural network, the connections 1255 are instantiated and/or weighted so that every neuron 1208 only propagates an output value to a subsequent layer of the neural network 1200. For example, data may only move one direction (forward) from one neuron 1208 to the next neuron 1208 in a feed-forward neural network. Such a “forward” direction may be defined as proceeding from the input layer 1202 through the one or more hidden layers 1204, and toward the output layer 1206.

In other examples, the neural network 1200 may be a recurrent neural network. A recurrent neural network can include one or more feedback loops among the connections 1255, thereby allowing data to propagate in both forward and backward through the neural network 1200. Such a “backward” direction may be defined as proceeding in the opposite direction of forward, such as from the output layer 1206 through the one or more hidden layers 1204, and toward the input layer 1202. This can allow for information to persist within the recurrent neural network. For example, a recurrent neural network can determine an output based at least partially on information that the recurrent neural network has seen before, giving the recurrent neural network the ability to use previous input to inform the output.

In some examples, the neural network 1200 operates by receiving a vector of numbers from one layer; transforming the vector of numbers into a new vector of numbers using a matrix of numeric weights, a nonlinearity, or both; and providing the new vector of numbers to a subsequent layer (“subsequent” in the sense of moving “forward”) of the neural network 1200. Each subsequent layer of the neural network 1200 can repeat this process until the neural network 1200 outputs a final result at the outputs 1277 of the output layer 1206. For example, the neural network 1200 can receive a vector of numbers at the inputs 1222 of the input layer 1202. The neural network 1200 can multiply the vector of numbers by a matrix of numeric weights to determine a weighted vector. The matrix of numeric weights can be tuned during the training of the neural network 1200. The neural network 1200 can transform the weighted vector using a nonlinearity, such as a sigmoid tangent or the hyperbolic tangent. In some examples, the nonlinearity can include a rectified linear unit, which can be expressed using the equation y=max(x, 0) where y is the output and x is an input value from the weighted vector. The transformed output can be supplied to a subsequent layer (e.g., a hidden layer 1204) of the neural network 1200. The subsequent layer of the neural network 1200 can receive the transformed output, multiply the transformed output by a matrix of numeric weights and a nonlinearity, and provide the result to yet another layer of the neural network 1200 (e.g., another, subsequent, hidden layer 1204). This process continues until the neural network 1200 outputs a final result at the outputs 1277 of the output layer 1206.

As also depicted in FIG. 12, the neural network 1200 may be implemented either through the execution of the instructions of one or more routines 1244 by central processing units (CPUs), or through the use of one or more neuromorphic devices 1250 that incorporate a set of memristors (or other similar components) that each function to implement one of the neurons 1208 in hardware. Where multiple neuromorphic devices 1250 are used, they may be interconnected in a depth-wise manner to enable implementing neural networks with greater quantities of layers, and/or in a width-wise manner to enable implementing neural networks having greater quantities of neurons 1208 per layer.

The neuromorphic device 1250 may incorporate a storage interface 1299 by which neural network configuration data 1293 that is descriptive of various parameters and hyper parameters of the neural network 1200 may be stored and/or retrieved. More specifically, the neural network configuration data 1293 may include such parameters as weighting and/or biasing values derived through the training of the neural network 1200, as has been described. Alternatively, or additionally, the neural network configuration data 1293 may include such hyperparameters as the manner in which the neurons 1208 are to be interconnected (e.g., feed-forward or recurrent), the trigger function to be implemented within the neurons 1208, the quantity of layers and/or the overall quantity of the neurons 1208. The neural network configuration data 1293 may provide such information for more than one neuromorphic device 1250 where multiple ones have been interconnected to support larger neural networks.

Other examples of the present disclosure may include any number and combination of machine-learning models having any number and combination of characteristics. The machine-learning model(s) can be trained in a supervised, semi-supervised, or unsupervised manner, or any combination of these. The machine-learning model(s) can be implemented using a single computing device or multiple computing devices, such as the communications grid computing system 400 discussed above.

Implementing some examples of the present disclosure at least in part by using machine-learning models can reduce the total number of processing iterations, time, memory, electrical power, or any combination of these consumed by a computing device when analyzing data. For example, a neural network may more readily identify patterns in data than other approaches. This may enable the neural network to analyze the data using fewer processing cycles and less memory than other approaches, while obtaining a similar or greater level of accuracy.

Some machine-learning approaches may be more efficiently and speedily executed and processed with machine-learning specific processors (e.g., not a generic CPU). Such processors may also provide an energy savings when compared to generic CPUs. For example, some of these processors can include a graphical processing unit (GPU), an application-specific integrated circuit (ASIC), a field-programmable gate array (FPGA), an artificial intelligence (AI) accelerator, a neural computing core, a neural computing engine, a neural processing unit, a purpose-built chip architecture for deep learning, and/or some other machine-learning specific processor that implements a machine learning approach or one or more neural networks using semiconductor (e.g., silicon (Si), gallium arsenide (GaAs)) devices. These processors may also be employed in heterogeneous computing architectures with a number of and/or a variety of different types of cores, engines, nodes, and/or layers to achieve various energy efficiencies, processing speed improvements, data communication speed improvements, and/or data efficiency targets and improvements throughout various parts of the system when compared to a homogeneous computing architecture that employs CPUs for general purpose computing.

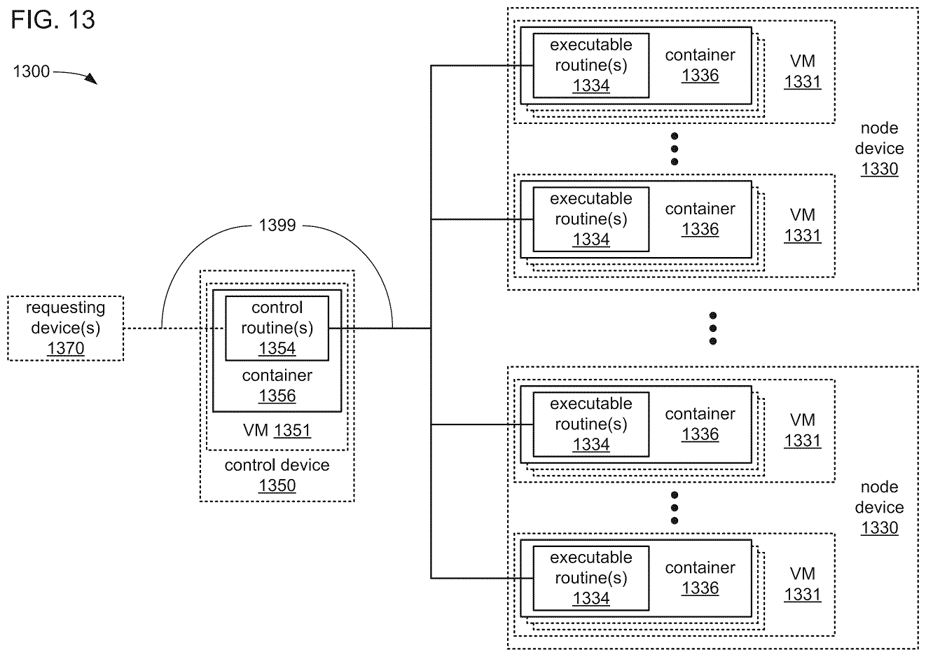

FIG. 13 illustrates various aspects of the use of containers 1336 as a mechanism to allocate processing, storage and/or other resources of a processing system 1300 to the performance of various analyses. More specifically, in a processing system 1300 that includes one or more node devices 1330 (e.g., the aforedescribed grid system 400), the processing, storage and/or other resources of each node device 1330 may be allocated through the instantiation and/or maintenance of multiple containers 1336 within the node devices 1330 to support the performance(s) of one or more analyses. As each container 1336 is instantiated, predetermined amounts of processing, storage and/or other resources may be allocated thereto as part of creating an execution environment therein in which one or more executable routines 1334 may be executed to cause the performance of part or all of each analysis that is requested to be performed.

It may be that at least a subset of the containers 1336 are each allocated a similar combination and amounts of resources so that each is of a similar configuration with a similar range of capabilities, and therefore, are interchangeable. This may be done in embodiments in which it is desired to have at least such a subset of the containers 1336 already instantiated prior to the receipt of requests to perform analyses, and thus, prior to the specific resource requirements of each of those analyses being known.

Alternatively, or additionally, it may be that at least a subset of the containers 1336 are not instantiated until after the processing system 1300 receives requests to perform analyses where each request may include indications of the resources required for one of those analyses. Such information concerning resource requirements may then be used to guide the selection of resources and/or the amount of each resource allocated to each such container 1336. As a result, it may be that one or more of the containers 1336 are caused to have somewhat specialized configurations such that there may be differing types of containers to support the performance of different analyses and/or different portions of analyses.

It may be that the entirety of the logic of a requested analysis is implemented within a single executable routine 1334. In such embodiments, it may be that the entirety of that analysis is performed within a single container 1336 as that single executable routine 1334 is executed therein. However, it may be that such a single executable routine 1334, when executed, is at least intended to cause the instantiation of multiple instances of itself that are intended to be executed at least partially in parallel. This may result in the execution of multiple instances of such an executable routine 1334 within a single container 1336 and/or across multiple containers 1336.

Alternatively, or additionally, it may be that the logic of a requested analysis is implemented with multiple differing executable routines 1334. In such embodiments, it may be that at least a subset of such differing executable routines 1334 are executed within a single container 1336. However, it may be that the execution of at least a subset of such differing executable routines 1334 is distributed across multiple containers 1336.

Where an executable routine 1334 of an analysis is under development, and/or is under scrutiny to confirm its functionality, it may be that the container 1336 within which that executable routine 1334 is to be executed is additionally configured assist in limiting and/or monitoring aspects of the functionality of that executable routine 1334. More specifically, the execution environment provided by such a container 1336 may be configured to enforce limitations on accesses that are allowed to be made to memory and/or I/O addresses to control what storage locations and/or I/O devices may be accessible to that executable routine 1334. Such limitations may be derived based on comments within the programming code of the executable routine 1334 and/or other information that describes what functionality the executable routine 1334 is expected to have, including what memory and/or I/O accesses are expected to be made when the executable routine 1334 is executed. Then, when the executable routine 1334 is executed within such a container 1336, the accesses that are attempted to be made by the executable routine 1334 may be monitored to identify any behavior that deviates from what is expected.

Where the possibility exists that different executable routines 1334 may be written in different programming languages, it may be that different subsets of containers 1336 are configured to support different programming languages. In such embodiments, it may be that each executable routine 1334 is analyzed to identify what programming language it is written in, and then what container 1336 is assigned to support the execution of that executable routine 1334 may be at least partially based on the identified programming language. Where the possibility exists that a single requested analysis may be based on the execution of multiple executable routines 1334 that may each be written in a different programming language, it may be that at least a subset of the containers 1336 are configured to support the performance of various data structure and/or data format conversion operations to enable a data object output by one executable routine 1334 written in one programming language to be accepted as an input to another executable routine 1334 written in another programming language.

As depicted, at least a subset of the containers 1336 may be instantiated within one or more VMs 1331 that may be instantiated within one or more node devices 1330. Thus, in some embodiments, it may be that the processing, storage and/or other resources of at least one node device 1330 may be partially allocated through the instantiation of one or more VMs 1331, and then in turn, may be further allocated within at least one VM 1331 through the instantiation of one or more containers 1336.

In some embodiments, it may be that such a nested allocation of resources may be carried out to effect an allocation of resources based on two differing criteria. By way of example, it may be that the instantiation of VMs 1331 is used to allocate the resources of a node device 1330 to multiple users or groups of users in accordance with any of a variety of service agreements by which amounts of processing, storage and/or other resources are paid for each such user or group of users. Then, within each VM 1331 or set of VMs 1331 that is allocated to a particular user or group of users, containers 1336 may be allocated to distribute the resources allocated to each VM 1331 among various analyses that are requested to be performed by that particular user or group of users.

As depicted, where the processing system 1300 includes more than one node device 1330, the processing system 1300 may also include at least one control device 1350 within which one or more control routines 1354 may be executed to control various aspects of the use of the node device(s) 1330 to perform requested analyses. By way of example, it may be that at least one control routine 1354 implements logic to control the allocation of the processing, storage and/or other resources of each node device 1300 to each VM 1331 and/or container 1336 that is instantiated therein. Thus, it may be the control device(s) 1350 that effects a nested allocation of resources, such as the aforedescribed example allocation of resources based on two differing criteria.

As also depicted, the processing system 1300 may also include one or more distinct requesting devices 1370 from which requests to perform analyses may be received by the control device(s) 1350. Thus, and by way of example, it may be that at least one control routine 1354 implements logic to monitor for the receipt of requests from authorized users and/or groups of users for various analyses to be performed using the processing, storage and/or other resources of the node device(s) 1330 of the processing system 1300. The control device(s) 1350 may receive indications of the availability of resources, the status of the performances of analyses that are already underway, and/or still other status information from the node device(s) 1330 in response to polling, at a recurring interval of time, and/or in response to the occurrence of various preselected events. More specifically, the control device(s) 1350 may receive indications of status for each container 1336, each VM 1331 and/or each node device 1330. At least one control routine 1354 may implement logic that may use such information to select container(s) 1336, VM(s) 1331 and/or node device(s) 1330 that are to be used in the execution of the executable routine(s) 1334 associated with each requested analysis.

As further depicted, in some embodiments, the one or more control routines 1354 may be executed within one or more containers 1356 and/or within one or more VMs 1351 that may be instantiated within the one or more control devices 1350. It may be that multiple instances of one or more varieties of control routine 1354 may be executed within separate containers 1356, within separate VMs 1351 and/or within separate control devices 1350 to better enable parallelized control over parallel performances of requested analyses, to provide improved redundancy against failures for such control functions, and/or to separate differing ones of the control routines 1354 that perform different functions. By way of example, it may be that multiple instances of a first variety of control routine 1354 that communicate with the requesting device(s) 1370 are executed in a first set of containers 1356 instantiated within a first VM 1351, while multiple instances of a second variety of control routine 1354 that control the allocation of resources of the node device(s) 1330 are executed in a second set of containers 1356 instantiated within a second VM 1351. It may be that the control of the allocation of resources for performing requested analyses may include deriving an order of performance of portions of each requested analysis based on such factors as data dependencies thereamong, as well as allocating the use of containers 1336 in a manner that effectuates such a derived order of performance.

Where multiple instances of control routine 1354 are used to control the allocation of resources for performing requested analyses, such as the assignment of individual ones of the containers 1336 to be used in executing executable routines 1334 of each of multiple requested analyses, it may be that each requested analysis is assigned to be controlled by just one of the instances of control routine 1354. This may be done as part of treating each requested analysis as one or more “ACID transactions” that each have the four properties of atomicity, consistency, isolation and durability such that a single instance of control routine 1354 is given full control over the entirety of each such transaction to better ensure that either all of each such transaction is either entirely performed or is entirely not performed. As will be familiar to those skilled in the art, allowing partial performances to occur may cause cache incoherencies and/or data corruption issues.

As additionally depicted, the control device(s) 1350 may communicate with the requesting device(s) 1370 and with the node device(s) 1330 through portions of a network 1399 extending thereamong. Again, such a network as the depicted network 1399 may be based on any of a variety of wired and/or wireless technologies, and may employ any of a variety of protocols by which commands, status, data and/or still other varieties of information may be exchanged. It may be that one or more instances of a control routine 1354 cause the instantiation and maintenance of a web portal or other variety of portal that is based on any of a variety of communication protocols, etc. (e.g., a restful API). Through such a portal, requests for the performance of various analyses may be received from requesting device(s) 1370, and/or the results of such requested analyses may be provided thereto. Alternatively, or additionally, it may be that one or more instances of a control routine 1354 cause the instantiation of and maintenance of a message passing interface and/or message queues. Through such an interface and/or queues, individual containers 1336 may each be assigned to execute at least one executable routine 1334 associated with a requested analysis to cause the performance of at least a portion of that analysis.

Although not specifically depicted, it may be that at least one control routine 1354 may include logic to implement a form of management of the containers 1336 based on the Kubernetes container management platform promulgated by Could Native Computing Foundation of San Francisco, CA, USA. In such embodiments, containers 1336 in which executable routines 1334 of requested analyses may be instantiated within “pods” (not specifically shown) in which other containers may also be instantiated for the execution of other supporting routines. Such supporting routines may cooperate with control routine(s) 1354 to implement a communications protocol with the control device(s) 1350 via the network 1399 (e.g., a message passing interface, one or more message queues, etc.). Alternatively, or additionally, such supporting routines may serve to provide access to one or more storage repositories (not specifically shown) in which at least data objects may be stored for use in performing the requested analyses.

### Associated Processes

The present method describes a computer-implemented process for anomaly detection and remediation using a predictive maintenance pipeline. The computer-implemented process may transform sensor-derived anomaly detections associated with an industrial asset into one or more enriched asset alerts that may be contextually comprehensive, diagnostically actionable, and computationally efficient. Conventional anomaly detection systems may merely generate alerts that indicate a deviation from expected operation; however, such alerts lack the contextual parameters required to understand the underlying cause or prescribe corrective measures. The method described herein enables the generation of enriched asset alerts that are suitable for diagnostic assessment and automated or operator-driven remediation.

In one or more implementations, the predictive maintenance pipeline may include a sequence of interoperable applications operably connected through application programming interfaces. Each application may perform a distinct analytical or reasoning stage, including anomaly detection, diagnostic reasoning, retrieval-augmented data enrichment, and alert visualization. Invocation of these applications through application programming interface calls may allow the predictive maintenance pipeline to automatically orchestrate machine-learning, large language model, and data retrieval processes across distributed computing environments. The predictive maintenance pipeline may therefore exhibit modularity, scalability, and interoperability, enabling processing of data from different classes of industrial assets, including mechanical, electrical, or hybrid electromechanical systems, that may operate under heterogeneous communication protocols and data schemas.

The predictive maintenance pipeline may further provide technical improvements by enriching an existing asset alert data record rather than generating a new asset alert. Conventional maintenance frameworks may produce secondary or derivative alerts as new sensor data becomes available, resulting in duplication, redundant storage, and elevated computational load. The disclosed predictive maintenance pipeline may enrich the existing asset alert in place by embedding contextual, diagnostic, and reasoning data directly within the same alert data structure. Such in-place enrichment may reduce memory consumption, minimize alert fatigue by maintaining a single canonical record for each anomaly, and improve consistency across downstream visualization and control applications.

In some embodiments, the predictive maintenance pipeline may perform autonomous remediation actions based on the enriched asset alert. When a recommended maintenance task corresponds to a predefined automated maintenance task type, the predictive maintenance pipeline may execute control commands through connected programmable logic controllers or automation subsystems in real time or near real time. These operations may include adjusting actuator settings, recalibrating control variables, or resetting operational parameters such that the industrial asset automatically transitions from an anomalous state to a nominal state without requiring operator intervention. By completing this closed feedback loop between detection, diagnosis, and correction, the predictive maintenance pipeline may reduce downtime, improve reliability, and produce tangible operational changes in the physical environment in which the industrial asset operates.

The predictive maintenance pipeline described herein may further provide enhancements to graphical user interface technology. Traditional industrial maintenance platforms may require users to navigate across multiple disconnected user interfaces to investigate a target alert. The asset diagnostic graphical user interface described herein may display alert metadata, diagnostic reasoning outputs, and recommended maintenance tasks within a single visual context and may further include a conversational digital assistant that accepts natural-language queries related to the alert or asset. By minimizing interface transitions and redundant data rendering, the asset diagnostic graphical user interface may reduce processor and memory utilization, accelerate fault investigation, and improve the speed and accuracy of remediation across complex industrial systems.

In one or more implementations, the predictive maintenance pipeline may obtain sensor data from a set of sensors operably coupled with an industrial asset, process the sensor data using one or more anomaly detection algorithms, and generate an asset alert indicating that the industrial asset is operating or will operate in an anomalous state. The sensor data may include time-stamped measurements of one or more target attributes. The anomaly detection algorithm may include, by way of example, a support vector data description model, a supervised predictive maintenance model, or a pattern-matching algorithm that compares real-time sensor readings with reference baselines. The resulting asset alert may identify the detected anomaly and the specific measured values that caused its generation.

The predictive maintenance pipeline may extract, from the asset alert, alert metadata that characterizes the operating state of the industrial asset at the time of detection. Such alert metadata may include the measured values of one or more target attributes, the baseline or threshold used for comparison, the computed deviation magnitude, the corresponding sensor identifiers, and the operational mode of the industrial asset during the anomaly event. Embedding such metadata directly within the alert record or asset alert provides localized diagnostic context that minimizes the need for external data retrieval and accelerates downstream reasoning.

The predictive maintenance pipeline may further construct an asset diagnostic prompt that may integrate both the extracted alert metadata and a set of model instructions directing a large language model to perform a diagnostic assessment of the anomalous state. The model instructions may be represented in a structured, machine-interpretable control format and define diagnostic objectives, specify the alert metadata fields to be analyzed, impose domain-specific constraints, and establish the structure of the output including suspected components, probable root-cause factors, and recommended maintenance actions. Embedding the contextual sensor data and structured reasoning instructions within a single machine-readable prompt ensures that the diagnostic reasoning performed by the large language model is consistent, targeted, and reproducible.

In some embodiments, construction of the asset diagnostic prompt may be controlled by stored prompt construction instructions or by a predefined asset diagnostic prompt template retrieved from a repository. The prompt construction instructions may define which metadata fields to include, their sequence, and applicable formatting or validation parameters. The asset diagnostic prompt template may define diagnostic input slots corresponding to relevant operating characteristics. The predictive maintenance pipeline may populate each slot of the template with one or more corresponding sensor-derived values contained within the alert metadata, thereby generating a complete and schema-aligned prompt that preserves the operational context of the anomaly event.

The asset diagnostic prompt may then be transformed into an embedding representation that captures semantic relationships between the contextual data and the diagnostic objectives. As used herein, an embedding representation may refer to a numerical vector within a continuous, high-dimensional space in which semantically related operational states are positioned near each other while unrelated states are placed farther apart. In one example, the embedding representation may include a 1524-dimensional vector generated by a machine learning-based embedding model. This embedding representation may be used to query one or more heterogeneous asset-maintenance data collections, each maintaining its own embedding index. Only those data items within a defined similarity threshold of the embedding representation may be retrieved, ensuring that the returned results are semantically and operationally relevant to the detected anomaly.

The retrieved maintenance data items may be combined with the constructed asset diagnostic prompt to form an enriched diagnostic input for the large language model. The large language model may process this enriched input to generate a diagnostic inference that identifies the likely components contributing to the anomaly, provides a rationale grounded in both real-time sensor data and historical maintenance data, and outputs one or more recommended maintenance tasks or configuration changes. The predictive maintenance pipeline may incorporate this inference into the enriched asset alert, which may be displayed to operators or automatically transmitted to connected control systems for execution.

By embedding contextual metadata directly into the alert, standardizing diagnostic reasoning through structured prompts, and coupling retrieval-augmented reasoning with semantically filtered data collections, the predictive maintenance pipeline achieves technical improvements over traditional anomaly detection systems. These improvements include reduced diagnostic latency, lower computational overhead, real-time corrective capability, improved interpretability, and integration of visualization, analysis, and control within a single operational framework adaptable to diverse industrial environments.

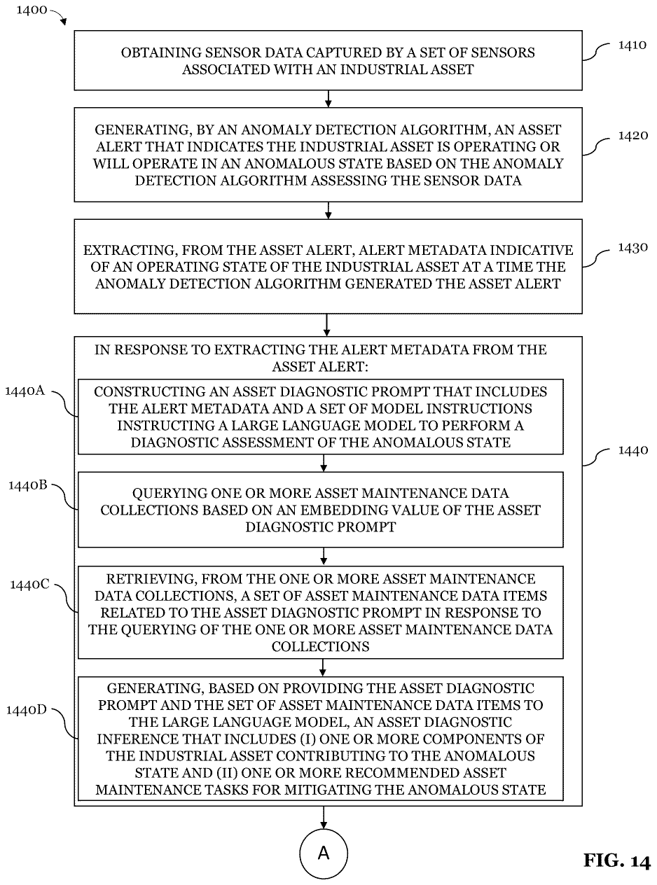

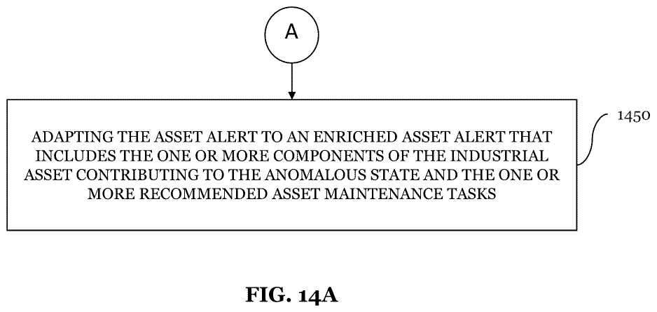

FIGS. 14-14A illustrate one implementation of a method 1400 for generating enriched asset alerts from sensor-derived anomaly detections using a retrieval-augmented-generation (RAG) pipeline and one or more large language models. Other implementations contemplated within the scope of the present application may involve more operations, fewer operations, different operations, or a different order of operations than as shown in FIGS. 14-14A. It should be noted that a computer-program product may include a non-transitory machine-readable storage medium storing computer instructions that, when executed by one or more operations, may perform operations corresponding to the processes and sub-processes of method 1400. Additionally, or alternatively, a computer-implemented method may include operations corresponding to processes and sub-processes of 1400. Additionally, or alternatively, a computer-implemented system may include one or more processors, a memory, and a computer-readable medium operably coupled to the one or more processors, the computer-readable medium having computer-readable instructions stored thereon that, when executed by the one or more processors, cause a computing device to perform operations corresponding to the processes and sub-processes of method 1400.

One of ordinary skill in the art will appreciate that the disclosed method 1400 may provide technical improvements in predictive maintenance workflows by transforming raw anomaly detections into actionable and contextually grounded enriched asset alerts. Traditional anomaly detection systems may typically generate alerts that merely identify deviations in measured attributes, e.g., without specifying the root causes of the anomaly or concrete remedial actions. This lack of diagnostic context may increase the mean time to repair (MTTR), thereby resulting in delayed remediation of anomalies. By contrast, the disclosed method 1400 may automatically integrate outputs of anomaly detection algorithms with a RAG pipeline that queries multiple collections of asset maintenance data. Such integration may reduce diagnostic overhead, accelerate root cause analysis, and/or improve the operational availability of industrial assets.

Further, conventional predictive maintenance systems may often be limited to preprogrammed rule-based mappings between detected anomalies and remedial instructions. These systems may fail when encountering novel or context-dependent failure scenarios. These systems may also often yield incomplete or inaccurate recommendations. The disclosed method 1400 may overcome these deficiencies by constructing asset diagnostic prompts enriched with alert metadata and by invoking one or more large language models that may reason across heterogeneous maintenance data collections. This configuration enables context-aware interpretation of anomaly alerts, disambiguation of symptoms across multiple subsystems, and generation of diagnostic inferences that include both suspected root causes and recommended maintenance tasks. As a result, the enriched asset alerts produced by the disclosed method 1400 may provide technicians with human-readable, evidence-backed instructions that reduce ambiguity and increase accuracy in maintenance decision-making.

The disclosed method 1400 may further improve system responsiveness by embedding evaluation and retrieval processes directly within the predictive maintenance pipeline. Moreover, the generation of enriched asset alerts as part of a continuous anomaly-to-diagnosis workflow may lower processing overhead, optimize memory allocation across edge and cloud components, and enable more efficient utilization of computing resources. Integration of RAG-powered diagnostic inference within predictive maintenance frameworks may therefore result in faster fault resolution, lower maintenance costs, and increased asset uptime across large-scale industrial environments.

### Obtaining Sensor Data Captured by a Set of Sensors Monitoring an Industrial Asset

In one or more embodiments, method 1400 may include process 1410. Process 1410, which may include obtaining raw sensor data captured by a set of sensors monitoring an industrial asset, may function to collect time-stamped measurement data and device metadata that characterize an operating state of an industrial asset for diagnostic processing. As used herein, industrial asset may refer to a physical apparatus that performs one or more tasks in a real-world environment, e.g., using mechanical components, electrical components, and/or digitally controlled components. Non-limiting examples of an industrial asset may include a gas turbine, an industrial fan driven by a motor, a robotic arm on a production line, a pump, a conveyor subsystem, a computer numerical control (CNC) spindle, and/or the like. As used herein, a set of sensors may refer to measurement devices affixed to, embedded in, or otherwise operably coupled with subsystems of the industrial asset. The set of sensors may generate raw sensor data at least including telemetry data corresponding to industrial assets at defined sampling rates or time intervals. Non-limiting examples of sensors may include accelerometers, vibration probes, strain gauges, thermocouples, resistance temperature detectors, pressure transducers, flow meters, Hall-effect current sensors, voltage taps, torque sensors, rotational speed encoders, proximity switches, acoustic microphones, and the like.

Further, raw sensor data may refer to unprocessed time-series samples, event records, and associated metadata emitted directly from the set of sensors. The raw sensor data may include unprocessed values emitted by one or more sets of sensors, such as but not limiting to, vibration amplitude (g), temperature reading (° C.), torque measurement (Nm), rotational speed (RPM), current (A), voltage (V), pressure (bar), flow rate (L/min), and the like. The associated metadata may include per-channel identifiers, timestamps, sampling intervals, engineering units, calibration states, edge time-synchronization indicators, quality flags, and the like. Process 1410 may include obtaining raw sensor data corresponding to a plurality of industrial assets such that a computing device (e.g., an anomaly detection system) may evaluate the raw sensor data and associated metadata to detect and remediate anomalous operations for one or more industrial assets.

In one implementation, raw sensor data may be obtained by an anomaly detection system through one or more data acquisition mechanisms. For example, analog signals outputted by one or more sensors may be first digitized by data acquisition circuitry of the anomaly detection system. The digitized signals may then be streamed into a buffer accessible to the anomaly detection system. In another example, one or more sensors may be network-connected and expose application programming interfaces (APIs) or publish telemetry to a message bus using standardized protocols such as Message Queuing Telemetry Transport (MQTT) or Open Platform Communications Unified Architecture (OPC-UA). In some other cases, programmable logic controllers or edge gateways may aggregate signals from multiple sensors and transmit batched data packets at fixed intervals to the anomaly detection system. These mechanisms may ensure that raw sensor data is ingested in real time or near real time simultaneously from a plurality of industrial assets, e.g., for subsequent anomaly detection and remediation.

In one or more embodiments, an anomaly detection system may include one or more computing systems, circuitries, and/or processing components configured to obtain raw event data generated by a set of sensors monitoring an industrial asset. The anomaly detection system may process the raw event data, e.g., by executing an anomaly detection algorithm, to produce an output indicating whether the industrial asset is operating within expected operating behavior or in an anomalous state.

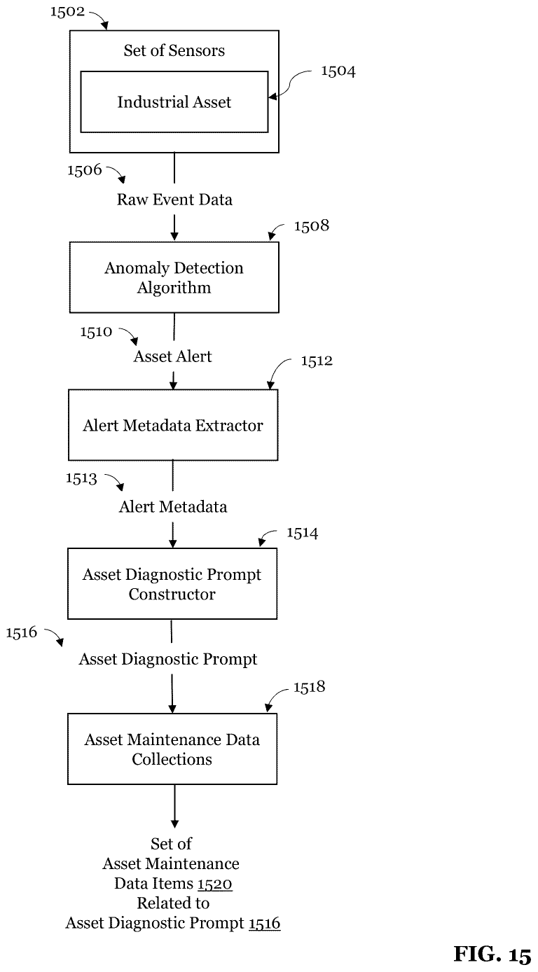

As shown in one non-limiting example in FIG. 15, an industrial asset 1504 may be monitored by a set of sensors 1502, wherein each sensor generates raw sensor data, which may be transmitted as raw event data 1506 to be processed by an anomaly detection algorithm 1508. In one implementation, the industrial asset 1504 may include mechanical components, electrical components, and/or digitally controlled components that operate together to perform one or more tasks in real-world environments. The set of sensors 1502 may capture physical and electrical attributes, resulting from performance of the one or more tasks, as raw sensor data. The raw sensor data may be streamed as raw event data 1506 to the anomaly detection system executing the anomaly detection algorithm 1508.

In one example, the industrial asset 1504 may include an industrial fan, e.g., installed in a manufacturing cell for process cooling or in a ventilation assembly for airflow regulation. The industrial fan may include mechanical components such as a shaft, pillow-block bearings, a hub, and a fan blade assembly that may convert rotational motion into airflow. The industrial fan may further include electrical components such as a motor, power conductors, and protection circuitry that may deliver electrical energy and convert the electrical energy into torque on the shaft. Furthermore, the industrial fan may include digitally controlled components such as a variable frequency drive that may regulate motor frequency and voltage, and/or a programmable logic controller (PLC) configured to execute interlocks and start-stop commands. In this example, the set of sensors 1502 may include accelerometers mounted near bearings, vibration probes on the housing, resistance temperature detectors attached to bearing caps, pressure transducers in the duct, flow meters in the airflow path, torque sensors within the shaft, rotational speed encoders on the motor, and/or the like. The raw sensor data generated by the set of sensors 1502 may include unprocessed measurement values such as vibration amplitude, temperature reading, duct pressure, airflow rate, electrical current, electrical voltage, torque, and rotational speed, together with associated timestamps and channel identifiers.

In another example, the industrial asset 1504 may include a gas turbine installed in a power generation facility. The gas turbine may include mechanical components such as a compressor, a turbine section, bearings, and a coupling to a generator. The gas turbine may further include electrical components such as excitation systems, power conditioning, and instrumentation power supplies. Furthermore, the gas turbine may include digitally controlled components such as a supervisory control system that executes control loops and exposes telemetry through an API. The set of sensors 1502 in this example, may include thermocouples on turbine stages, pressure transducers across the compressor, vibration probes on bearings, strain gauges on support structures, and/or current and voltage monitors on the generator lines. The raw sensor data generated by the sets of sensors 1502 may include temperature profiles, pressure ratios, vibration magnitudes, strain readings, electrical current, and electrical voltage readings that may characterize the operating state of the gas turbine.

In an implementation, the components of the industrial asset 1504 may operate in combination during normal service. For instance, for an industrial fan, a variable frequency drive may command a rotational speed, the motor may deliver torque, the shaft and bearings may transmit mechanical power, and the fan blades may move air through a duct. The set of sensors 1502 may measure the resulting physical and electrical attributes and may emit the raw sensor data in real time or near real time. Further, at least one sensor of the set of sensors 1502 may be operably configured to measure a target attribute of the industrial asset 1504. For example, the target attribute may correspond to a coolant flow rate of a power generation turbine, which may represent a measurable operational parameter indicative of the thermal regulation performance of the power generation turbine. The raw sensor data generated by the set of sensors 1502 may be inputted to the anomaly detection algorithm 1508 as raw event data 1506.

In one implementation, the anomaly detection system may execute the anomaly detection algorithm 1508 as one or more computational instructions stored in memory, e.g., to evaluate the raw event data 1506 to detect whether the industrial asset 1504 deviates from expected operating behavior. In an implementation, the expected operating behavior may be defined during commissioning, calibration, or verified periods of stable operation. The expected operating behavior may be represented as a numeric interval, e.g., a motor current between 12 amperes and 18 amperes. In another example, the expected operating behavior may be represented as a relationship between values, e.g., a compressor outlet pressure of at least 13 bar when a turbine inlet temperature equals 950° C. Expected operating behavior may also be represented as statistical distributions, cluster assignments, or model-defined boundaries that capture the normal operational range of the industrial asset 1504.

The anomaly detection algorithm 1508 may include one or more computational models for evaluating raw event data 1506 corresponding to the industrial asset 1504, e.g., to determine whether the industrial asset 1504 is operating or will operate in an anomalous state, i.e., anomalous to the expected operating behavior. These computational models may include, without limitation, a Support Vector Data Description (SVDD) model, a machine learning-based predictive maintenance model, and/or a pattern matching algorithm. In other embodiments, the anomaly detection algorithm 1508 may include one or more supervised or unsupervised learning models, e.g., trained to identify deviations in sensor data patterns associated with the industrial asset 1504. Examples of supervised machine learning models may include, without limitation, a random forest classifier, a gradient boosting model, a convolutional neural network (CNN) trained on time-series sensor traces, or a recurrent neural network (RNN) configured for temporal anomaly detection. Examples of unsupervised machine learning models may include, without limitation, a k-means clustering algorithm, a Gaussian mixture model (GMM), an autoencoder-based anomaly detection network, and a principal component analysis (PCA)-based residual error detector. In some embodiments, a combination of supervised and unsupervised models may be used.

In one or more alternate embodiments, the raw sensor data described herein may be replaced with, or supplemented by, synthetic data generated by one or more computational models. As used herein, synthetic data may refer to data that emulates one or more attributes of the industrial asset 1504 but may not be directly measured by any physical sensor of the set of sensors 1502. In some implementation, the synthetic data may be produced by an upstream simulation module, a generative machine learning model, or any data-synthesis component operably configured to output values in the same format, units, and structure as raw event data 1506.

In such embodiments, the synthetic data may represent estimated or simulated values of attributes of the industrial asset 1504, including but not limited to motor current, shaft torque, bearing temperature, airflow rate, fluid pressure, vibration amplitude, rotational speed, or turbine exhaust temperature. The synthetic data may be generated using one or more predictive or generative techniques, including interpolation from historical operating profiles, stochastic sampling from probability distributions learned from historical records, or inference produced by a machine learning model trained on prior raw sensor data.

In one or more embodiments, the synthetic data may substitute for raw sensor data when one or more sensors of the set of sensors 1502 is unavailable, malfunctioning, operating with degraded accuracy, or undergoing maintenance. For example, where a temperature sensor embedded in a turbine blade assembly is offline, a predictive model may generate synthetic values of turbine inlet temperature based on correlated measurements such as compressor discharge pressure, fuel flow rate, and rotor speed. In another non-limiting example, synthetic data may also be used to simulate rare or hazardous anomalous conditions that may not arise often during normal operation. For instance, a simulation model may generate synthetic vibration signatures for a gearbox undergoing early-stage gear-tooth fatigue, even though the industrial asset 1504 may not have yet exhibited such behavior in a live environment. This may allow testing, validation, or tuning of alert-handling and diagnostic processes without requiring real industrial assets to enter dangerous operating regimes.

Alternatively, the anomaly detection algorithm 1508 may process a hybrid input stream that includes both raw event data 1506 and synthetic data. For example, in a multi-sensor monitoring configuration for a hydraulic pump assembly, pressure transducer measurements of inlet pressure may be real-time sensor measurements, while flow-rate values may be synthetic estimates generated by a digital-twin model when the flow sensor is intermittently unavailable. Other embodiments are possible and are contemplated.

Generating, by the Anomaly Detection Algorithm, an Asset Alert that Indicates the Industrial Asset is Operating or Will Operate in an Anomalous State

In one or more embodiments, method 1400 may include process 1420. Process 1420, which may include generating, by the anomaly detection algorithm 1508, an asset alert that indicates the industrial asset 1504 is operating or will operate in an anomalous state, may function to transform raw sensor data obtained from one or more sensors from the set of sensors 1502 into a diagnostic output indicative of the presence of an abnormal or impending-fault condition for the industrial asset 1504. As shown in one non-limiting example in FIG. 15, the asset detection algorithm 1508 may generate an asset alert 1510, e.g., as a result of processing the raw event data 1506.

As used herein, an asset alert may refer to a machine-readable message, record, or output produced by the anomaly detection algorithm 1508 that conveys a determination that the industrial asset 1504 is not functioning within an expected operating behavior. The asset alert 1510 may include, without limitation, an alert type or code identifying the class of anomaly and a time stamp identifying when the asset alert 1510 was generated. In some implementations, the asset alert 1510 may further include additional context such as a baseline or threshold value used for comparison of raw event data 1506 received from one or more sensors of the set of sensors 1502, an anomaly score or confidence value generated by the anomaly detection algorithm 1508, and optional explanatory information identifying which raw event data 1506 that most strongly influenced the determination.

In one or more embodiments, the set of sensors 1502 may include at least one sensor operably configured to measure a target attribute of the industrial asset 1504. As used herein, a target attribute may refer to a measurable physical, electrical, thermal, and/or operational characteristic of the industrial asset 1504 that may be indicative of performance or condition of the industrial asset 1504. One or more non-limiting examples of a target attribute may include motor current, rotational speed, torque, vibration amplitude, bearing temperature, airflow rate, fluid pressure, or acoustic emission. The at least one sensor may be affixed to, embedded in, or otherwise operably coupled with a component of the industrial asset 1504 so that the at least one sensor may produce raw sensor data representing a measured value of the target attribute in real time or at defined sampling intervals.

In one or more embodiments, the raw sensor data may indicate the measured value of the target attribute at the time the anomaly detection algorithm 1508 generated the asset alert 1510. In other words, when the anomaly detection algorithm 1508 determines that the industrial asset 1502 is operating or will operate in an anomalous state, the raw sensor data may include the time-correlated value of the target attribute that triggered the determination. The anomaly detection algorithm 1508 may extract this measured value from the incoming raw event data 1506 and associate the measured value with the generated asset alert 1510. This way, the asset alert 1510 conveys the specific measured value of the target attribute at the moment of detection of the anomalous state of the industrial asset 1504, in addition to an indication that the anomalous state has been detected for the industrial asset 1504. Associating the measured value of the target attribute with the asset alert 1510 may enable the asset alert 1510 to convey the specific measurement that triggered the asset alert 1510, thereby allowing subsequent diagnostic or corrective actions to be based directly on the actual operating condition of the industrial asset 1504 at the moment the asset alert 1510 was generated.

In one embodiment, the anomaly detection algorithm 1508 may include executing a SVDD model trained using historical raw event data collected from the set of sensors 1502 while the industrial asset 1504 is operating without fault (i.e., during normal operation of the industrial asset 1504). Each training instance may include one or more target attributes expressed as numeric values with corresponding engineering units. The historical raw event data may be formatted into feature vectors, wherein each feature vector may represent an ordered set of numeric values corresponding to the target attributes. In some examples, the SVDD model may define a hypersphere around historical raw event data representing normal operation of the industrial asset 1504. A data point (e.g., target attribute value) may be flagged as an outlier when the data point lies outside this hypersphere. The SVDD model may therefore enable unsupervised detection of anomalous behavior of the industrial asset 1504 based on deviations from expected multivariate relationships.

During operation, the raw event data 1506 produced by the set of sensors 1502 may be processed into the same feature vector structure used during the training instances. Each feature vector may represent a measured value of a target attribute, such as motor current, motor voltage, or shaft speed. The SVDD model may process the one or more feature vectors to determine whether each feature vector lies inside or outside the closed boundary representing expected operating behavior. If all feature vectors lie inside the closed boundary, the industrial asset 1504 may be classified as functioning within expected operating behavior. However, if one or more feature vectors lie outside the closed boundary, the industrial asset 1504 may be classified as functioning outside of expected operating behavior, i.e., the industrial asset 1504 may be operating in an anomalous state. In such cases, the anomaly detection algorithm 1508 may generate the asset alert 1510 indicating that the industrial asset 1504 is operating or will operate in an anomalous state. The anomaly detection algorithm may further associate the asset alert 1510 with the measured value of the target attribute at the time the asset alert 1510 was generated.

In one non-limiting example, where the industrial asset 1504 includes an industrial fan, a given sensor of the set of sensors 1502 may generate raw event data 1506 representing the electrical current delivered to the fan motor of the industrial fan. Historical raw event data may indicate that when the industrial fan operates without fault, motor current values consistently fall between 12 amperes and 18 amperes. The SVDD model may train on these values and compute a closed boundary that encloses this numerical range of motor current (12 A to 18 A). During operation, the given sensor may produce raw event data, e.g., indicating that the motor current is 23 A. When formatted as a feature vector and evaluated against the closed boundary, the value of 23 A may fall outside the closed boundary. The SVDD model executed by the anomaly detection algorithm 1508 may therefore classify the industrial fan as operating or likely to operate in an anomalous state. The anomaly detection algorithm 1508 may further generate the asset alert 1510 indicating the current or impending anomalous state and associate the asset alert 1510 with the measured value of the target attribute (motor current of 23 A), at the time the asset alert 1510 is generated.

In another embodiment, the anomaly detection algorithm 1508 may include executing a machine-learning-based predictive-maintenance model, e.g., trained using historical raw event data collected from the set of sensors 1502 while the industrial asset 1504 is operating without fault (i.e., during normal operation of the industrial asset 1504). Each training instance for the predictive maintenance model may include a training dataset generated using historical raw event data at least comprising one or more target attributes corresponding to the industrial asset 1504, expressed as numeric values with corresponding engineering units. The historical raw event data may be formatted into feature vectors, wherein each feature vector may represent an ordered set of numeric values corresponding to the target attributes. Formatting the historical raw event data into feature vectors may enable the predictive maintenance model to process diverse target attributes using a consistent representation. This consistent representation may allow the predictive maintenance model to learn patterns among the target attributes that distinguish normal operation from patterns indicative of developing anomalies.

In one or more examples, the predictive maintenance model may be implemented as a supervised learning model, such as a gradient-boosted decision tree, a feed-forward neural network, or a recurrent neural network. By processing the feature vectors, e.g., along with labels indicating whether each training instance reflects fault-free or faulty operation, the predictive maintenance model may learn to recognize combinations of target attribute values that represent expected operating behavior and to identify alternative combinations that precede or accompany fault conditions.

During operation, the raw event data 1506 produced by the set of sensors 1502 may be processed into the same feature vector structure used during training. Each feature vector may represent a measured value of a target attribute, such as motor current, shaft torque, bearing temperature, or vibration amplitude. The predictive maintenance model may evaluate each feature vector to generate an anomaly score or a probability that the industrial asset 1504 is approaching or has entered an anomalous state. If the anomaly score or probability exceeds a defined threshold, the anomaly detection algorithm 1508 may classify the industrial asset 1504 as operating or likely to operate in an anomalous state. In such cases, the anomaly detection algorithm 1508 may generate the asset alert 1510 indicating the current or impending anomalous state. The anomaly detection algorithm 1508 may further associate the asset alert 1510 with the measured value of the target attribute at the time the asset alert 1510 was generated.

In one non-limiting example, where the industrial asset 1504 includes a gas turbine, the set of sensors 1502 may include a temperature sensor configured to measure turbine inlet temperature and a pressure transducer configured to measure compressor outlet pressure. Historical raw event data may indicate that during normal operation a turbine inlet temperature of 950° C. is normally associated with a compressor outlet pressure of at least 13 bar. The predictive maintenance model may be trained to recognize this pattern as indicative of expected operating behavior. During operation, the temperature sensor may record a turbine inlet temperature of 980° C., while the pressure transducer may record a compressor outlet pressure of 11 bar. When processed as a feature vector and evaluated by the predictive maintenance model, the combination of these target attribute values may be classified as indicative of a current or impending anomalous state, such as compressor degradation. The anomaly detection algorithm 1508 may therefore generate the asset alert 1510 indicating that the gas turbine is operating or likely to operate in an anomalous state. The anomaly detection algorithm 1508 may further associate the asset alert 1510 with the measured values of the target attributes (i.e., a turbine-inlet temperature of 980° C. and a compressor-outlet pressure of 11 bar) at the time the asset alert 1510 was generated.

In another implementation, the anomaly detection algorithm 1508 may include executing a pattern-matching algorithm configured to detect deviations in raw event data 1506 relative to predefined reference patterns that may each represent the expected operating behavior of the industrial asset 1504. Each reference pattern may include one or more target attributes expressed as numeric values with corresponding engineering units. The reference patterns may be derived from historical raw event data collected from the set of sensors 1502 while the industrial asset 1504 is operating without fault (i.e., during normal operation of the industrial asset 1504).

In one or more embodiments, the reference patterns may be stored in a memory of the anomaly detection system as baseline profiles, templates, or multi-attribute signatures, wherein each reference pattern captures characteristic associations among target attributes during normal operation. Each reference pattern may define an acceptable association or combination of values for the target attributes, such as motor current together with airflow rate, or duct pressure together with fan speed. During operation, the raw event data 1506 produced by the set of sensors 1502 may be processed into a comparable feature vector structure. Each feature vector may represent measured values of one or more target attributes, such as airflow rate, duct static pressure, or motor current. The pattern matching algorithm may be executed to compare each new feature vector against the stored reference patterns to determine whether the new feature vector matches at least one reference pattern within a defined tolerance.

If the new feature vector does not match any stored reference pattern within the defined tolerance, the anomaly detection algorithm 1508 may classify the industrial asset 1504 as operating or likely to operate in an anomalous state. In such cases, the anomaly detection algorithm 1508 may further generate the asset alert 1510 indicating the current or impending anomalous state. The anomaly detection algorithm 1508 may also associate the asset alert 1510 with the measured value of the target attribute at the time the asset alert 1510 was generated.

In one non-limiting example, where the industrial asset 1504 includes an industrial fan, the set of sensors 1502 may include an airflow sensor configured to measure volumetric airflow rate through a duct and a pressure transducer configured to measure static pressure within the duct. Historical raw event data collected during normal operation of the industrial fan may indicate that an airflow rate of 1,000 cubic meters per hour is normally associated with a duct static pressure of at least 1.6 bar. The pattern matching algorithm may utilize this combination of target attribute values as part of a reference pattern representing expected operating behavior.

During operation, the airflow sensor may record an airflow rate of 1,000 cubic meters per hour, while the pressure transducer may record a duct static pressure of 1.2 bar. When formatted as a feature vector and evaluated by the pattern matching algorithm, this combination may fail to match the reference pattern. The anomaly detection algorithm 1508 may therefore classify the industrial fan as operating or likely to operate in an anomalous state, for example indicating partial duct obstruction or fan-blade degradation. The anomaly detection algorithm 1508 may further generate the asset alert 1510 indicating the detected anomalous state and associate the asset alert 1510 with the measured values of the target attributes (i.e., an airflow rate of 1,000 cubic meters per hour and a duct static pressure of 1.2 bar), at the time the asset alert 1510 was generated.

In one or more alternate implementations, the anomaly detection algorithm 1508 may further include other algorithms or models, including, but not limited to, statistical threshold-based detectors, clustering-based detectors, frequency-domain analysis techniques, time-series forecasting models, rule-based and/or other ensemble approaches that combine outputs of two or more anomaly detection methods to improve sensitivity and robustness of detecting anomalous states of the industrial asset 1504.

In one or more embodiments, the anomaly detection algorithm 1508, whether implemented as a SVDD model, a predictive-maintenance model, and/or a pattern-matching algorithm may typically produce the asset alert 1510 that may include the measured values of target attributes along with an indication of a current or impending anomalous state of the industrial asset 1504. While the asset alert 1510 may serve as an early indicator of deviation from nominal operating behavior, the asset alert 1510 may lack contextual, causal, and historical data necessary for a complete diagnostic assessment for the industrial asset 1504. For instance, the asset alert 1510 may indicate that the temperature of a compressor stage exceeds a predefined threshold, but may not specify the underlying mechanical or operational cause of the anomaly. Moreover, because the asset alert 1510 may be generated directly by the anomaly detection algorithm 1508 focused on statistical deviation rather than interpretive reasoning, the asset alert 1510 may not inherently identify which subsystem or component of the industrial asset 1504 is responsible for the abnormal condition, nor may it suggest maintenance actions suitable for remediation. As a result, while the asset alert 1510 may provide critical real-time detection capability, its limited content may restrict the ability of remediation systems and/or operators to autonomously determine corrective measures.

In some embodiments, the asset alert 1510 may only include data that is limited to a binary or categorical indication of the anomalous state of the industrial asset 1504. For example, the asset alert 1510 may only indicate that the industrial asset 1504 is operating or likely to operate in an anomalous state. Such asset alerts may not include contextual details about the operating state of the industrial asset 1504 at the time the anomaly detection algorithm 1508 generates the asset alert 1510. For example, the asset alert 1510 may not include time-correlated measured values of target attributes or the degree of deviation of a target attribute from a normal range. As a result, the remediation systems must retrieve and correlate additional contextual information from raw data streams or logs, introducing latency and processing complexity.

Further, in real-time remediation workflows, e.g., wherein an automated remediation system or a human analyst must swiftly act to prevent further degradation of the industrial asset 1510, the lack of embedded contextual information in the asset alert 1510 hampers the ability to determine the appropriate corrective action. For instance, a remediation controller tasked with reducing fan load or adjusting turbine inlet pressure cannot rely solely on a binary “anomalous state” label without knowing which measurement crossed a threshold, by how much, and under what operating conditions. Similarly, a field analyst may require detailed metadata (e.g., sensor identifier, timestamped reading, associated operating mode) to correlate the detected anomaly with historical incidents or maintenance records. These limitations of the asset alert 1510 generated by the anomaly detection algorithm 1508 may therefore require execution of one or more processes beyond merely detecting anomalies, e.g., to autonomously extract and leverage contextual metadata associated with the asset alert 1510, in order to enrich the asset alert 1510 to become self-contained, interpretable, and actionable for downstream diagnostic, remediation, and decision-support functions.

Extracting, from the Asset Alert, Alert Metadata Indicative of an Operating State of the Industrial Asset at a Time the Anomaly Detection Algorithm Generated the Asset Alert

In one or more embodiments, method 1400 may further include process 1430. Process 1430, which may include extracting, from the asset alert 1510, alert metadata indicative of an operating state of the industrial asset 1504 at a time the anomaly detection algorithm 1508 generated the asset alert 1510, may function to augment the asset alert 1510 with technical information that characterizes the operational context in which an anomalous state for the industrial asset 1504 was detected. As discussed above with respect to process 1420, the anomaly detection algorithm 1508 may produce the asset alert 1510 that may include a binary or categorical indication that the industrial asset 1504 is operating or likely to operate in an anomalous state along with values of one or more target attributes measured by the set of sensors 1502. Such asset alerts may often omit critical contextual information, including but not limited to, the identification of the particular sensor or sensors whose sensor values triggered the anomaly determination, any baseline or threshold values used for comparison, the computed deviation of the measured value of a target attribute from the expected operating behavior, timestamped readings of other relevant target attributes, and/or other time-correlated operating-mode parameters of the industrial asset 1504. The absence of such contextual information may force remediation controllers, automated decision-support modules, or other remediation systems to retrieve, align, and correlate additional records from logs, OEM manuals, service bulletins, or past incident reports before deciding on a suitable remediation plan, thereby introducing processing latency and complicating timely and effective remedial action.

Process 1430 may include autonomously extracting, from the asset alert 1510, alert metadata. In one or more embodiments, the alert metadata extracted from the asset alert 1510 may encompass any data elements that characterize the operational context of the industrial asset 1504 at the time the anomaly detection algorithm 1508 generated the asset alert 1510. The alert metadata may include, without limitation, sensor identifiers, corresponding sensor readings, timestamps, equipment identifiers, operating-mode parameters, and/or computed deviation metrics derived from the assessed sensor data. In some implementations, the alert metadata may further include structured or unstructured fields such as fault codes generated by an on-board controller, alarm identifiers, maintenance cycle indicators, and environmental parameters recorded by auxiliary monitoring systems. The alert metadata may function as a comprehensive contextual record of the detected anomalous state of the industrial asset 1504, aggregating both raw event data 1506 and associated descriptive information that together define the anomalous event for subsequent diagnostic processing.

In the non-limiting example shown in FIG. 15, the asset alert 1510 may be processed by alert metadata extractor 1512 to extract alert metadata 1513 from the asset alert 1510. The alert metadata 1513 may include, without limitation, the measured value of one or more target attributes at the time the asset alert 1510 was generated, the corresponding baseline or threshold values used by the anomaly detection algorithm 1508 in evaluating the raw event data 1506, one or more sensor identifiers associated with time-stamped sensor values, the computed degree or direction of deviation of such sensor values from the expected operating behavior, and/or the like. By embedding the alert metadata 1513 directly within the asset alert 1510, process 1430 may enable the anomaly detection system to deliver a diagnostic output that is intrinsically enriched and interpretable, thereby reducing the need for subsequent data retrieval and correlation and allowing diagnostic, remediation, and decision-support functions to respond promptly and with improved technical precision.

In one implementation, the alert metadata extractor 1512 may be configured as a software module executed by one or more processing units of the anomaly detection system and supported by a dedicated parsing library stored in non-volatile memory of the anomaly detection system. The alert metadata extractor 1512 may receive the asset alert 1510 generated by the anomaly detection algorithm 1508 and parse the asset alert 1510 to extract alert metadata 1513. The alert metadata 1513 may be written into a structured metadata record stored in a high-speed in-memory data store for access by subsequent diagnostic or remediation processes. In another implementation, the alert metadata extractor 1512 may further include a correlation sub-module configured to associate sequential asset alerts that pertain to the industrial asset 1502 within a defined time window. By linking temporally adjacent asset alerts into a consolidated metadata record, the alert metadata extractor 1512 may reduce redundant processing and enable the diagnostic pipeline to analyze a complete incident context rather than isolated alert fragments.

In one or more embodiments, the anomaly detection system may internally represent the asset alert 1510 as a structured digital record stored in memory, for example as a message object containing predefined fields such as alert type, timestamp, sensor identifier, sensor values, anomaly score, and other optional data fields. The alert metadata extractor 1512 may be implemented as a computational routine that parses this structured digital record, e.g., to select one or more fields, and extract alert metadata 1513 that describes the operating state of the industrial asset 1504 at the time the asset alert 1504 was generated. By extracting and associating the alert metadata 1513 with the asset alert 1510, process 1430 may enable detection and remediation processes to interpret the asset alert 1510 in the context of the operating state of the industrial asset 1504, without separately querying other data sources for contextual information.

By way of example, when the industrial asset 1504 includes an industrial fan, the anomaly detection algorithm 1508 may generate the asset alert 1510 after determining that the duct static pressure value measured by a pressure transducer of the set of sensors 1502 is 1.2 bar. Further, at the time the anomaly detection algorithm 1508 generated the asset alert 1510, the duct static pressure may deviate from a baseline static pressure value (e.g., 1.6 bar) normally associated with an airflow rate of 1,000 m³/h. The alert metadata extractor 1512 may extract, from the asset alert 1510, alert metadata 1513 including the sensor identifier of the pressure transducer (e.g., “PT-101”), the measured value of the duct static-pressure measurement (e.g., 1.2 bar), the baseline reference value (e.g., 1.6 bar), the time-correlated airflow-sensor reading (1,000 m³/h), and a computed deviation metric indicating a 25% deficit relative to the baseline. The alert metadata 1513 may be stored in a structured data record corresponding to the asset alert 1510 generated for the industrial asset 1504.

In another non-limiting example, when the industrial asset 1504 includes a centrifugal pump, the anomaly detection algorithm 1508 may generate the asset alert 1510 responsive to determining that a vibration-amplitude value measured by a vibration probe of the set of sensors 1502 is 6.5 mm/s (RMS). Further, at the time the anomaly detection algorithm 1508 generated the asset alert 1510, the measured vibration-amplitude value may deviate from a baseline vibration-amplitude value (e.g., 3.0 mm/s RMS) normally associated with stable operating conditions at a nominal discharge pressure of 4.5 bar and a flow rate of 250 L/min. The alert metadata extractor 1512 may extract, from the asset alert 1510, alert metadata 1513 including the sensor identifier of the vibration probe (e.g., “VB-112”), the value of the vibration-amplitude measurement (e.g., 6.5 mm/s) at the time the asset alert 1510 was generated, the baseline reference value (e.g., 3.0 mm/s), the time-correlated discharge-pressure reading (e.g., 4.4 bar), the time-correlated flow-rate reading (e.g., 247 L/min), and a computed deviation metric indicating an increase of more than 115% relative to the baseline. The alert metadata 1513 may be stored in a structured data record corresponding to the asset alert 1510 generated for the centrifugal-pump-based industrial asset 1504, thereby providing a diagnostic context for remediation logic and/or maintenance processes.

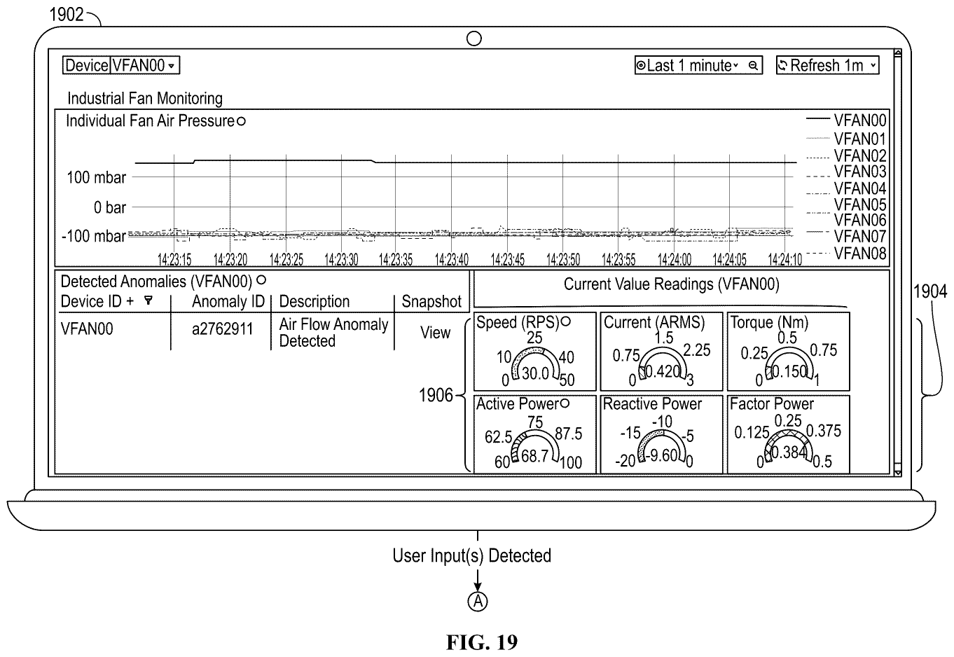

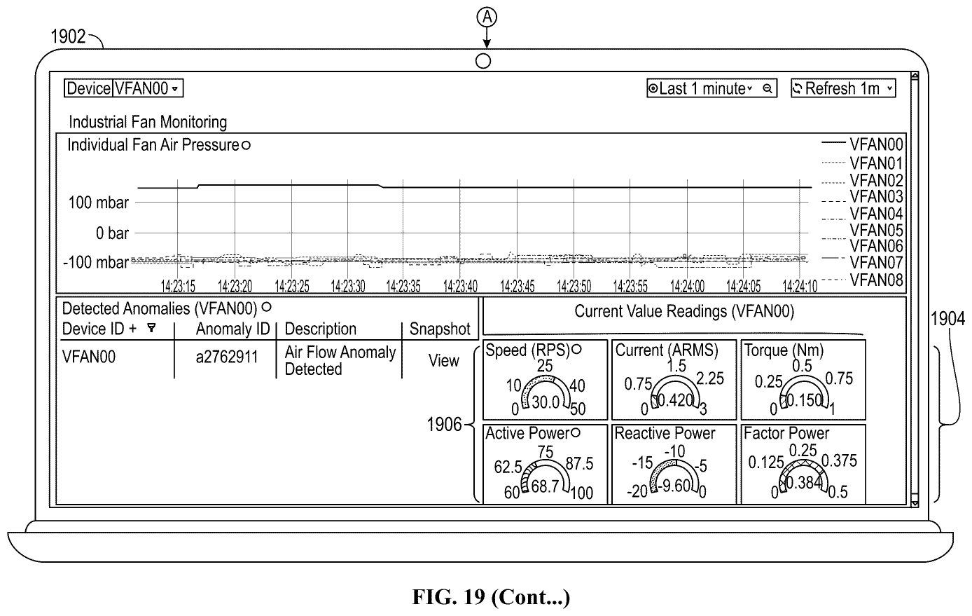

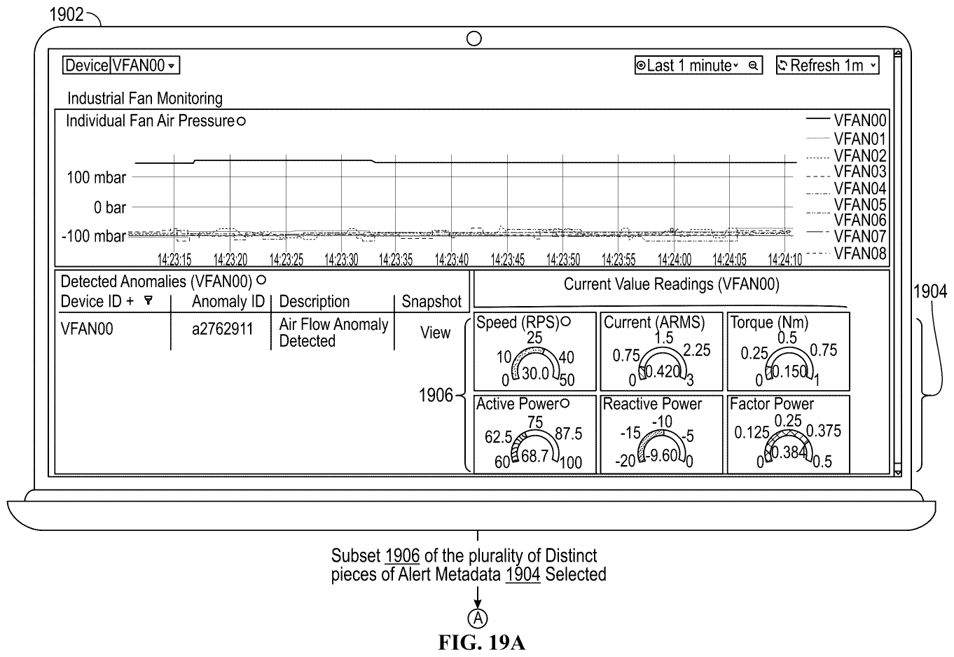

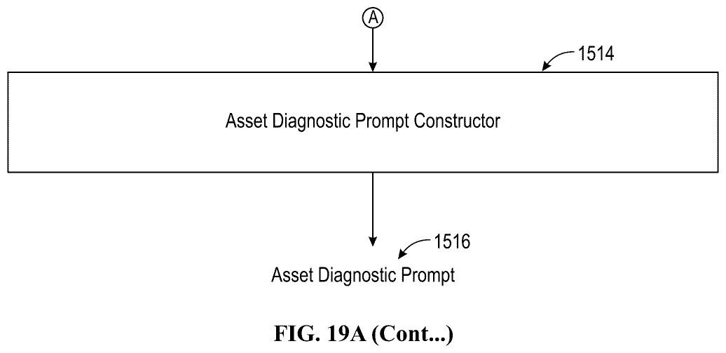

In one non-limiting example illustrated in FIG. 19, the asset alert 1510 may include a collection of current value readings corresponding to the industrial asset 1504. In this example, the industrial asset 1504 may correspond to an industrial cooling fan assembly identified as device “VFAN00.” The asset alert 1510 may include a device identifier (“VFAN00”), a unique anomaly ID (e.g., “a276291f1”), and an anomaly description (“Air Flow Anomaly Detected”). The asset alert 1510 may further include a snapshot of current value sensor readings captured at the time the anomaly detection algorithm 1508 generated the asset alert 1510. The current value readings may include a speed (RPS) of 30.0, a current (ARMS) of 0.420, a torque (Nm) of 0.150, an active power of 68.7, a reactive power of −9.60, and a power factor of 0.384. These current value sensor readings may represent instantaneous sensor values corresponding to one or more measured target attributes of the electrical and mechanical subsystems of the industrial fan. The alert metadata extractor 1512 may extract, from the asset alert 1510, alert metadata 1513 comprising at least these current value sensor readings.

In some embodiments, the alert metadata extractor 1512 may further retrieve a distinct set of prompt construction instructions corresponding to an asset alert type of the asset alert 1510. As described herein, “prompt construction instructions” may refer to a structured collection of machine-interpretable directives that specify how to organize, combine, and format the alert metadata 1513 for constructing an asset diagnostic prompt that is to be used by a large language model for autonomous diagnostic assessment of the industrial asset 1504. Stated another way, the prompt construction instructions may specify how an asset diagnostic prompt is to be constructed and how the LLM is required to perform the diagnostic assessment of the industrial asset 1504 based on the constructed asset diagnostic prompt. The prompt construction instructions may be stored in a persistent memory of the anomaly detection system, for example as a structured table in which each row corresponds to a distinct set of prompt construction instructions and each column specifies a directive, such as which metadata field to include, the ordering of fields, or the syntax for presenting them. In other examples, the prompt construction instructions may be stored as a hierarchical configuration file expressed in formats such as JSON, YAML, or XML, defining fields, formatting rules, and control parameters for assembling a prompt for the LLM. Other formats are possible and are contemplated.

In such embodiments, the alert metadata extractor 1512 may first determine a respective asset alert type of the asset alert 1510 from a plurality of predefined asset alert types. By determining the asset alert type for the asset alert 1510, the anomaly detection system may establish a semantic link between the detected anomaly and subsequent diagnostic processes. Further, based on the asset alert type, the alert metadata extractor 1512 may retrieve a distinct set of prompt construction instructions corresponding to the respective asset alert type of the asset alert 1510.

In one or more embodiments, the distinct set of prompt construction instructions may include at least two components. A first component may include a set of model instructions that specify, in a machine-interpretable format, one or more commands to be provided to the large language model for performing a diagnostic assessment of the anomalous state indicated by the asset alert 1510. A second component may include a set of metadata extraction instructions that may each specify which items of the alert metadata 1513 to be extracted from the asset alert 1510.

In an implementation, the set of model instructions may be formatted as a structured control specification, for example as a JavaScript Object Notation (JSON) object, an extensible markup language (XML) document, or another structured schema that may be machine-readable. The control specification may include, without limitation, fields such as diagnostic_objective, inputs, constraints, output_schema, and retrieval_directives. The diagnostic_objective field may define the intended purpose of the diagnostic process, for example identifying root-cause components that contribute to the anomalous state or ranking contributing factors according to probability. The inputs field may reference specific types of alert metadata 1513 that are to be consumed by the large language model, such as a measured value of a target attribute at the time the asset alert 1510 was generated, a baseline or threshold reference, a computed deviation metric, or time-correlated operating-mode parameters. The constraints field may specify requirements that the LLM must follow, for example to use specific engineering units, to avoid inferring values not provided by the alert metadata 1513, and to adhere to domain-specific nomenclature. The output_schema field may define the structure of the expected diagnostic assessment output, such as mandatory sections for suspected components, probable root causes, confidence scores, or recommended next-step actions. The retrieval_directives field, where present, may declare rules for later retrieval of external knowledge, for example specifying which maintenance data sources or OEM manuals may be queried using keys derived from the alert metadata 1513. Stated another way, the set of model instructions may define, for example, a query or instruction block that frames the diagnostic reasoning expected of the LLM.

The set of metadata extraction instructions may define, for example, explicit field references or data-schema mappings for extracting data elements from the alert metadata 1513 that characterize the operating state of the industrial asset 1504 at the time the asset alert 1510 was generated. In one example, the set of metadata extraction instructions may specify extraction of sensor identifiers, the measured value of target attributes at the time of the asset alert 1510 was generated, baseline values of target attributes, and/or associated deviation metrics.

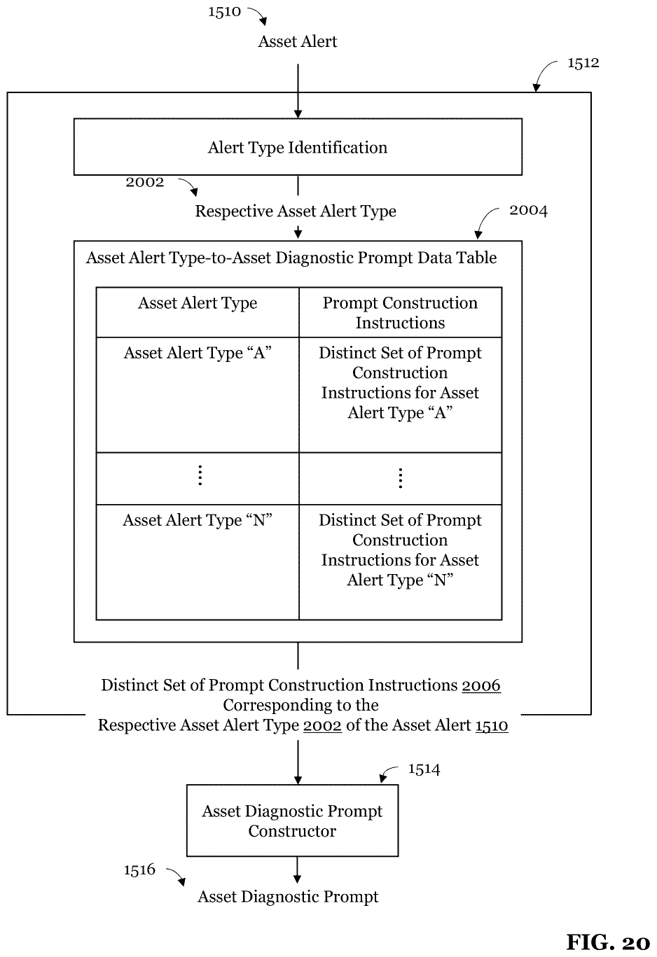

In one non-limiting example of FIG. 20, retrieval of a distinct set of prompt construction instructions 2006 corresponding to a respective asset alert type 2002 of the asset alert 1510 is illustrated. In one embodiment, as illustrated in FIG. 20, the alert metadata extractor 1512 may first determine the respective asset alert type 2002 that the asset alert 1510 corresponds to. The determination may be based, e.g., on parsing one or more fields included in the asset alert 1510, such as, but not limiting to, an asset alert code or identifier, the associated sensor identifiers, the measured values of the relevant target attributes at the time the asset alert 1510 was generated, the computed deviation metrics, and time-correlated operating-mode parameters. The alert metadata extractor 1512 may compare these parsed fields with reference patterns stored in one or more data repositories to identify the respective asset alert type 2002 of the asset alert 1510. The data repositories may include past incident reports, logs of field service interventions, original-equipment-manufacturer manuals, diagnostic templates, previously recorded asset alert types mapped to known fault categories, and/or the like. Based on the data accessed from the data repositories, the alert metadata extractor 1512 may assign the asset alert 1510 to the respective asset alert type 2002.

Upon determining the respective asset alert type 2002, the alert metadata extractor 1512 may query an asset alert type-to-asset diagnostic prompt data table 2004 using the determined asset alert type 2002 as a query parameter. The asset alert type-to-asset diagnostic prompt data table 2004 may associate each of a plurality of predefined asset alert types with a distinct set of prompt construction instructions to construct the asset diagnostic prompt. For instance, asset alert type “A” may be associated with a distinct set of prompt construction instructions for asset alert type “A,” asset alert type “B” may be associated with a distinct set of prompt construction instructions for asset alert type “B,” asset alert type “N” may be associated with a distinct set of prompt construction instructions for asset alert type “N,” and so forth. Likewise, associations between all asset alert types and distinct sets of prompt construction instructions may be included in asset alert type-to-asset diagnostic prompt data table 2004. In an implementation, the asset alert type-to-asset diagnostic prompt data table 2004 may be stored in a memory accessible to the anomaly detection system, for example as a relational table with rows corresponding to asset alert types and columns containing a unique identifier for each asset alert type, an associated description, version and applicability metadata, and the corresponding distinct set of prompt construction instructions. In some implementations, the asset alert type-to-asset diagnostic prompt data table 2004 may alternatively be maintained as a key-value store or a document-oriented repository in which keys may correspond to asset alert types and stored values may contain the corresponding prompt construction instructions in a structured format.

In one non-limiting example, a given entry in the asset alert type-to-asset diagnostic prompt data table 2004, may include asset alert type A, as corresponding to “excessive gearbox vibration.” For asset alert type A, corresponding prompt construction instructions may include a set of model instructions that specify how an asset diagnostic prompt is to be constructed and how the LLM is required to perform the diagnostic assessment of the gearbox based on the constructed asset diagnostic prompt. The set of prompt construction instructions may further include a set of metadata extraction instructions defining directives to extract alert metadata 1513 from the asset alert 1510.

For instance, the set of metadata extraction instructions may specify extraction of sensor readings (e.g., vibration amplitude, baseline vibration threshold, rotational speed, and torque fluctuation data) from the asset alert 1510, at the time the anomaly detection algorithm 1508 generated the asset alert 1510. The extracted sensor readings may be inserted into corresponding input fields of an asset diagnostic prompt, thereby defining the current operational state of the gearbox at the onset of the anomalous state. The prompt construction instructions may further specify that the LLM is to analyze the vibration amplitude relative to the baseline threshold, correlate the rotational speed with known resonance bands, and cross-reference the historical gearbox maintenance records to infer whether the anomalous state arises from mechanical wear, misalignment, and/or imbalance. Thus, the distinct set of prompt construction instructions for asset alert type A may govern both the construction of the asset diagnostic prompt and the diagnostic assessment steps performed by the LLM using the asset diagnostic prompt, ensuring that the diagnostic assessment directly reflects the operating conditions captured when the anomalous state was detected.

In another example, a given entry in the asset alert type-to-asset diagnostic prompt data table 2004, may include asset alert type N, as corresponding to “hydraulic pressure fluctuation.” The prompt construction instructions may include a set of metadata extraction instructions to extract alert metadata 1513 from the asset alert 1510, e.g., sensor readings and operational parameters measured at the time the anomaly detection algorithm 1508 generated the asset alert 1510. These sensor readings may include, without limitation, instantaneous and baseline pressure values, fluctuation range, valve actuation states, and pump maintenance history. The extracted data may be inserted into respective input fields of the asset diagnostic prompt, thereby defining the operating context of the hydraulic system when the anomalous state was detected.

The prompt construction instructions may further include the set of model instructions, e.g., directing the LLM to assess the relationships between the instantaneous and baseline pressure values, evaluate the fluctuation range relative to permissible control tolerances, correlate valve actuation sequences with the timing of the detected pressure deviations, and cross-reference the pump maintenance history to identify potential degradation or blockage conditions contributing to the anomaly. Accordingly, the prompt construction instructions for asset alert type N may govern both the composition of the asset diagnostic prompt and the inferential reasoning performed by the LLM, ensuring that the diagnostic assessment reflects the actual operational state of the hydraulic system at the time of anomaly detection.

In one or more embodiments, the distinct set of prompt construction instructions 2006 may further include one or more model-level directives that may define the analytical reasoning operations to be performed by the LLM when assessing the anomalous state of industrial asset 1504. Such directives may instruct the LLM to analyze correlations between concurrently measured sensor values, evaluate temporal progressions of the operating parameters represented in the alert metadata 1513, compare the measured parameters with baseline reference profiles associated with the same or similar industrial assets, infer one or more potential root causes contributing to the anomalous state based on the detected parameter deviations, and/or determine a prioritization of candidate maintenance actions based on operational or safety considerations. In some implementations, the prompt construction instructions may also direct the LLM to compute or output one or more confidence metrics associated with the generated diagnostic assessment, thereby enabling other subsystems to determine whether subsequent verification or human review is required.

In some embodiments, the distinct set of prompt construction instructions 2006 associated with each entry in the asset alert type-to-asset diagnostic prompt data table 2004 may initially be generated by subject-matter experts, using historical fault analyses, incident reports, and/or recommended practice manuals to define which categories of alert metadata 1513 and contextual parameters should be emphasized for the respective asset alert type 2002 when constructing the asset diagnostic prompt 1516 for the LLM. The defined distinct set of prompt construction instructions 2006 may be refined over time based on performance feedback and/or by using automated tuning mechanisms to improve the diagnostic relevance of the asset alert type-to-asset diagnostic prompt data table 2004.

By incorporating both the set of model instructions and the set of metadata extraction instructions, the distinct set of prompt construction instructions 2006 retrieved from the asset alert type-to-asset diagnostic prompt data table 2004 may enable the asset diagnostic prompt constructor 1514 to automatically generate the asset diagnostic prompt 1516 that may not only be alert-type-specific but also complete in a diagnostic context. The LLM may therefore be provided with a structured prompt that includes both the relevant alert metadata 1513 and explicit diagnostic guidance, allowing the LLM to perform a targeted and technically precise assessment of the anomalous state reported in the asset alert 1510.

In one or more embodiments, the asset diagnostic prompt constructor 1514 may parse the distinct set of prompt construction instructions 2006 to determine both the structure and content of the asset diagnostic prompt 1516 to be constructed. As described in the foregoing, the distinct set of prompt construction instructions 2006 may define a schema that may specify one or more input data fields, each corresponding to a particular or distinct category of alert metadata 1513 to be inserted into the asset diagnostic prompt 1516, and one or more model instruction fields that describe the reasoning objectives and analytical constraints to be executed by the LLM. The asset diagnostic prompt constructor 1514 may instantiate a machine-readable object, for example, a structured document or serialized data representation, that includes the required fields populated with the values extracted from the asset alert 1510, together with the set of model instructions retrieved from the distinct set of prompt construction instructions 2006.

In some examples, the asset diagnostic prompt constructor 1514 may further perform one or more preprocessing operations defined in the distinct set of prompt construction instructions 2006 before embedding the values into the asset diagnostic prompt 1516. Such operations may include, without limitation, normalization of numerical sensor readings, unit conversions, aggregation of temporally adjacent samples, and/or association of the measured attributes with corresponding subsystems of the industrial asset 1504. The resulting asset diagnostic prompt 1516 may therefore constitute a structured input to the LLM, combining both the alert metadata 1513 reflective of the real-time operating condition of the industrial asset 1504 and the diagnostic reasoning objectives that guide the LLM toward generating a diagnostic inference.

In some embodiments, the asset diagnostic prompt constructor 1514 may validate the generated asset diagnostic prompt 1516 against one or more format constraints defined in the distinct set of prompt construction instructions 2006 to ensure compliance with syntactic and semantic requirements of the LLM. Upon validation, the asset diagnostic prompt 1516 may be transmitted to another component of the anomaly detection system for embedding generation and further retrieval-based contextual augmentation.

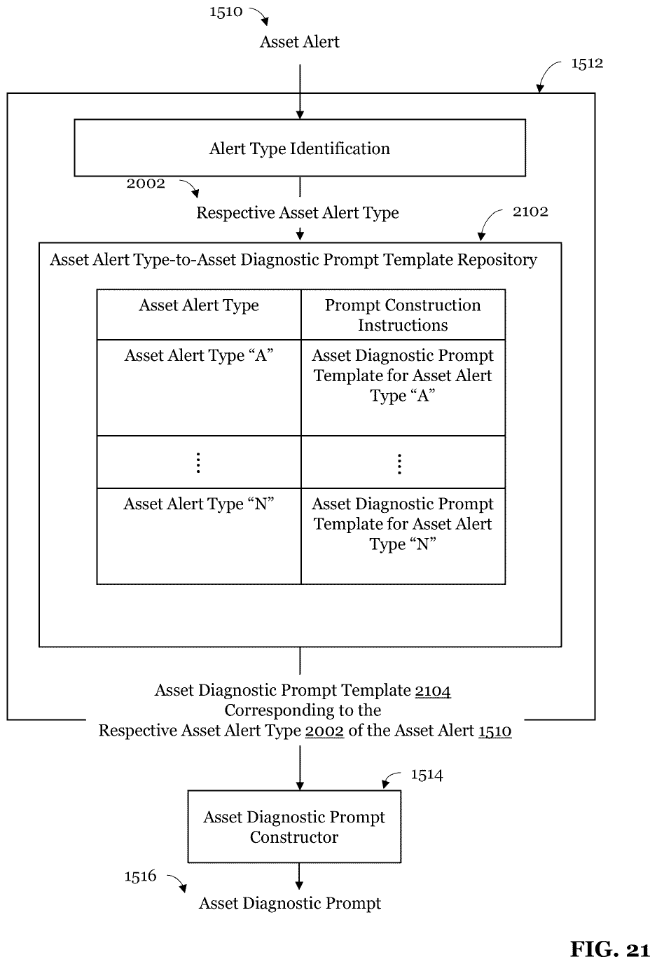

As shown in another non-limiting example of FIG. 21, extraction of the alert metadata 1513 from the asset alert 1510 by the alert metadata extractor 1512 may further include querying an asset alert type-to-asset diagnostic prompt template repository 2102 using the respective asset alert type 2002 as a query parameter. The alert metadata extractor 1512 may retrieve, from the asset alert type-to-asset diagnostic prompt template repository 2102, an asset diagnostic prompt template 2104 that corresponds to the respective asset alert type 2002 of the asset alert 1510.

In one or more embodiments, the term “asset diagnostic prompt template” may refer to a pre-defined, structured representation that may specify an arrangement and presentation of selected alert metadata 1513 together with model instructions intended for use in guiding a diagnostic assessment of an anomalous state of the industrial asset 1504. The asset diagnostic prompt template may serve as a reusable blueprint that defines the order and hierarchy in which information is to be combined, including the inclusion of particular metadata fields from the alert metadata 1513 that characterize the state of the industrial asset 1504 at the time the anomaly detection algorithm 1508 generated the asset alert 1510. In some implementations, each asset diagnostic prompt template may include a plurality of predefined input slots, with each input slot corresponding to a specific category of alert metadata 1513 or sensor-derived measurement, such as temperature, vibration, pressure, or flow rate. The asset diagnostic prompt constructor 1514 may populate each input slot of the asset diagnostic prompt template with corresponding sensor data extracted from the alert metadata 1513.

The asset diagnostic prompt template may further define control parameters such as the format of each field, the required syntax for structuring the overall input, and the placement of predefined instructions that describe the diagnostic reasoning task to be performed by the LLM. The asset diagnostic prompt template may be stored in the anomaly detection system in one or more machine-readable formats such as a structured table, a parameterized text template, or a configuration file expressed in JSON, YAML, or another markup or serialization language.

In the embodiment shown in FIG. 21, once the respective asset alert type 2002 is identified, the alert metadata extractor 1512 may query the asset alert type-to-asset diagnostic prompt template repository 2102 using the asset alert type 2002 as a key. The asset alert type-to-asset diagnostic prompt template repository 2102 may associate each predefined asset alert type with a distinct asset diagnostic prompt template 2104 tailored to the respective asset alert type 2002. In an implementation, the asset alert type-to-asset diagnostic prompt template repository 2102 may be implemented as a relational table or as a key value store in which keys represent asset alert types and stored values encapsulate the corresponding asset diagnostic prompt templates together with version and applicability metadata.

In one non-limiting example, an entry in the asset alert type-to-asset diagnostic prompt template repository 2102 may associate an asset alert type “A” with abnormal coolant-flow oscillation. The corresponding asset diagnostic prompt template 2104 may specify that the asset diagnostic prompt 1516 includes a plurality of predefined input slots, each slot corresponding to a distinct category of alert metadata 1513 or sensor-derived measurement relevant to the coolant system. For instance, the asset diagnostic prompt template 2104 may define separate input slots for instantaneous coolant-flow-rate readings at the time the asset alert 1510 was generated, baseline flow-rate measurements from stable operating periods, and valve-actuation histories that show how oscillation events align with control sequences. Additional input slots may be designated for pump-cavitation indices derived from acoustic or pressure sensors and for temperature-gradient measurements across the coolant circuit. The asset diagnostic prompt constructor 1514 may populate each slot of the asset diagnostic prompt template 2104 with the corresponding sensor values extracted from the alert metadata 1513, thereby producing a structured prompt that allows the LLM to evaluate the presence of hydraulic or thermal non-uniformities contributing to the detected anomaly.

In another non-limiting example, an entry in the asset alert type-to-asset diagnostic prompt template repository 2102 may associate an asset alert type “N” with transient voltage-rail instability. The corresponding asset diagnostic prompt template 2104 may likewise include a plurality of predefined input slots, each configured to receive voltage-related sensor readings and operational context data extracted from the alert metadata 1513. For instance, the asset diagnostic prompt template 2104 may specify inclusion of sampled voltage-ripple profiles recorded at the affected power rails, switching-pattern logs from the power stage that correlate with ripple events, and firmware-revision tags that indicate whether the instability coincided with a particular firmware update. The asset diagnostic prompt template 2104 may define input slots for sampled voltage-ripple profiles recorded at the affected power rails, switching-pattern logs from the power stage that correlate with the timing of ripple events, and firmware-revision identifiers indicating whether instability coincided with a particular control software update. Additional input slots in the asset diagnostic prompt template 2104 may capture environmental load-step records such as abrupt changes in connected electrical loads or current-demand spikes resulting from temperature variations. The asset diagnostic prompt constructor 1514 may fill these input slots with corresponding sensor values, ensuring that the resulting asset diagnostic prompt 1516 provides the LLM with a semantically organized and contextually complete dataset for analyzing the voltage-rail anomaly.

The asset diagnostic prompt template 2104 corresponding to the respective asset alert type 2002 of the asset alert 1510 may therefore function to enable construction of the asset diagnostic prompt 1516 that incorporates specific categories of alert metadata 1513 that may be most relevant for diagnosing the anomalous condition indicated by the asset alert 1510. By defining, in advance, the technical parameters to be included for a given alert type, the asset diagnostic prompt template 2104 provides structured guidance that directs the asset diagnostic prompt constructor 1514 to supply the LLM with both contextual operating data and diagnostic focus areas. As a result, the asset diagnostic prompt 1516 constructed for each asset alert type 2002 may be type-specific and diagnostically comprehensive, thereby improving the precision, consistency, and technical relevance of the subsequent large-language-model assessment.

In one or more embodiments, the asset diagnostic prompt template 2104 may be distinct for different asset alert types identified using the asset alert type-to-asset diagnostic prompt template repository 2102. Each asset diagnostic prompt template may be custom-defined to reflect the operational characteristics, sensor configurations, and failure modes specific to the corresponding asset alert type. For example, an asset alert type associated with a mechanical subsystem such as a gearbox, pump, or actuator may include input slots for vibration amplitude, torque deviation, or lubrication parameters, whereas an asset alert type associated with an electrical subsystem may include input slots for voltage fluctuation, current imbalance, or switching-cycle irregularities. By maintaining a plurality of specialized asset diagnostic prompt templates, each mapped to a respective asset alert type, the system may ensure that the asset diagnostic prompt 1516 generated for the asset alert 1510 is contextually relevant and populated with only those sensor values and operational records most indicative of the detected anomaly.

In one embodiment, the distinct asset diagnostic prompt template 2104 retrieved from the asset alert type-to-asset diagnostic prompt template repository 2102 that corresponds to the respective asset alert type 2002 of the asset alert 1510 may at least include a set of model instructions and a set of asset diagnostic input data fields.

The set of model instructions may be configured to instruct a large language model to perform a diagnostic assessment of the anomalous state reported in the asset alert 1510. The set of model instructions may be expressed in a machine interpretable format, such as a structured specification in JSON, XML, or another schema-based representation. The set of model instructions may define diagnostic objectives, required inputs, operational constraints, and expected output structures for the LLM. For example, the set of model instructions may specify that the diagnostic objective is to isolate potential root-cause components, to rank contributing factors by probability, and/or to generate recommended remediation actions. The set of model instructions may further prescribe operational constraints, such as requiring adherence to engineering units, enforcing domain-specific terminology, or limiting the model from extrapolating beyond the provided alert metadata 1513. In some implementations, the set of model instructions may define an output schema for the LLM with designated sections for suspected components, probability-weighted causal factors, confidence scores, and recommended remediation steps. By codifying diagnostic objectives, constraints, and output structures, the set of model instructions enable the LLM to generate assessments that are both technically precise and consistent across different alert types.

The set of asset diagnostic input data fields included in the asset diagnostic prompt template 2104 may each be associated with a respective operating characteristic of the industrial asset 1504 monitored by the anomaly detection system. Each asset diagnostic input data field may define the type of asset data required for diagnostic reasoning, as well as rules for extraction, formatting, and validation. Examples of such asset diagnostic input data fields may include vibration amplitude values compared to baseline thresholds, hydraulic pressure measurements correlated with valve actuation states, temperature gradients across thermal circuits, pump cavitation indices, voltage ripple profiles, switching pattern logs, or firmware revision identifiers. The asset diagnostic input data fields may therefore specify the precise sensor readings, baseline values, computed deviation metrics, and/or contextual operating parameters that must be included in the asset diagnostic prompt 1516. In certain implementations, the asset diagnostic input data fields may also define constraints such as timestamp granularity, alignment with operating-mode states, or adherence to domain-specific data schemas, thereby allowing the LLM to receive data in a consistent and diagnostically useful format.

By incorporating both the set of model instructions and the set of asset diagnostic input data fields, the asset diagnostic prompt template 2104 may enable the asset diagnostic prompt constructor 1514 to generate an asset diagnostic prompt 1516 that is not only aligned with the identified asset alert type 2002, but also populated with the most relevant operating characteristics of the industrial asset 1504. As a result, the LLM may receive structured diagnostic guidance as well as the contextualized asset data required for targeted reasoning. This may enable the LLM to produce diagnostic assessments that are reliable, explainable, and actionable for downstream maintenance workflows.

In one or more embodiments, the alert metadata extractor 1512 may further instantiate a metadata selection user interface when the generated asset alert 1510 includes a plurality of distinct pieces of alert metadata that exceed a predetermined metadata count threshold. For example, when the industrial asset 1504 is a part of a simple industrial deployment (e.g., a single-stage fan), the generated asset alert 1510 may contain fewer than ten distinct pieces of alert metadata (e.g., sensor values, sensor identifiers, baseline values, deviation metrics, timestamps, etc.). In such cases, the alert metadata extractor 1512 may extract each alert metadata 1513. In contrast, deployment of the industrial asset 1504 in a more complex environment (e.g., a multi-stage centrifugal pump train), the anomaly detection algorithm 1508 may generate an asset alert 1510 with hundreds or even thousands of alert metadata elements (e.g., sensor readings from multiple vibration probes, bearing temperatures, flow and pressure differentials, anomaly scores per subsystem, etc.). In these scenarios, the total number of alert metadata elements may exceed a predefined metadata count threshold (for example, 12 or 20, depending on configuration and use case). This may cause the alert metadata extractor 1512 to instantiate the metadata selection user interface to allow a user (e.g., operator or analyst) to select a subset of the most relevant alert metadata elements for downstream diagnostic and remediation processes.

In one non-limiting example shown in FIG. 19, a metadata selection user interface 1902 may display each of the distinct pieces of alert metadata 1904 as an individually selectable user interface item (e.g., selectable user interface object or the like). The distinct pieces of alert metadata 1904 may include, without limitation, the sensor identifier corresponding to the sensor that measured a target attribute, the measured value of the target attribute at the time the asset alert 1510 was generated, a baseline or threshold reference value used by the anomaly detection algorithm 1508 for comparison, a computed deviation metric, a timestamp of measurement, a correlated reading of another target attribute, and/or other operating-state parameters of the industrial asset 1504.

As illustrated in FIG. 19, the metadata selection user interface 1902 may display the plurality of distinct pieces of alert metadata 1904 associated with the asset alert 1510 generated for an industrial fan. In the example shown, the distinct pieces of alert metadata 1904 may include readings such as speed, current, torque, active power, reactive power, and factor power, each displayed as a labeled gauge or field. Responsive to the plurality of distinct pieces of alert metadata 1904 exceeding a predetermined metadata count threshold, the metadata selection user interface 1902 may prompt the user to select a subset of the displayed items to focus subsequent diagnostic or remedial processing. As shown, the metadata selection user interface 1902, may detect that a user input(s) indicates a subset 1904 of the plurality of distinct pieces of alert metadata 1906 to be selected. The selection may be highlighted by a visual indicator, for example showing that only two pieces of alert metadata 1906 (the speed and active power readings) out of a total six pieces have been selected, and the remaining four pieces are not selected. The alert metadata extractor 1512 may then extract, from the asset alert 1510, only the subset 1906 of the plurality of distinct pieces of alert metadata 1904, corresponding to the user selected items. This subset 1906 of the plurality of distinct pieces of alert metadata 1904 may thus represent the context considered most relevant for immediate diagnostic or remediation purposes. In one embodiment, as shown in FIG. 19A, the subset 1906 of the plurality of distinct pieces of alert metadata 1904 may be forwarded to the asset diagnostic prompt constructor that may use the subset 1906 to generate the asset diagnostic prompt 1516, instead of using the entirety of the alert metadata 1513.

By supporting selective extraction of alert metadata 1513 through the metadata selection user interface 1902, process 1430 may allow an operator, an automated decision-support module, or a remediation controller to focus on the pieces of contextual information most pertinent to resolving the detected anomaly, without losing access to the plurality of distinct pieces of alert metadata 1904 represented by the asset alert 1510. This capability may reduce information overload and latency in decision-making while preserving traceability to the original, comprehensive alert record.

In one or more embodiments, method 1400 may further include process 1440, which may include a sequence of subprocesses 1440A through 1440D. Process 1440, may function to transform the alert metadata 1513 to the asset diagnostic prompt 1516 in response to extracting the alert metadata 1513 from the asset alert 1510. Process 1440 may at least include characterizing the operating state of the industrial asset 1504 at the time the anomaly detection algorithm 1508 generated the asset alert 1510, e.g., into a diagnostic inquiry suitable for automated reasoning by the LLM in combination with one or more external or internal asset maintenance data collections. By leveraging the extracted alert metadata 1513 as structured input, process 1440 may enable the anomaly detection system to automatically construct an asset diagnostic prompt 1516. The constructed asset diagnostic prompt 1516 may be used to query one or more heterogeneous asset maintenance data collections for information relevant to diagnosing the detected anomaly. The anomaly detection system may then process the retrieved information to generate an asset diagnostic inference to identify one or more components of the industrial asset 1504 contributing to the anomalous state. The asset diagnostic inference may further output one or more asset maintenance tasks recommended for remediation of the anomalous state of the industrial asset 1504.

Constructing an Asset Diagnostic Prompt that Includes the Alert Metadata and a Set of Model Instructions Instructing a Large Language Model to Perform a Diagnostic Assessment of the Anomalous State

In one embodiment, process 1440 may include subprocess 1440A. Subprocess 1440A, which may include constructing an asset diagnostic prompt that includes the alert metadata 1513 and a set of model instructions instructing a large language model to perform a diagnostic assessment of the anomalous state, may function to automatically generate the asset diagnostic prompt 1516 suitable for ingestion by the LLM. The asset diagnostic prompt constructor 1514 may implement more than one construction process, e.g., depending on how diagnostic configuration data is stored and retrieved within the anomaly detection system.

As described with respect to process 1440A, the asset diagnostic prompt constructor 1514 may automatically construct the asset diagnostic prompt 1516 formatted for direct processing by the LLM. Automatic construction may entail combining the alert metadata 1513, which characterizes the operating state of the industrial asset 1504 at the time of the anomaly, with the set of model instructions that instruct the LLM to perform a diagnostic assessment of the anomalous state indicated in the asset alert 1510. The set of model instructions may specify the diagnostic objectives to be achieved by the LLM, the alert metadata 1513 to be analyzed, the operational constraints to be observed, and the structure of the expected diagnostic output. By embedding both the contextual operating data and the structured guidance into a single machine-readable object, the system may ensure that the asset diagnostic prompt 1516 is technically complete, aligned with the anomalous condition, and suitable for generating an accurate and explainable diagnostic inference by the LLM.

In a first embodiment, as shown in FIG. 20, the alert metadata extractor 1512 may query an asset alert type-to-asset diagnostic prompt data table 2004 using the respective asset alert type 2002 of the asset alert 1510 as a query parameter. The asset alert type-to-asset diagnostic prompt data table 2004 may associate each predefined asset alert type 2002 with the distinct set of prompt construction instructions 2006. The distinct set of prompt construction instructions 2006 may include two components: (i) the set of model instructions that specify, in a machine-interpretable format, the diagnostic objectives, operational constraints, and output schemas that guide the LLM; and (ii) the set of metadata extraction directives identifying which items of alert metadata 1513 are to be incorporated into the asset diagnostic prompt 1516. The asset diagnostic prompt constructor 1514 may execute the distinct set of prompt construction instructions 2006 by retrieving the referenced metadata elements from the structured record produced by the alert metadata extractor 1512, formatting these values according to schema directives, and embedding them alongside the set of model instructions in the asset diagnostic prompt 1516.

For example, when the asset alert type 2002 corresponds to excessive gearbox vibration, the distinct set of prompt construction instructions 2006 may specify that the asset diagnostic prompt 1516 must include vibration amplitude sensor readings, baseline vibration thresholds, and rotor speed sensor values. The associated set of model instructions may direct the LLM to correlate amplitude trends with threshold values and infer whether bearing wear or rotor imbalance is a likely root cause for the anomalous state of the industrial asset 1504. In another example, for an asset alert type 2002 corresponding to hydraulic pressure fluctuation, the distinct set of prompt construction instructions 2006 may direct the asset diagnostic prompt constructor 1514 to insert instantaneous and baseline pressure values, fluctuation ranges, and valve actuation states into the asset diagnostic prompt 1516. Further, the set of model instructions may instruct the LLM to assess whether cavitation or actuator malfunction is the most probable cause for the anomalous state of the industrial asset 1504.

In a second embodiment, the alert metadata extractor 1512 may instead query an asset alert type-to-asset diagnostic prompt template repository 2102 using the determined asset alert type 2002 as the key. The asset alert type-to-asset diagnostic prompt template repository 2102 may store an association of each asset alert type 2002 with the corresponding asset diagnostic prompt template 2104. The asset diagnostic prompt template 2104 may define both the set of model instructions and the set of asset diagnostic input data fields. Each asset diagnostic input data field may be associated with a specific operating characteristic of the industrial asset 1504, such as coolant flow rates, valve duty cycles, temperature gradients, voltage ripple profiles, or firmware revision tags. The asset diagnostic prompt constructor 1514 may automatically construct the asset diagnostic prompt 1516 by populating each asset diagnostic input data field in the asset diagnostic prompt template 2104 with corresponding values obtained from the alert metadata 1513, and embedding the set of model instructions to provide diagnostic reasoning directives to the LLM.

For instance, when the asset alert type 2002 corresponds to abnormal coolant-flow oscillation, the asset diagnostic prompt template 2104 may require inclusion of instantaneous and baseline flow-rate values, valve actuation histories, pump cavitation indices, and thermal gradient measurements into the asset diagnostic prompt 1516. The asset diagnostic prompt constructor 1514 may insert the extracted values into the specified asset diagnostic input data fields and embed the set of model instructions that guide the LLM to assess whether the oscillation arises from cavitation, thermal imbalance, or flow-loop resonance. In another non-limiting example, when the asset alert type 2002 corresponds to transient voltage-rail instability, the asset diagnostic prompt template 2104 may define the asset diagnostic input data fields for sampled voltage ripple profiles, switching pattern logs, firmware revision identifiers, and environmental load-step events. The asset diagnostic prompt constructor 1514 may populate the asset diagnostic input data fields with the extracted telemetry and include the set of model instructions that direct the LLM to correlate ripple behavior with switching anomalies or firmware-induced instability. In both embodiments, the asset diagnostic prompt constructor 1514 may perform schema validation, apply versioning metadata, and generate the asset diagnostic prompt 1516 as a structured digital record such as a JSON object or parameterized text block.

In some implementations, the two approaches described above for automatic construction of the asset diagnostic prompt may also be combined. Stated another way, the asset diagnostic prompt constructor 1514 may retrieve a distinct set of prompt construction instructions 2006 from the asset alert type-to-asset diagnostic prompt data table 2004 and apply those instructions to govern how an asset diagnostic prompt template 2104, retrieved from the asset alert type-to-asset diagnostic prompt template repository 2102, may be populated with the alert metadata 1513. In this combined configuration, the distinct set of prompt construction instructions 2006 may provide control parameters, such as field-ordering rules, formatting constraints, or additional metadata selection directives, while the asset diagnostic prompt template 2104 may provide the structural schema and the asset diagnostic input data fields. By merging the two approaches, the asset diagnostic prompt constructor 1514 may generate an asset diagnostic prompt 1516 that benefits from both the fine-grained instruction set and the reusable schema template, thereby ensuring flexibility, extensibility, and technical consistency across different asset alert types.

### Querying One or More Asset Maintenance Data Collections Based on an Embedding Value of the Asset Diagnostic Prompt

In one or more embodiments, process 1440 may include subprocess 1440B. Subprocess 1440B, which may include querying one or more asset maintenance data collections 1518 based on an embedding value of the asset diagnostic prompt 1516, may function to automatically retrieve data corresponding to maintenance and anomaly mitigation data most relevant to the anomalous state reported in the asset alert 1510. In an embodiment, once the asset diagnostic prompt 1516 has been constructed using the alert metadata 1513 and the set of model instructions tailored to the anomalous state of the industrial asset 1504, the anomaly detection system may transform the constructed asset diagnostic prompt 1516 into a representation that may be suitable for use as a database query. This transformation may enable the anomaly diagnostic system to project both the structured data fields and the diagnostic objectives of the asset diagnostic prompt 1516 into an embedding space where semantic similarity can be measured.

The term “embedding value” may refer to a numerical vector representation generated by transforming the asset diagnostic prompt 1516 into a continuous high-dimensional vector space. The embedding value may encode both the contextual semantics of the alert metadata 1513 and the diagnostic intent expressed by the set of model instructions contained in the asset diagnostic prompt 1516. Each embedding value may preserve latent relationships among data items such that asset alerts or asset diagnostic prompts describing similar anomalous behaviors, operating conditions, or component failures are positioned proximally within the embedding space.

In an embodiment, the embedding value may be computed using one or more machine learning models, such as transformer-based encoders or neural embedding networks trained on domain-specific maintenance and sensor datasets. In some examples, the embedding value may correspond to a fixed-dimensional vector, such as a 1536-dimensional representation, where each dimension captures a learned feature describing a particular aspect of the operational state or maintenance context of the industrial asset 1504. The resulting embedding value may be used as a query key for performing similarity searches across one or more data collections, allowing retrieval of contextual data that is semantically aligned with the content of the asset diagnostic prompt 1516.

The resulting embedding value may then serve as a key for accessing heterogeneous asset maintenance data collections, including, but not limiting to, technical manuals, historical service records, and/or community-derived operational insights. By retrieving supporting maintenance and anomaly mitigation data from these asset maintenance data collections, the anomaly diagnostic system may enable enrichment of the diagnostic context established by the asset diagnostic prompt 1516, e.g., with knowledge that may reflect prior maintenance practices, domain-specific procedures, and/or field-level troubleshooting experience. In this way, the anomaly detection system may ensure that the diagnostic inference by the LLM may not be limited to the conditions observed at the time of the asset alert 1510, but may instead be grounded in a broader body of accumulated maintenance knowledge that improves accuracy, explainability, and actionability. In one implementation, the embedding value may then be applied as a query input to a set of distinct asset maintenance data collections, each containing different forms of diagnostic and maintenance knowledge.

In one non-limiting example shown in FIG. 15, the embedding value of the asset diagnostic prompt 1516 may be used to query the asset maintenance data collections 1518, e.g., to extract a set of maintenance data items 1520 related to the asset diagnostic prompt 1516. In some embodiments, the asset maintenance data collections 1518 may include at least three distinct types of maintenance data sources. A first type may include a maintenance manual data collection. In some embodiments, a maintenance manual data collection may include structured or semi-structured repositories that store digitized versions of unstructured maintenance manuals, service bulletins, operating guides, and troubleshooting documents associated with one or more industrial assets. The maintenance manual data collection may include both tokenized textual representations of the maintenance manuals content and corresponding embedding representations generated through a vectorization process that encodes the semantic meaning of the maintenance manuals text into high-dimensional numerical embedding vectors.

A second type may include a maintenance record data collection at least in part storing previously recorded or performed maintenance events for the industrial asset 1504. In some embodiments, a maintenance record data collection may include one or more repositories configured to store historical maintenance-related information derived from real-world servicing, inspection, or repair events performed on one or more industrial assets. The maintenance record data collection may include both structured and unstructured data, such as textual maintenance logs, technician notes, service tickets, replacement part records, diagnostic test outcomes, and timestamps associated with completed maintenance actions. The recorded maintenance events may be similarly stored in tokenized and embedding-based form.

A third type may include a crowd-sourced data collection. In some embodiments, a crowd-sourced data collection may include one or more repositories that aggregate and store unstructured content originating from publicly or privately accessible web-based discussion platforms, user forums, community-maintenance portals, and/or operator knowledge exchanges related to diagnosing, troubleshooting, or repairing industrial assets. The crowd-sourced data collection may include textual content such as forum posts, question-answer threads, technician discussions, field observations, and shared troubleshooting narratives describing real-world maintenance experiences that may not be documented in official manufacturer manuals or enterprise maintenance records. This textual content may also be stored in tokenized and embedding-based form. Each of these asset maintenance data collections 1518 may be individually searched by comparing its respective stored vector embeddings to the query embedding generated from the asset diagnostic prompt 1516.

In some embodiments, the embedding value of the asset diagnostic prompt 1516 may function as a semantic query vector that may be used to search across multiple asset maintenance data collections 1518 maintained within or accessible to the anomaly detection system. Each asset maintenance data collection may include a plurality of precomputed embedding representations corresponding to maintenance documents, repair logs, operating manuals, or crowd-sourced troubleshooting discussions. During a retrieval operation, the embedding value of the asset diagnostic prompt 1516 may be compared against the stored embedding representations using one or more similarity metrics, such as cosine similarity or Euclidean distance, to identify data items whose embeddings lie within a defined similarity threshold from the embedding value of the asset diagnostic prompt 1516.

In one implementation, each asset maintenance data collection may be queried independently using the same embedding value, allowing for parallel retrieval from diverse data sources that differ in structure, origin, and content granularity. For instance, the embedding-based query may retrieve one or more data items from the maintenance manual data collection when a similarity score between the embedding value of the asset diagnostic prompt 1516 and the embedding representations of one or more data items stored in the maintenance manual data collection exceeds a defined similarity threshold. The similarity score may be computed using a mathematical comparison function, such as a cosine similarity, dot product, or normalized Euclidean distance between the corresponding embedding vectors. When the resulting score satisfies or exceeds a predefined similarity threshold, the associated set of maintenance manual data items may be deemed semantically relevant to the diagnostic context represented by the asset diagnostic prompt 1516, and the corresponding set of maintenance manual data items may be retrieved.

In another implementation, if the computed similarity score between the embedding value and all embedding representations stored in a given asset maintenance data collection falls below the similarity threshold, it may be determined that no semantically relevant item exists within that asset maintenance data collection. For example, a maintenance record data collection may not return any data items when no previously logged maintenance event exhibits an embedding distance below the threshold value, indicating that the current anomalous state of the industrial asset 1504 may not have been observed in past maintenance operations. Conversely, a crowd-sourced data collection may yield a set of crowd-sourced data items whose embedding representations fall within the similarity threshold of the embedding value of the asset diagnostic prompt 1516, e.g., representing field-reported cases of comparable anomalies that may have occurred under similar operational conditions.

In this manner, the embedding value may serve as a unifying retrieval key that enables consistent, vector-based querying across all collections. The absence of matching data items within the similarity threshold in any given asset maintenance data collection may also carry diagnostic significance, indicating that the observed anomalous state or associated metadata represents a novel or previously undocumented operational state. Such selective retrieval may enable only those data items most semantically aligned with the asset diagnostic prompt to be extracted for subsequent reasoning by the LLM.

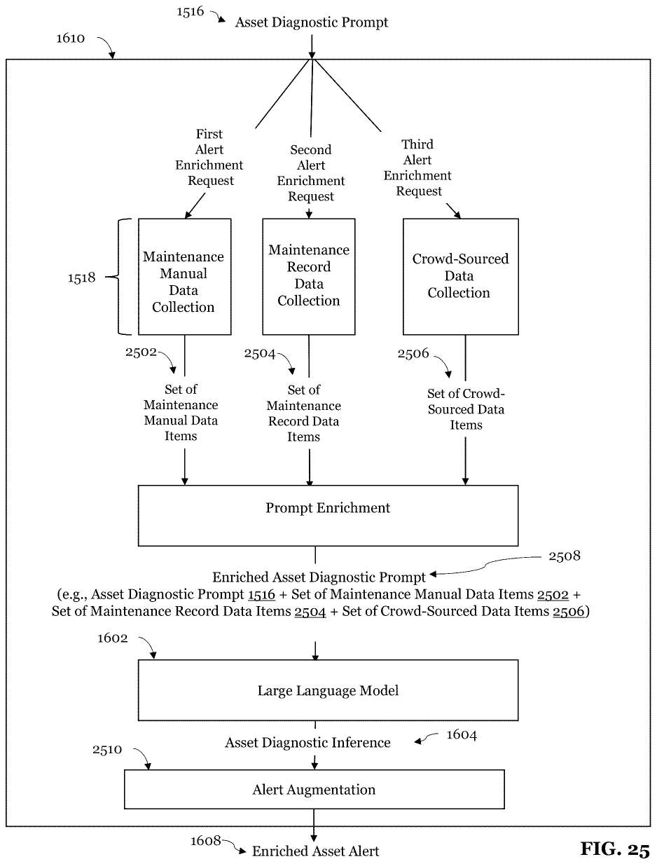

As illustrated in FIG. 25, the asset diagnostic prompt 1516 may be used by the alert enrichment service 1610 to query the asset maintenance data collections 1518. As shown, the asset diagnostic prompt 1516 may be received by the alert enrichment service 1610. In an implementation, the alert enrichment service 1610 may expose a programmatic interface that enables other components of the anomaly diagnostic system, e.g., the asset diagnostic prompt constructor 1514, to send prompt payloads of the asset diagnostic prompt 1516 containing embedded alert metadata 1513 and the diagnostic input data fields in a machine-readable format.

Upon receiving the asset diagnostic prompt 1516, the alert enrichment service 1610 may encode both the contextual semantics of the alert metadata 1513 and the diagnostic intent expressed by the set of model instructions contained in the asset diagnostic prompt 1516 into a dense embedding representation using a vectorization engine stored in local or distributed memory. This embedding representation may encode the anomaly context but also the diagnostic objectives and required data characteristics from the asset diagnostic prompt 1516, thereby enabling semantic alignment with external asset maintenance data collections 1518. A query orchestration module within the alert enrichment service 1610 may then initiate parallel alert enrichment requests to each of the asset maintenance data collections 1518 containing domain-specific maintenance data organized for semantic search.

In one implementation, the alert enrichment service 1610 may transmit a first alert enrichment request based on the embedding representation of the asset diagnostic prompt 1516 to a first distinct API endpoint associated with a maintenance manual data collection. The same embedding value may also be transmitted as part of a second alert enrichment request to a second distinct API endpoint associated with a maintenance record data collection, and a third alert enrichment request to a third distinct API endpoint associated with a crowd-sourced data collection. These enrichment alert requests may each be implemented as API payloads that include the embedding representation of the asset diagnostic prompt 1516, formatted according to a defined schema accepted by a backend associated with each asset maintenance data collection.

In one embodiment, each of the asset maintenance data collections 1518 may maintain an internal embedding index derived from the source documents (e.g., source data) and/or structured records contained therein. Upon receiving an alert enrichment request, each asset maintenance data collection may execute an approximate nearest-neighbor search within an embedding space to identify data records that may be most semantically aligned with the received embedding representation. For example, the maintenance manual data collection may return official OEM procedures that are within a predetermined threshold distance of the embedding value corresponding to the asset diagnostic prompt 1516. Similarly, the maintenance record data collection may return historical logs of similar faults, corresponding resolutions previously observed for the industrial asset 1504, and/or previously performed maintenance tasks performed on the industrial asset 1504. Further, the crowd-sourced data collection may return data items having embedding representations that are within a predetermined threshold distance of the embedding value corresponding to the asset diagnostic prompt 1516. These data items may include, without limitation, community-reported practices, heuristics, and/or undocumented troubleshooting techniques shared by field engineers associated with industrial assets similar to the industrial asset 1504.

In some embodiments, the crowd-sourced data collection may be screened to avoid duplication with OEM maintenance manuals contained in the maintenance manual data collection. This screening process may ensure that only unique, field-specific information may be incorporated from the crowd-sourced data collection. The screened content may include, without limitation, practical guidance derived from field conditions not captured in OEM manuals, such as recurring failure modes in particular operating environments (e.g., high-humidity coastal installations), localized adaptations of diagnostic thresholds due to environmental stressors, and/or procedural workarounds reported by field technicians during unexpected operating scenarios.

In an example, the alert enrichment service 1610 may send a first alert enrichment request to an API endpoint of a maintenance manual data collection containing OEM documentation for turbine assemblies. The first alert enrichment request may be sent to retrieve data that describes blade tip clearance diagnostic sequences matching the fault encoded in the asset diagnostic prompt 1516. In another example, the alert enrichment service 1610 may send a second alert enrichment request to a distinct API endpoint of a maintenance record data collection. The second alert enrichment request may be sent to retrieve service ticket logs that record historical corrective actions applied to similar turbine assemblies for the same type of abnormal vibration condition represented in the asset diagnostic prompt 1516. In yet another example, the alert enrichment service 1610 may send a third alert enrichment request to a distinct API endpoint of a crowd-sourced data collection. The third alert enrichment request may be sent to retrieve field engineer reports or community-shared troubleshooting practices describing early-onset symptoms of the vibration condition that may not be documented in the OEM manuals.

By leveraging embedding-based querying across multiple complementary asset maintenance data collections 1518, subprocess 1440B may enable the anomaly detection system to compile a diverse and contextually aligned evidence set. This evidence set, when appended to or linked with the asset diagnostic prompt 1516, may then be provided to the LLM for a technically precise and contextually rich diagnostic inference.

In alternative embodiments, the asset maintenance data collections 1518 may include additional or different data collections from the data collections described above. The additional or alternative data collections may be incorporated depending on the industrial environment, data architecture, or enterprise configuration of the anomaly detection system. Such additional data collections may include, for example, an OEM diagnostic bulletin repository that aggregates manufacturer-issued maintenance advisories, a sensor telemetry archive that stores long-term operational time-series data, an engineering change database containing hardware or firmware update records, a simulation dataset repository comprising modeled performance degradations under controlled conditions, or a knowledge-graph-based asset ontology store that captures interrelationships between component hierarchies, fault signatures, and corresponding remediation actions.

Retrieving, from the One or More Asset Maintenance Data Collections, a Set of Asset Maintenance Data Items Related to the Asset Diagnostic Prompt in Response to the Querying of the One or More Asset Maintenance Data Collections

In one or more embodiments, process 1440 may include subprocess 1440C. Subprocess 1440C, which may include retrieving, from the one or more asset maintenance data collections 1518, a set of asset maintenance data items 1520 related to the asset diagnostic prompt 1516 in response to the querying of the one or more asset maintenance data collections 1518, may function to enable the anomaly detection system to retrieve asset maintenance data items from external heterogeneous data sources semantically aligned with the anomalous condition specified in the asset diagnostic prompt 1516. Subprocess 1440C may allow the anomaly detection system to enrich the diagnostic context established by the asset diagnostic prompt 1516 with relevant maintenance and operational insights accumulated from these external heterogeneous data sources.

In an embodiment, as shown in FIG. 15, responsive to the issuance of alert enrichment requests to the distinct API endpoints of the asset maintenance data collections 1518, a set of asset maintenance data items 1520 related to the asset diagnostic prompt 1516 may be retrieved. Further, as shown in FIG. 25, alert enrichment requests may be sent to the distinct API endpoints of maintenance manual data collection, maintenance record data collection, and crowd-sourced data collection by the alert enrichment service 1610. For instance, only a subset of data items whose embedding representations fall within a predefined similarity threshold relative to the embedding value of the asset diagnostic prompt 1516 may be retrieved as the set of maintenance manual data items 2502 from the maintenance manual data collection. Similarly, the set of maintenance record data items 2504 extracted from the maintenance record data collection may include only those historical maintenance entries determined to exhibit semantic proximity to the embedding value of the asset diagnostic prompt 1516, representing previously recorded conditions or maintenance actions relevant to the detected anomalous state. Further, the set of crowd-sourced data items 2506 extracted from the crowd-sourced data collection, may comprise a filtered subset of discussion threads or field observations that satisfy the similarity threshold, ensuring that only semantically aligned insights are obtained while excluding unrelated or redundant content. The set of maintenance manual data items 2502, the set of maintenance record data items 2504, and the set of crowd-sourced data items 2506 may together form the set of asset maintenance data items 1520.

In the context of the present application, the set of maintenance manual data items 2502 may refer to a subset of content retrieved from a maintenance manual data collection that corresponds to documentation authored or approved by the original equipment manufacturer (OEM), such as procedural instructions, calibration specifications, component tolerances, and operational thresholds relevant to diagnosing or mitigating the anomalous state of the industrial asset 1504. Further, the set of maintenance record data items 2504 may refer to the subset of entries retrieved from a maintenance record data collection that corresponds to historical maintenance logs, service tickets, and prior intervention reports associated with the industrial asset 1504, including temporal information describing when and how corrective actions were previously implemented and their respective outcomes. The set of crowd-sourced data items 2506 may refer to the subset of user-contributed or field-reported content retrieved from a crowd-sourced data collection that corresponds to publicly shared observations, troubleshooting experiences, or corrective techniques gathered from practitioner forums, discussion platforms, and/or community-maintained repositories, providing real-world insights not necessarily captured in formal manuals or structured maintenance databases.

The retrieved asset maintenance data items 1520 may supplement the original alert metadata 1513 by contributing prescriptive instructions, empirical field evidence, and/or historical operational experience that together enrich the diagnostic context of the asset diagnostic prompt 1516. By bridging the automatically constructed asset diagnostic prompt 1516 with external domain knowledge stored in the asset maintenance data collections 1518, subprocess 1440C may enable the subsequent diagnostic inference drawing upon a comprehensive foundation that reflects not only the conditions captured at the time of the anomaly but also the accumulated technical understanding of similar faults across diverse operational environments.

In some embodiments, the retrieval of the set of asset maintenance data items 1520 may be structured to correspond to the source of each alert enrichment request issued by the alert enrichment service 1610. For instance, in response to transmitting the first alert enrichment request to the first distinct API endpoint associated with the maintenance manual data collection, the set of maintenance manual data items 2502 related to the anomalous state described by the asset diagnostic prompt 1516 may be retrieved. In an example, the set of maintenance manual data items 2502 may include, without limitation, OEM-approved inspection and adjustment procedures, diagnostic flowcharts, and reference parameter thresholds pertinent to the industrial asset 1504. In one instance, when the industrial asset 1504 includes an industrial fan, the retrieved set of maintenance manual data items 2502 may include official rotor balancing procedures, bearing alignment tolerances, and/or prescribed vibration monitoring protocols published by the OEM for the relevant class of turbine.

Further, in response to transmitting the second alert enrichment request to the second distinct API endpoint associated with the maintenance record data collection, the set of maintenance record data items 2504 related to the anomalous state described by the asset diagnostic prompt 1516 may be retrieved. The set of maintenance record data items 2504 may include, without limitation, service ticket logs associated with the industrial asset 1504, intervention notes, component replacement histories associated with the industrial asset 1504, and/or recorded operating parameter trends associated with prior occurrences of the same anomalous state. In one instance, when the industrial asset 1504 includes a centrifugal pump, the retrieved set of maintenance record data items 2504 may include historical service logs for the centrifugal pump, e.g., documenting impeller inspections, seal replacements, and/or control-valve adjustments correlated with similar oscillation events, together with the recorded changes in vibration levels and flow rate following each intervention.

Furthermore, in response to transmitting the third alert enrichment request to the third distinct API endpoint associated with the crowd-sourced data collection, the set of crowd-sourced data items 2506 related to the anomalous state described by the asset diagnostic prompt 1516 may be retrieved. The set of crowd-sourced data items 2506 may include, without limitation, field engineer reports, discussion forum excerpts, and incident summaries describing observed symptoms, remedial practices, and/or contextual operating factors not fully addressed in OEM manuals created for the industrial asset 1504 or recorded maintenance histories. In one instance, when the industrial asset 1504 includes a transformer undergoing intermittent power-factor drift, the retrieved set of crowd-sourced data items 2506 may include technician-shared observations on auxiliary fan sequencing or coolant-flow distribution practices that helped mitigate the power-factor drift, e.g., under high humidity seasonal conditions.

The set of asset maintenance data items 1520 related to the asset diagnostic prompt 1516 may thus include the combined retrievals from the set of maintenance manual data items 2502, the set of maintenance record data items 2504, and the set of crowd-sourced data items 2506 together forming the set of asset maintenance data items 1520. The inclusion of set of asset maintenance data items 1520 from each of the asset maintenance data collections 1518 may enable enrichment of the asset diagnostic prompt 1516 such that diagnostic and maintenance instructions executed in subsequent processes may not be limited to unidimensional data from the asset alert 1510, but instead benefit from composite data spanning prescriptive OEM guidance, historical operational evidence, and/or adaptive field-level knowledge. By aggregating the set of maintenance manual data items 2502, set of maintenance record data items 2504, and the set of crowd-sourced data items 2506 into a unified evidence set, the anomaly detection system may provide the LLM with a more comprehensive and enriched asset diagnostic prompt to generate accurate and operationally relevant diagnostic inferences.

Generating, Based on Providing the Asset Diagnostic Prompt and the Set of Asset Maintenance Data Items to the Large Language Model, an Asset Diagnostic Inference that Includes (I) One or More Components of the Industrial Asset Contributing to the Anomalous State and (II) One or More Recommended Asset Maintenance Tasks for Mitigating the Anomalous State

In one or more embodiments, once the set of asset maintenance data items 1520 has been retrieved from the asset maintenance data collections 1518, the anomaly detection system may enter a diagnostic reasoning stage that may leverage the LLM to generate a structured and actionable inference to remediate the anomalous state of the industrial asset 1504. The diagnostic reasoning stage may transform the combined evidence from the asset diagnostic prompt 1516 and the retrieved set of asset maintenance data items 1520 into a human-readable as well as machine-readable diagnostic output that identifies the technical sources of the anomalous state and may further prescribe specific maintenance actions to address them.

Subprocess 1440D, which may include generating, based on providing the asset diagnostic prompt 1516 and the set of asset maintenance data items 1520 to a large language model, an asset diagnostic inference that includes (i) one or more components of the industrial asset 1504 contributing to the anomalous state and (ii) one or more recommended asset maintenance tasks for mitigating the anomalous state, may function to produce a technically grounded and operationally actionable diagnostic output. Such a diagnostic output may be consumed by maintenance planning systems or by automated remediation controllers to address the identified anomalous state of the industrial asset 1504 in a targeted manner.

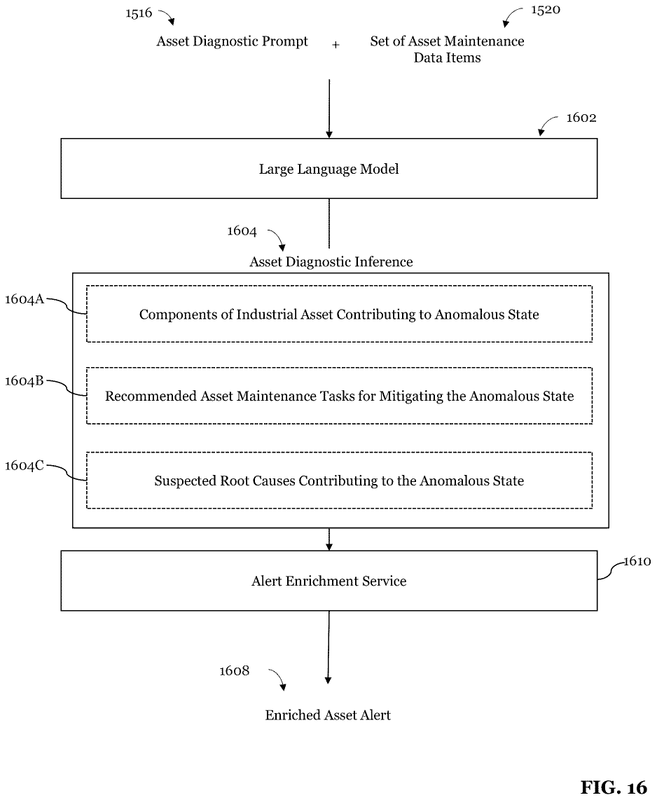

As shown in one non-limiting example of FIG. 16, the asset diagnostic prompt 1516 may be combined with the retrieved set of asset maintenance data items 1520 and provided as input to the LLM 1602. The LLM 1602 may process this combined input to generate an asset diagnostic inference 1604. The asset diagnostic inference 1604 may include at least three logically distinct but interrelated components: the components of the industrial asset contributing to the anomalous state 1604A, the recommended asset maintenance tasks for mitigating the anomalous state 1604B, and in some embodiments, suspected root causes contributing to the anomalous state 1604C. Further, as shown in FIG. 25, the combination of the asset diagnostic prompt 1516 with the set of asset maintenance data items 1520 may be used as an enriched asset diagnostic prompt 2508. For instance, in response to the anomaly detection system invoking the asset enrichment service 1610, the enriched asset diagnostic prompt 2508 may be generated, e.g., at least including the asset diagnostic prompt 1516, the set of maintenance manual data items 2502, the set of maintenance record data items 2504, and set of crowd-sourced data items 2506. The LLM 1602 may receive the enriched asset diagnostic prompt 2508 as input, and output the asset diagnostic inference 1604.

In an embodiment, the LLM 1602 may be hosted on a cloud-based inference engine or deployed in an on-premise industrial computing cluster. The LLM 1602 may be configured to process heterogeneous input data from the asset diagnostic prompt 1516, such as structured sensor readings, tabular maintenance records, and unstructured text-based procedural or experiential knowledge. Some non-limiting examples of the LLM 1602 suitable for generating the asset diagnostic inference 1604 may include transformer-based architectures such as an instruction-tuned variant of Generative Pre-trained Transformer (GPT), Large Language Model Meta AI (LLAMA™), Falcon, or any other pretrained LLM adapted to perform domain-specific reasoning over maintenance and diagnostic tasks.

In some implementations, the LLM 1602 may operate as part of a RAG service within a predictive maintenance pipeline. In this configuration, both the asset diagnostic prompt 1516 and the retrieved set of asset maintenance data items 1520 (e.g., as enriched asset diagnostic prompt 2508) may be provided to the LLM component of the RAG service at inference time. In one embodiment, the RAG service may include a context-assembly module configured to select the most relevant subset of the retrieved set of asset maintenance data items 1520, e.g., determined according to similarity scores, timestamps, and/or the diagnostic objectives defined by the set of model instructions of the asset diagnostic prompt 1516. The context-assembly module may format the selected subset as a structured, machine-readable context input, e.g., a serialized JSON block or tokenized text section, and provide the context input to the LLM 1602. This structured context input may be processed by an attention mechanism of the LLM 1602, together with the asset diagnostic prompt 1516, enabling the LLM 1602 to predict both the one or more components of the industrial asset 1504 contributing to the anomalous state (1604A) and one or more recommended asset maintenance tasks (1604B) for mitigating the anomalous state based on operational state captured in the alert metadata 1513 and the suspected root causes contributing to the anomalous state (1604C).

In another implementation, the RAG service may employ a hybrid model architecture in which the LLM 1602 may be integrated with a retrieval layer and context prioritization logic. The retrieval layer may be configured to extract and transmit the most diagnostically significant maintenance procedures, historical intervention logs, and/or field-level observations retrieved from the set of asset maintenance data items 1520 to the LLM. Further, the context prioritization logic may be configured to deprioritize generic or less relevant records. For example, when the asset alert 1510 reports “oscillating coolant-flow rates in a multi-stage centrifugal chiller”, the context prioritization logic may only prioritize OEM valve-calibration procedures and historical records of bypass-valve malfunctions from the set of asset maintenance data items 1520, while excluding unrelated service guidelines. The LLM 1602, operating with this curated context, may therefore be enabled to focus reasoning on diagnosing the oscillation by linking the anomalous state of the industrial asset 1504 with proven maintenance remedies.

In other implementations, the LLM 1602 may be fine-tuned on historical industrial diagnostic data, such as labeled incident reports and maintenance logs, and may use chain-of-thought prompting defined by the set of model instructions to trace logical connections between sensor deviations, historical corrective actions, and expected outcomes. The LLM 1602 may output the asset diagnostic inference 1604 in a structured representation, such as JSON or XML, as defined by the schema in the set of model instructions, allowing other components of the anomaly diagnostic system to programmatically parse the results. Optionally, the asset diagnostic inference 1604 may further include references to the alert metadata 1513.

For example, in one instance, the industrial asset 1504 may include a power distribution transformer equipped with a set of sensors 1502 including voltage transducers, current transformers, and temperature probes. During routine operation, the set of sensors 1502 may generate raw event data 1506 that includes time-stamped voltage waveform samples, power-factor readings, and ambient temperature measurements. The anomaly detection algorithm 1508 may analyze the raw event data 1506 and determine that the power distribution transformer exhibits an anomalous pattern characterized by persistent voltage ripple and gradual power-factor drift outside the expected baseline range. In response, the anomaly detection algorithm 1508 may generate an asset alert 1510 that records the respective asset alert type, the sensor identifiers, a measured value of the power-factor reading at the time asset alert 1510 was generated, the computed deviation metric, and a timestamp.

The alert metadata extractor 1512 may parse the asset alert 1510 and extract alert metadata 1513 that characterizes the operating state of the transformer at the time of the anomaly. In this example, the alert metadata 1513 may include the measured value of the power factor at the time the asset alert 1510 is generated, the baseline power-factor reference, the magnitude and frequency of the voltage ripple, the sensor identifiers of the voltage and current transducers, correlated load-current readings, and deviation metrics indicating the degree of departure from normal operation.

The asset diagnostic prompt constructor 1514 may then incorporate the extracted alert metadata 1513 together with a relevant diagnostic template retrieved from an asset alert type-to-asset diagnostic prompt template repository 2102, generating an asset diagnostic prompt 1516. The asset diagnostic prompt 1516 may be formatted in a machine-interpretable schema and may combine the extracted alert metadata 1513 with the set of model instructions that direct the LLM 1602 to identify root-cause components related to voltage regulation and power-factor control. The prompt may, for example, specify that the LLM should evaluate the condition of the transformer tap-changer assembly, review evidence of capacitor-bank imbalance, and consider load-driven stress factors in its diagnostic reasoning.

The generated asset diagnostic prompt 1516 may then be transmitted to an alert enrichment service 1610, which may derive an embedding representation of the asset diagnostic prompt 1516 and use the embedding representation to query one or more asset maintenance data collections 1518. In one example, when the industrial asset 1504 includes a transformer, the alert enrichment service 1610 may issue a first alert enrichment request to a first API endpoint associated with a maintenance manual data collection to retrieve the set of maintenance manual data items 2502 (e.g., describing OEM-approved maintenance procedures such as core-tightening, bushing-inspection, dielectric-oil testing, or temperature-sensor calibration for the transformer and/or transformers of a similar type). The alert enrichment service 1610 may also transmit a second alert enrichment request to a second API endpoint of a maintenance record data collection to retrieve the set of maintenance record data items 2504 (e.g., documenting historical winding-resistance checks, oil filtration cycles, or cooling fan replacements performed on the transformer). Further, a third alert enrichment request may be sent to a third API endpoint of a crowd-sourced data collection to retrieve the set of crowd-sourced data items 2506 (e.g., identifying field-reported transformer anomalies for transformers of a similar type, such as contact oxidation under humid operating environments, elevated vibration near the core clamp assembly, or repetitive load-induced thermal cycling affecting insulation durability). The alert enrichment service 1602 may then initiate a prompt enrichment service to generate the enriched asset diagnostic prompt 2508, e.g., comprising the asset diagnostic prompt 1516, the set of maintenance manual data items 2502, the set of maintenance record data items 2504, and the set of crowd-sourced data items 2506.

The enriched asset diagnostic prompt 2508 may be provided as input to the LLM 1602 implemented within a retrieval-augmented generation service of the predictive-maintenance pipeline. The LLM 1602, operating over the enriched asset diagnostic prompt 2508, may analyze the contextualized data and predict that the components of the industrial asset 1504 contributing to the anomalous state (FIG. 16, 1604A) may include degraded tap-changer contacts and an imbalanced capacitor bank. The LLM 1602 may further predict recommended asset-maintenance tasks for mitigating the anomalous state (FIG. 16, 1604B), which may include refurbishment or replacement of the tap-changer contacts, rebalancing of the capacitor bank, and adjustment of humidity-control measures to restore stable power-factor performance. In some implementations, the LLM 1602 may additionally attribute the anomalous state to suspected root causes contributing to the anomalous state (FIG. 16, 1604C), such as prolonged operation of the transformer under variable load in a high-humidity environment that accelerated the degradation of the tap-changer contacts.

In another example, the industrial asset 1504 may include a multi-stage centrifugal chiller. The anomaly detection algorithm 1508 may generate the asset alert 1510 corresponding to the industrial asset 1504 indicating “persistent coolant-flow oscillations beyond normal control thresholds.” In this instance, the LLM 1602 may use the contextual information from the enriched asset diagnostic prompt 2508 which may include the asset diagnostic prompt 1516 together with retrieved maintenance manual data items 2502 describing valve-tuning procedures, historical maintenance record data items 2504 documenting prior replacements of degraded control-valve actuators, and crowd-sourced data items 2506 describing field observations of cavitation during specific load transitions. The LLM 1602 may infer that the components of the industrial asset 1504 contributing to the anomalous state (FIG. 16, 1604A) may include degraded main control-valve responsiveness and suboptimal bypass-valve sequencing. Further, the recommended maintenance tasks for mitigating the anomalous state (FIG. 16, 1604B) may include recalibration or replacement of the main control-valve actuator, inspection of the bypass-valve actuators, and/or reconfiguration of transient-mode control parameters to reduce cavitation. In some implementations, the LLM 1602 may also attribute the anomalous state of the industrial asset 1504 to suspected root causes contributing to the anomalous state (FIG. 16, 1604C), such as long-term wear of the main control-valve actuator under high-cycle load variations and delayed calibration updates in the control logic.

The asset diagnostic inference 1604 generated by the LLM 1602 based on the enriched asset diagnostic prompt 2508 may provide a structured and evidence-based assessment of the anomalous state of the industrial asset 1502. Further, asset diagnostic inference 1604 may enable decision-support systems or automated remediation modules to act on a clear understanding of the components most responsible for the anomalous state, the concrete tasks required to mitigate the anomalous state, and in some embodiments, the likely underlying root causes that need to be addressed to prevent recurrence.

In some embodiments, the anomaly detection system may verify that each component of the industrial asset 1504 contributing to the anomalous state and each recommended asset maintenance tasks for mitigating the anomalous state is supported by at least one reference within the retrieved set of asset maintenance data items 1520, thereby preventing unsupported extrapolation. The verified asset diagnostic inference 1604 may be stored in a diagnostic inference repository.

By integrating the enriched evidence set from subprocess 1440C with advanced language-model-based reasoning, subprocess 1440D may produce the asset diagnostic inference 1604 that is specific in identifying the components contributing to the anomalous state and prescriptive in recommending maintenance interventions. This approach ensures that diagnostic reasoning is evidence-based, traceable to authoritative and field-tested sources, and capable of supporting both manual and automated mitigation of anomalous operating states across diverse industrial assets.

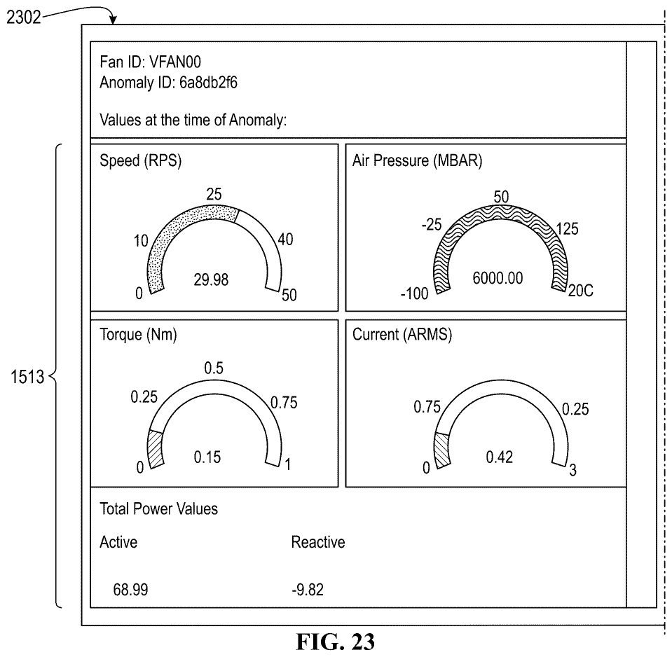

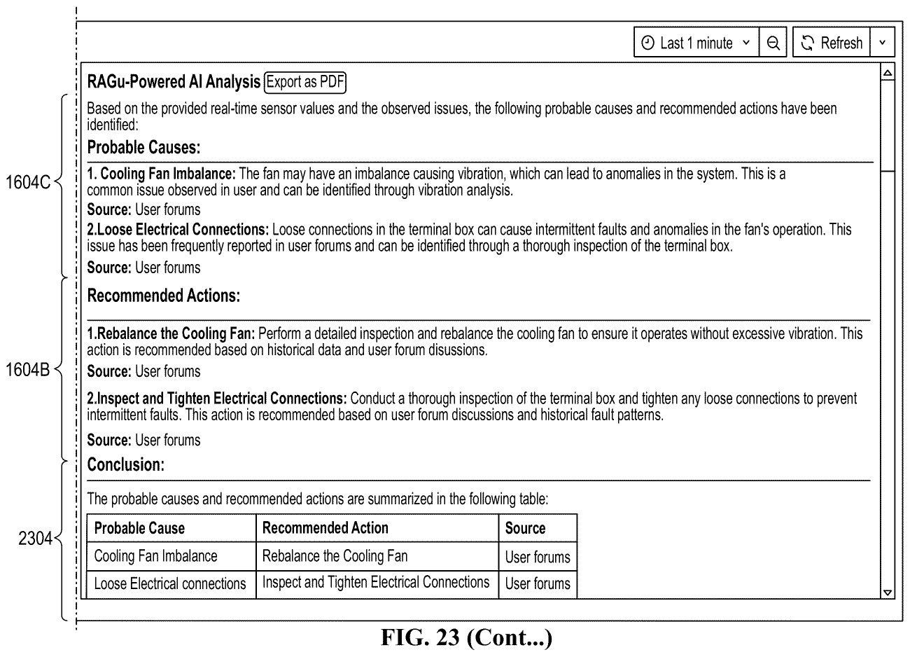

In one or more embodiments, as shown in FIG. 23, the anomaly detection system may further instantiate an asset diagnostic graphical user interface 2302 that may enable operators or analysts to visualize, in a single integrated display, the contextual and diagnostic information derived from the asset diagnostic inference 1604. The asset diagnostic graphical user interface 2302 may at least display four categories of information pertaining to the anomalous state of the industrial asset 1504. As a first category of information, the alert metadata 1513 indicative of the operating state of the industrial asset 1504 at the time the anomaly detection algorithm 1508 generated the asset alert 1510, may be displayed. As shown in the example of FIG. 23, the asset diagnostic graphical user interface 2302 may present indications for sensor values such as speed (e.g., 29.98 RPS), air pressure (e.g., 6000 MBAR), torque (e.g., 0.15 Nm), and current (e.g., 0.42 ARMS), together with active power measurement (68.99) and reactive power measurement (−9.82) at the time the anomaly detection algorithm 1508 generated the asset alert 1510. The displayed values may correspond to the alert metadata 1513 that was extracted by the alert metadata extractor 1512 and form the contextual baseline for subsequent diagnostic reasoning.

The asset diagnostic graphical user interface 2302 may further display, as a second category of information, suspected root causes contributing to the anomalous state 1604C, such as “cooling fan imbalance” (e.g., detected through vibration analysis or “loose electrical connections” based on analysis of intermittent faults caused by degraded electrical connections. Further, as a third category of information, the asset diagnostic graphical user interface 2302 may display the recommended asset maintenance tasks for mitigating the anomalous state 1604B as predicted by the LLM 1602. Continuing the above example, the asset diagnostic graphical user interface 2302 may present recommended actions such as “rebalancing the cooling fan” and “inspecting and tightening electrical connections”. These recommended asset maintenance tasks for mitigating the anomalous state 1604B may be presented together with their diagnostic context so that maintenance personnel may be able to act promptly and accurately.

The asset diagnostic graphical user interface 2302 may further include a source identification data table 2304 as a fourth category of information. The source identification data table 2304 may indicate, for each suspected root cause contributing to the anomalous state of the industrial asset 1504 and for corresponding recommended asset maintenance task for mitigating the anomalous state, the respective asset maintenance data collection 1518 that was accessed or used by the LLM 1602 to predict that particular root cause and recommended asset maintenance task. As shown in FIG. 23, the source identification data table 2304 may include the corresponding data source as “user forum or crowd-sourced data collection”, i.e., highlighting that the asset diagnostic inference 1604 is supported by field level experience rather than solely by OEM documentation or structured historical records. This explicit source attribution may allow improvement in the interpretability and trustworthiness of the asset diagnostic inference 1604.

Stated another way, the source identification data table 2304 may include a structured mapping between each respective pair of suspected root cause and corresponding recommended asset maintenance task, and the specific asset maintenance data collection 1518 from which the supporting information was retrieved and utilized by the LLM 1602 to generate the asset diagnostic inference 1604. For example, each row of the source identification data table 2304 may correspond to a distinct diagnostic pairing, wherein the first field may identify the root cause predicted by the LLM 1602, the second field may specify the associated recommended asset maintenance task, and the third field may indicate the asset maintenance data collection (e.g., maintenance manual data collection, maintenance record data collection, or crowd-sourced data collection) that was used as the evidentiary basis for generating the asset diagnostic inference 1604, predicting the root cause, and/or the recommended asset maintenance task. By linking each diagnostic output to its originating data collection, the source identification data table 2304 may enable traceability of the reasoning process executed by the LLM 1602, thereby facilitating validation, auditability, and explainability of the predicted relationships between observed anomalies, inferred root causes, and corresponding maintenance recommendations.

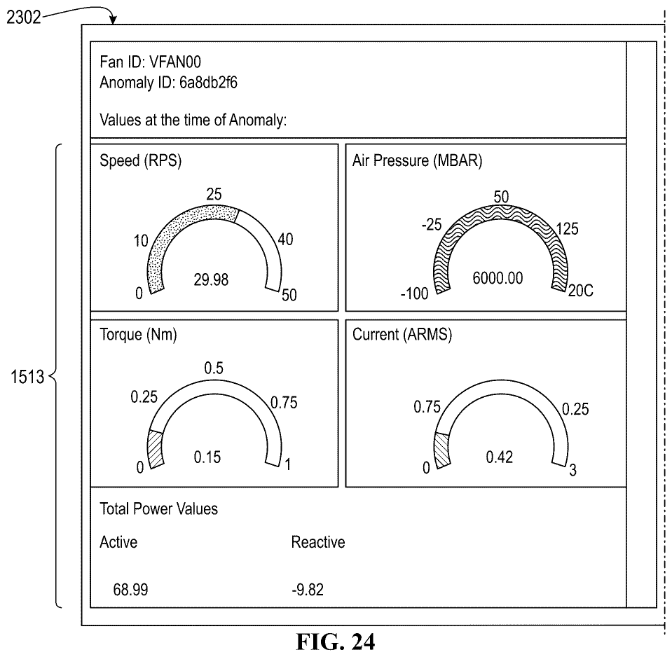

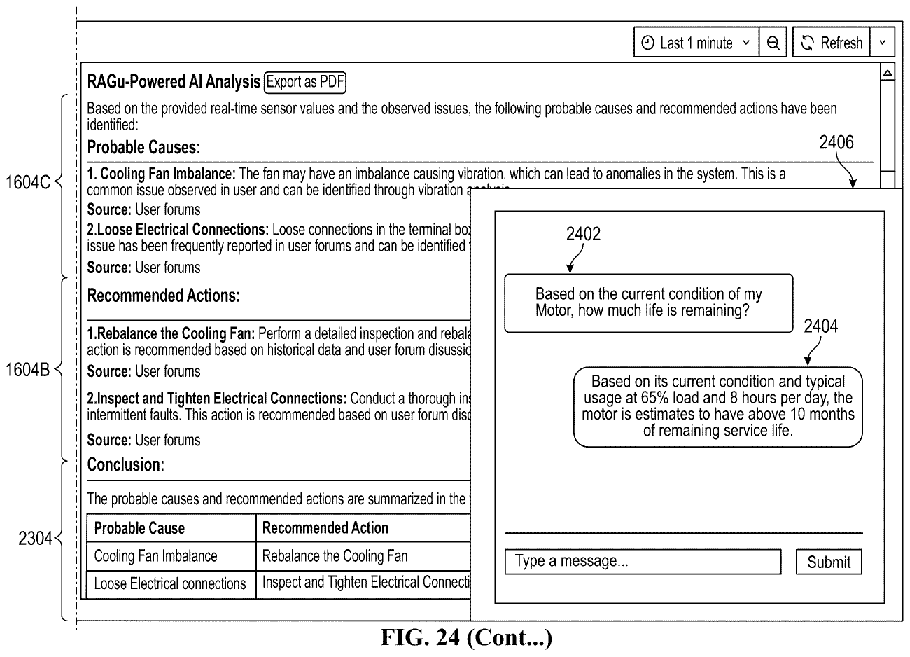

In another embodiment, as illustrated in FIG. 24, the asset diagnostic graphical user interface 2302 may further include a digital assistant interface 2406 that may allow the operator to engage in interactive analysis with the anomaly detection system through the LLM 1602. Through the digital assistant interface 2406, the operator may input a natural language query 2402 to seek additional predictive and/or maintenance-related information. For example, an operator may input the natural language query “Based on the current condition of my Motor, how much life is remaining?”. Upon receiving the natural language query 2402, the anomaly detection system may compute an embedding value representing the semantic intent of the natural language query 2402 and may transmit the embedding value to one or more of the asset maintenance data collections 1518. The embedding value may then be used by the alert enrichment service 1610 to search the asset maintenance data collections 1518, e.g., to retrieve a corpus of maintenance data items related to the natural language query 2402. The corpus of maintenance data items may include a distinct set of data items from each asset maintenance data collection (e.g., the maintenance manual data collection, the maintenance record data collection, the crowd-sourced data collection, etc.). The corpus of maintenance data items may include without limitation, historical degradation profiles of similar motors, field-reported data on bearing wear rates, OEM-specified duty cycle limits, and/or the like.

The anomaly detection system may then provide the natural language query 2402 together with the retrieved corpus of maintenance data items to the LLM 1602, which may generate a response to the natural language query 2404. For example, as shown in FIG. 24, the response to the natural language query 2404 may indicate that, based on the current operating condition of the motor and typical duty-cycle patterns (e.g., operating at 65% load for 8 hours per day), the motor is estimated to have about 10 months of remaining service life. The generated response to the natural language query 2404 may then be displayed directly in the digital assistant interface 2406 of the asset diagnostic graphical user interface 2302, enabling the operator to obtain context-specific guidance without leaving the diagnostic environment.

By integrating the display of the alert metadata 1513, the components contributing to the anomalous state 1604A, the recommended asset maintenance tasks 1604B, the suspected root causes 1604C, and the source identification data table 2304 within the asset diagnostic graphical user interface 2302, and further enabling interactive querying through the digital assistant interface 2406, the anomaly detection system may provide an end-to-end diagnostic and decision-support environment. The asset diagnostic graphical user interface 2302 may not only convey the reasoning steps taken by the LLM 1602 but also link the asset diagnostic inference 1604 to supporting evidence in the asset maintenance data collections 1518, thereby enhancing explainability and facilitating informed, efficient maintenance decisions.

Adapting the Asset Alert to an Enriched Asset Alert that Includes the One or More Components of the Industrial Asset Contributing to the Anomalous State and the One or More Recommended Asset Maintenance Tasks

In one or more embodiments, method 1400 may include process 1450. Process 1450 which may include adapting the asset alert to an enriched asset alert that incorporates both the one or more components of the industrial asset contributing to the anomalous state and the one or more recommended asset maintenance tasks for mitigating the anomalous state, may function to transform asset alert 1510 to an enriched asset alert based on the asset diagnostic inference 1604 generated by the LLM 1602.

In an embodiment, as shown in FIG. 16, the asset diagnostic inference 1604 may be processed by the alert enrichment service 1610 to generate an enriched asset alert 1608. In one example, the alert enrichment service 1610 may combine the asset diagnostic inference 1604 with the alert metadata 1513 of the originating asset alert 1510 and serialize the enriched asset alert 1608 in a machine-readable format such as JSON or XML. The enriched asset alert 1608 may include fields, such as but not limiting to, anomaly identifiers, timestamps, sensor identifiers, measured values of target attributes at the time the asset alert 1510 was generated, baseline references, computed deviation metrics, the components of the industrial asset 1504 contributing to the anomalous state (FIG. 16, 1604A), the recommended asset maintenance tasks for mitigating the anomalous state (FIG. 16, 1604B), and in some implementations suspected root causes contributing to the anomalous state (FIG. 16, 1604C). The alert enrichment service 1610 may also attach references that link each listed component contributing to the anomalous state and recommended asset maintenance task to supporting asset maintenance data items 1520 and corresponding asset maintenance data collections 1518. The enriched asset alert 1608 may be assigned a unique identifier, version and applicability metadata, and delivery attributes for publication to a message bus, a computerized maintenance management system, or an operator interface.

In an embodiment, the alert augmentation process within the alert enrichment service 1610 may include a formatting sub-process that maps the asset diagnostic inference 1604, e.g., including the components of the industrial asset contributing to the anomalous state 1604A, the recommended asset maintenance tasks 1604B, and, where applicable, the suspected root causes 1604C, into a pre-defined alert schema. This schema may follow structured formats such as JSON, XML, or an industrial standard such as ISA-95-compliant alert records, thereby ensuring that the enriched asset alert 1608 can be programmatically ingested by external computerized maintenance management systems (CMMS) or supervisory control interfaces.

In another implementation, the alert augmentation process may include a compliance validation step that ensures that the recommended maintenance tasks are aligned with safety and regulatory standards. For example, if the asset diagnostic inference 1604 recommends a bearing replacement, the compliance validation step may process asset diagnostic inference 1604 such that the enriched asset alert 1608 references the appropriate OEM-approved torque settings and lubrication instructions, including a version identifier of the relevant OEM manual. Further, when such information is missing or incomplete, the alert enrichment service 1610 may retrieve the information from the asset maintenance data collections 1518 before generating the enriched asset alert 1608. In some embodiments, the alert augmentation process may also append contextual and time-sensitive directives to the enriched alert.

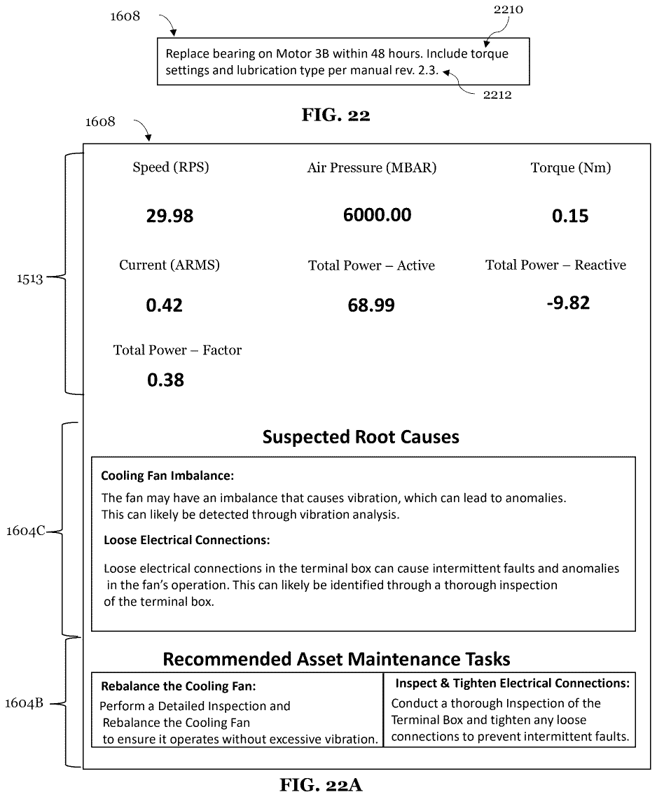

As illustrated in one non-limiting example of FIG. 22, the enriched asset alert 1608 may at least include a text string specifying a prescriptive maintenance directive generated as part of the enrichment process. In this example, the text string within the enriched asset alert 1608 specifies one or more OEM instructions 2210 for performing the one or more recommended asset maintenance tasks. As shown the one or more recommended as “Replace bearing on Motor 3B within 48 hours.” The text string of the enriched asset alert 1608 may further specify a version 2212 to the OEM maintenance manual, in which the one or more OEM instructions are documented. For example, the text string may specify “Include torque settings and lubrication type per manual rev. 2.3.” The text string embedded in the enriched asset alert 1608 may therefore guide operators and/or maintenance technicians to consult the precise source documentation that specifies the correct torque values, lubrication type, and other procedural details for bearing replacement. By integrating this actionable guidance directly within the enriched alert, the system eliminates the need for maintenance teams to manually search for or verify external reference materials, thereby reducing the likelihood of procedural errors and minimizing downtime during anomaly resolution.

Further, as illustrated in FIG. 22A, in an alternate embodiment, the enriched asset alert 1608 may further be configured to present, within a unified diagnostic view, the original alert metadata 1513 extracted from the asset alert 1510 together with the diagnostic and prescriptive elements derived from the asset diagnostic inference 1604. This embodiment may enable operators to see both the raw anomaly context and the analytic output from the LLM 1602 in a single, actionable record. In the example shown in FIG. 22A, the alert metadata 1513 may include sensor values that characterize the operating state of the industrial asset 1504 (e.g., industrial fan) at the moment the anomaly detection algorithm 1508 generated the asset alert 1510. As shown, the alert metadata 1513 may include data such as rotational speed (29.98 RPS), air pressure (6000 MBAR), torque (0.15 Nm), current (0.42 ARMS), active power (68.99), reactive power (−9.82), and a power factor (0.38). These values of the alert metadata 1513 may allow operator or maintenance personnel to understand the baseline operating condition of the industrial asset 1504 when the anomaly was detected.

The enriched asset alert 1608 may further include one or more components of the asset diagnostic inference 1604 generated by the LLM 1602. As shown, the enriched asset alert 1608 may include the suspected root causes contributing to the anomalous state (1604C). In this instance, the suspected root causes displayed within the enriched asset alert 1608 may consist of a cooling fan imbalance and loose electrical connections in the terminal box, each accompanied by a natural language explanatory note. The note for the cooling fan imbalance may indicate that “the fan may have an imbalance that causes vibration, which can lead to anomalies. This can likely be detected through vibration analysis.” Further, the note for the loose electrical connections may specify that “loose electrical connections in the terminal box can cause intermittent faults and anomalies in the fan's operation. This can likely be identified through a thorough inspection of the terminal box.”

Further, the enriched asset alert 1608 may present the recommended asset maintenance tasks for mitigating the anomalous state (1604B) in a clearly delineated section. The recommended tasks may include, as shown, performing a detailed inspection and rebalancing of the cooling fan to eliminate excess vibration, as well as conducting a thorough inspection and tightening of electrical connections in the terminal box to prevent intermittent faults. By presenting these recommended maintenance tasks together with the suspected root causes and the original alert metadata 1513, the enriched asset alert 1608 may provide a comprehensive diagnostic artifact that not only signals the presence of an anomaly but also offers targeted corrective actions grounded in the underlying operational context.

This alternate embodiment of the enriched asset alert 1608, as depicted in FIG. 22A, exemplifies how the anomaly detection system may unify raw anomaly data, analytic insights, and actionable maintenance guidance into a single integrated alert that can be consumed by operators or maintenance systems for rapid and informed decision-making.

As illustrated in FIG. 25, in some embodiments, the asset diagnostic inference 1604 generated by the LLM 1602 may be processed within an alert augmentation process operating within the alert enrichment service 1610 to produce the enriched asset alert 1608. The alert augmentation process may enable the alert enrichment process 1610 to translate the diagnostic reasoning included in the asset diagnostic inference 1604 generated by the LLM 1602, into a structured, actionable, and machine and human-readable enriched asset alert 1608, that can be consumed by decision-support systems or a predictive maintenance pipeline.

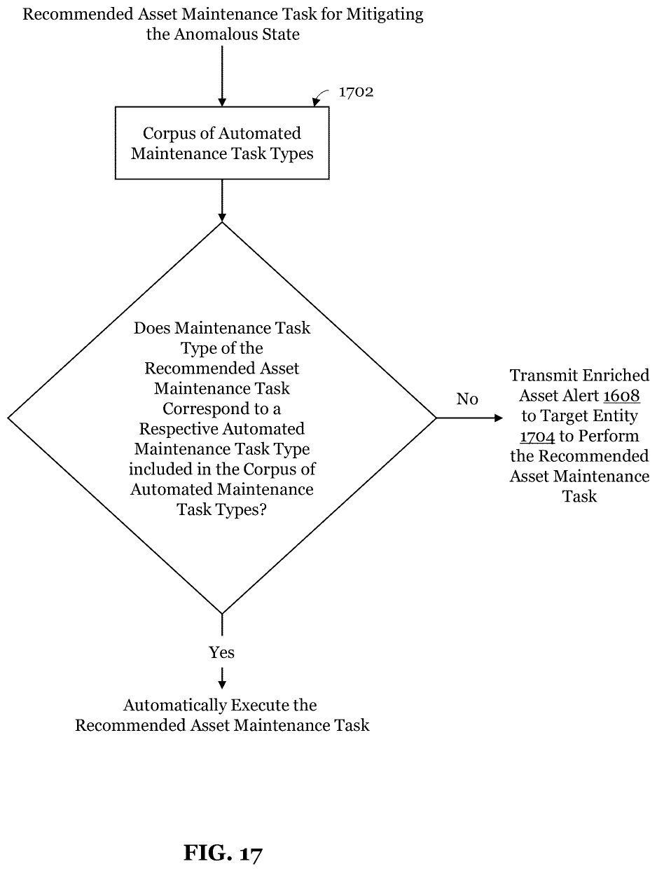

In one or more embodiment, once the asset alert 1510 has been adapted into the enriched asset alert 1608, the anomaly detection system may evaluate each recommended asset maintenance task included in the enriched asset alert 1608 against a corpus of automated maintenance task types in order to determine whether a given recommended task is eligible for direct, autonomous execution by the anomaly diagnostic system or otherwise requires escalation to a target entity for operator-led intervention. As shown in one non-limiting example in FIG. 17, each recommended asset maintenance task for mitigating the anomalous state of the industrial asset 1504 may be compared against a corpus of automated maintenance task types 1702 stored in a repository accessible to a maintenance subsystem of the anomaly detection system. The corpus of automated maintenance task types 1702 may include a catalog of maintenance actions that the maintenance subsystem may be authorized and technically capable of executing autonomously, such as firmware updates, software parameter resets, actuator profile adjustments, sensor recalibrations, lubrication routines, and/or voltage and current-limiting procedures. The corpus of automated maintenance task types 1702 may be dynamically updated to reflect newly validated maintenance procedures that have been proven to be safe and effective for autonomous execution in field conditions.

In some embodiments, the comparison between the recommended asset maintenance tasks and the corpus of automated maintenance task types 1702 may be implemented by an automated maintenance decision engine that is part of the alert maintenance subsystem. The decision engine may perform a rules-based or machine-learning-assisted classification to determine whether a given recommended maintenance task is eligible for autonomous execution. The classification may take into account one or more contextual parameters such as the class and configuration of the industrial asset 1504, the availability of actuation hardware, the criticality level of the asset alert 1510, the operational safety envelope, and current operating loads.

In response to a determination that the recommended asset maintenance task for mitigating the anomalous state matches an entry in the corpus of automated maintenance task types 1702, the maintenance subsystem may automatically execute that recommended asset maintenance task without requiring operator intervention. For example, in response to determining an automated maintenance task is equivalent or corresponds to a respective automated maintenance task type included in the corpus of automated maintenance task types, a component setting of a fan-speed controller of the industrial asset 1504 may be automatically adjusted from 1800 rpm to 1650 rpm to bring vibration levels within a predefined target limit. Similarly, in another scenario, a component setting of a valve actuator may be recalibrated from a 30-degree default position to a 25-degree throttled position to stabilize a pressure oscillation.

In one implementation, the maintenance subsystem may communicate with an embedded programmable controller of the industrial asset 1504, such as a programmable logic controller (PLC), a distributed control system (DCS) controller, or a field-programmable gate array (FPGA)-based actuator driver. The programmable controller may translate high-level maintenance instructions into low-level hardware control signals to modify a relevant component setting of the industrial asset 1504 such as an operating speed, a valve position, a pressure threshold, or a voltage limit.

For example, if the enriched asset alert 1608 includes a recommendation to adjust the operating speed of an industrial cooling fan to reduce bearing temperature, the maintenance subsystem may transmit the new target speed to the programmable controller as an updated component setting of the fan motor drive. In another example, the enriched asset alert 1608 may recommend recalibrating a valve actuator controlling flow to a heat-exchanger circuit. In response, the maintenance subsystem may issue a control instruction to the programmable controller to reposition the valve to a calibration reference point and execute the recalibration sequence.

In some embodiments, the raw sensor data that originally caused the generation of the asset alert 1510 may also include readings of a target attribute of the industrial asset 1504, such as temperature, pressure, voltage, current, or vibration amplitude. The recommended asset maintenance task may aim to change this target attribute from a first measured value associated with the anomalous state to a desired target value associated with normal operating conditions of the industrial asset 1504. For example, if the target attribute corresponds to the rotational speed of a blower fan, and the anomalous state is triggered when the blower speed drops below a safety threshold due to accumulated mechanical drag, the recommended asset maintenance task may specify increasing the blower speed to a prescribed nominal range. In such an implementation, the programmable controller may automatically execute the recommended asset maintenance task by issuing control signals to adjust the blower motor power input, thereby increasing the rotational speed from the measured value of the target attribute to the prescribed target value.

By enabling automated modification of relevant component settings for tasks included in the corpus of automated maintenance task types 1702, the anomaly detection system can reduce maintenance latency, eliminate delays caused by manual operator input, and ensure a rapid and controlled return of the industrial asset 1504 to acceptable operating conditions. This capability further integrates predictive diagnostics with automated corrective actions, improving both operational efficiency and the reliability of the predictive maintenance pipeline.

In some embodiments, when the recommended asset maintenance task for mitigating the anomalous state does not match any entry in the corpus of automated maintenance task types 1702, the maintenance subsystem may classify that task as unsuitable for autonomous execution. In such cases, e.g., as depicted in FIG. 17, the maintenance subsystem may transmit, over a computer network, the enriched asset alert 1608 to a target entity 1704. The target entity 1704 may include, without limitation, a maintenance operator, a field service team, a graphical user interface, and/or a computerized maintenance management system (CMMS). The transmitted enriched asset alert 1608 may convey to the target entity 1704 all the necessary information to execute the recommended asset maintenance task, e.g., the original alert metadata 1513, the components of the industrial asset 1504 contributing to the anomalous state (1604A), the recommended asset maintenance tasks for mitigating the anomalous state (1604B), and, where applicable, associated OEM procedural references, so that the target entity 1704 may schedule, plan, and carry out the recommended asset maintenance task. The enriched asset alert 1608 may further include, in some implementations, data pertaining to historic maintenance events performed on that industrial asset 1504, e.g., retrieved from the maintenance manual data collection and any other maintenance-related information, e.g., included in the crowd-sourced data collection.

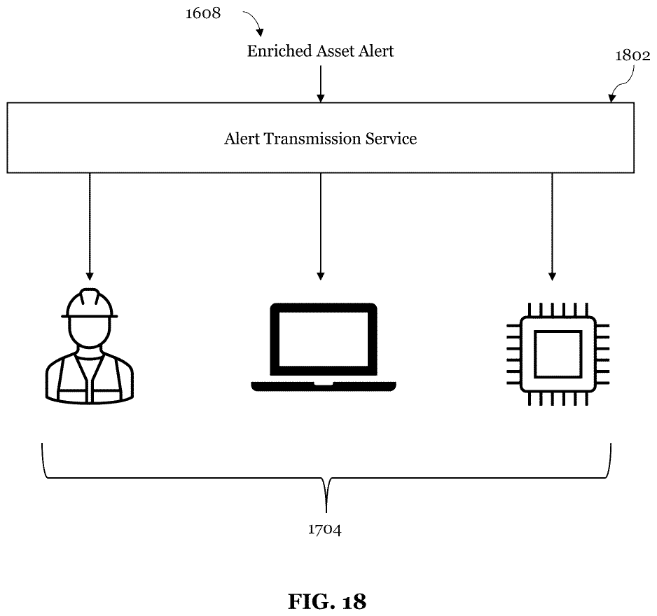

In one or more embodiments, as illustrated in FIG. 18, an enriched asset alert 1608 generated following the adaptation of the asset alert 1510 may be transmitted to the target entity 1704 through an alert transmission service 1802. In an implementation, the alert transmission service 1802 may be implemented using one or more computing nodes connected over a computer network, such as an industrial Ethernet backbone or a secured cloud-based messaging bus. The alert transmission service 1802 may expose a programmatic interface, such as a RESTful API or a message broker interface (e.g., using MQTT or AMQP protocols), enabling other components of the anomaly detection system to forward the enriched asset alert 1608 in a machine-readable format to the target entity 1704.

The alert transmission service 1802 may further include authentication, encryption, and role-based access control mechanisms to ensure that the enriched asset alert 1608 is securely routed to authorized recipients and subsystems. In some implementations, the alert transmission service 1802 may implement message queue buffering to guarantee reliable delivery, even when the target entity 1704 may be temporarily offline or disconnected.

The target entity 1704 receiving the enriched asset alert 1608 may include, by way of example, a field operator workstation in a control room, a portable maintenance tablet or mobile device carried by a field technician, a centralized computerized maintenance management system (CMMS) server, or an embedded controller integrated with the industrial asset. The embedded controller may include, without limitation, a Siemens S7-1500 or S7-1200 programmable logic controller (PLC) for process control of turbine assemblies and compressors, a Rockwell Automation ControlLogix® or CompactLogix® PLC for discrete manufacturing and conveyor systems, a Schneider Electric Modicon™ M580 PLC for plant-wide distributed control, an ABB AC500 PLC for robotics and motion-control applications, or an Emerson DeltaV™ controller integrated with distributed control systems in chemical or power-generation facilities.

In certain implementations, the enriched asset alert 1608 may be transmitted to multiple target entities simultaneously. For example, the enriched asset alert 1608 that specifies the replacement of a degraded bearing on a centrifugal pump, together with torque and lubrication instructions extracted from an OEM maintenance manual, may be transmitted both to a CMMS and a mobile device of a field technician, while also being transmitted to a local PLC such as a Siemens S7-1500 to adjust operating limits or initiate a controlled shutdown of the affected pump to prevent further damage.

The alert transmission service 1802 may therefore function as an interface layer that bridges the predictive maintenance pipeline with the operational and maintenance ecosystem of the industrial site. By ensuring that the enriched asset alert 1608 is transmitted reliably and securely to appropriate target entities, the alert transmission service 1802 may enable actionable diagnostic insights, such as those derived by the large language model, to be operationalized in real-time for mitigating the anomalous state of the industrial asset.

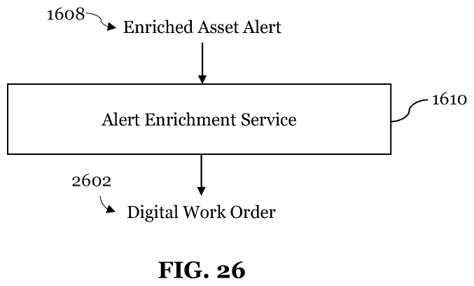

In one or more embodiments, as illustrated in FIG. 26, the alert enrichment service 1610 may be configured not only to generate the enriched asset alert 1608 but also to further assess the context provided by the enriched asset alert 1608 in order to create a digital work order 2602. The assessment may include parsing the recommended asset maintenance tasks contained in the enriched asset alert 1608, evaluating the urgency of the recommended asset maintenance tasks, verifying the applicability of the recommended asset maintenance tasks to the current operating state of the industrial asset 1504, and determining whether any additional instructions or scheduling constraints are required for execution of the recommended asset maintenance tasks. By performing this assessment, the alert enrichment service 1610 may enable translation of the enriched asset alert 1608 into a machine and human readable, actionable, and structured digital work order 2602. The digital work order 2602 may include, without limitation, one or more asset maintenance tasks that, when performed on the industrial asset 1504, mitigates the anomalous state associated with the industrial asset 1504. The digital work order 2602 may further include a specified time window within which the one or more asset maintenance tasks are to be performed on the industrial asset 1504. In some embodiments, the enriched asset alert 1608 may be treated as the digital work order 2602, without generating a separate artifact or data object. This approach may reduce processing steps and latency in critical response scenarios, allowing the enriched alert to serve as both the diagnostic and the prescriptive record.

In some implementations, the alert enrichment service 1610 may derive the specified time window by applying rules or thresholds defined by operational safety policies, OEM recommendations, and/or prior incident histories. For example, in one instance, the enriched asset alert 1608 may report that the drive-end bearing of a cooling fan in the industrial asset 1504 has exceeded permissible vibration thresholds and must be replaced to prevent unplanned downtime. The alert enrichment service 1610, after assessing the context of the enriched asset alert 1608, may generate the digital work order 2602 specifying that the “bearing of Motor 3B must be replaced within 48 hours”. The digital work order 2602 may include additional implementation details extracted from the enriched asset alert 1608, such as OEM-recommended torque settings and lubrication specifications drawn from a particular version of the maintenance manual (e.g., revision 2.3), thereby ensuring that the field technician can execute the task consistently with OEM guidelines.

In another instance, the enriched asset alert 1608 may indicate that a hydraulic actuator in a pump assembly is exhibiting unstable pressure oscillations. The alert enrichment service 1610 may analyze this context and generate the digital work order 2602 instructing a maintenance technician to inspect the actuator valve, clean the associated pressure control ports, and recalibrate the actuator within a 24-hour time window to restore stable operation. The digital work order 2602 may further identify the specific ports and calibration procedures corresponding to the pump assembly, e.g., by referencing the appropriate OEM maintenance manual version, as captured in the enriched asset alert 1608.

Once generated, the digital work order 2602 may be transmitted, in real-time or near real-time, over a secure computer network by the alert enrichment service 1610 to the target entity 1704, e.g., as described with respect to FIG. 18. In some implementations, the alert enrichment service 1610 may format the digital work order 2602 in a structured, machine-readable representation such as JSON or XML to ensure compatibility with downstream enterprise systems.

By enabling the alert enrichment service 1610 to further assess the context of the enriched asset alert 1608 to generate the digital work order 2602, the anomaly detection system may enable diagnostic insights being promptly transformed into concrete and actionable directives. This capability may help reduce latency between anomaly detection and corrective action, improves operational responsiveness, and minimizes the likelihood of prolonged equipment downtime or escalation of the anomalous condition.

In some embodiments, the anomaly detection system may employ a multi-stage reasoning approach in which the asset diagnostic inference 1604 generated by the LLM 1602 may be further evaluated and revised by a second large language model. In these embodiments, the asset alert 1510 may not be adapted to the enriched asset alert 1608 directly after the asset diagnostic inference 1604 is generated. Instead, the asset diagnostic inference 1604 produced by the LLM 1602 may be routed to the second large language model for a secondary assessment to provide a more refined diagnostic outcome.

In one embodiment, the second large language model may be configured differently from the LLM 1602, for example, pre-trained to specialize in tasks such as validation of preliminary assessments, reconciliation of evidence from heterogeneous data sources, optimization of recommended asset maintenance tasks for execution feasibility, and/or prioritization of asset maintenance tasks based on one or more operational constraints. For instance, the LLM 1602 may be a generative reasoning model, such as a GPT model, optimized for interpreting diagnostic prompts and natural-language content of maintenance documentation. The second large language model may instead be a model specialized for domain-specific decision support, such as a fine-tuned LLAMA™ instance or a hybrid transformer-graph neural network model trained to map inferred anomalous states of the industrial asset 1504 to executable maintenance workflows. Because of such architectural and training differences, the second large language model may be capable of analyzing the asset diagnostic inference 1604 generated by the LLM 1602, identifying gaps or inconsistencies, and substituting a revised asset diagnostic inference 2702 that is better aligned with domain-specific best practices and real-world maintenance execution requirements.

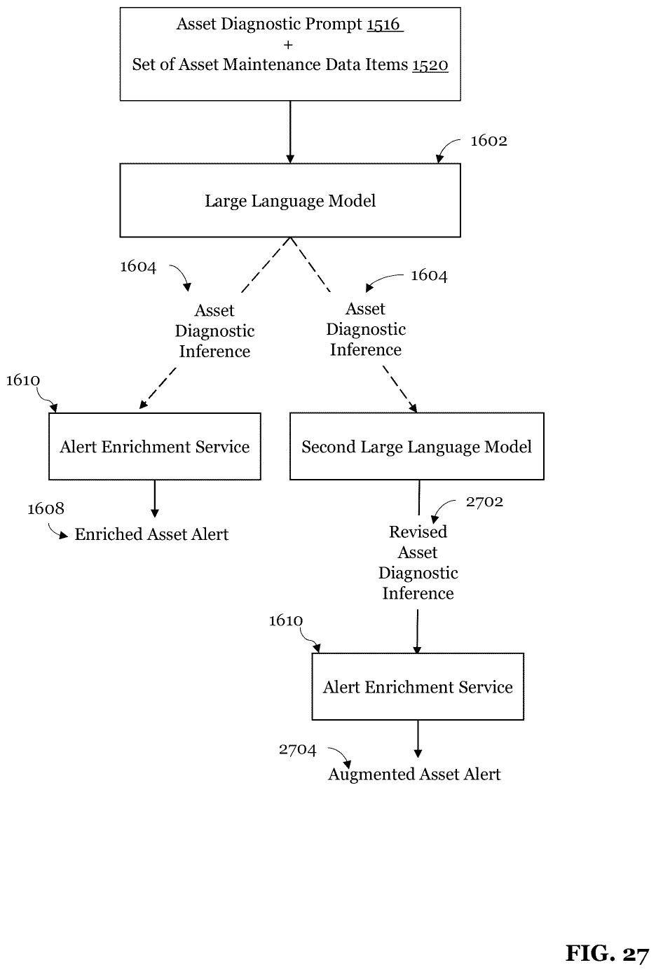

In one non-limiting example shown in FIG. 27, the second large language model may generate the revised asset diagnostic inference 2702 in response to assessing the initial asset diagnostic inference 1604 produced by the LLM 1602. The revised asset diagnostic inference 2702 may include, in some cases, a revised set of components of the industrial asset 1504 contributing to the anomalous state, a revised set of recommended asset maintenance tasks for mitigating the anomalous state, or both. For example, while the LLM 1602 may initially identify a cooling-fan imbalance and a loose terminal connection as components contributing to a vibration anomaly, the second large language model may predict the revised asset diagnostic inference 2702 by, for example, adding an additional component such as a fatigued drive-shaft coupling or replacing one of the previously identified components based on correlations detected in historical failure reports. Similarly, the second large language model may refine the recommended asset maintenance tasks by replacing a generic vibration-dampening instruction with a more precise corrective balancing procedure or by prioritizing tasks that minimize downtime during peak load conditions.

The revised asset diagnostic inference 2702 produced by the second large language model may be provided to the alert enrichment service 1610, which may generate an augmented asset alert 2704 based on the revised asset diagnostic inference 2702. The augmented asset alert 2704 may incorporate the revised set of components contributing to the anomalous state and the revised set of recommended asset maintenance tasks. In some implementations, the revised set of components may include an additional set of components, a reduced set of components, or a different set of components when compared to the components included in the original asset diagnostic inference 1604 generated by the LLM 1602. Similarly, the revised set of recommended asset maintenance tasks may include an additional set of tasks, a reduced set of tasks, or a different set of tasks when compared to those included in the original asset diagnostic inference 1604 generated by the LLM 1602.

Once the augmented asset alert 2704 is generated, the augmented asset alert 2704 may be transmitted, over a computer network, to the target entity 1702, such as a field-service technician terminal, an enterprise maintenance-management system, or an automated programmable logic controller (PLC) deployed at the asset site. This may ensure that downstream decision-making or remedial action is informed by the most refined and contextually relevant diagnostic assessment. In some embodiments, one or more of the revised asset maintenance tasks included in the revised asset diagnostic inference 2702 may correspond to automated maintenance task types included in a predefined corpus of automated maintenance task types. In such cases, the augmented asset alert 2704 may include actionable instructions that can be executed automatically by a connected PLC or by an automation-capable supervisory control and data acquisition (SCADA) system without requiring intervention by human operators. For example, a revised asset maintenance task specifying adjustment of a valve-control parameter or reconfiguration of a drive-shaft torque-limiter setting may be automatically executed by the control subsystem upon receipt of the augmented asset alert 2704, whereas other tasks, such as physical replacement of mechanical components, may still be routed to the target entity 1702 for manual execution.

As one illustrative industrial example, the industrial asset 1504 may include a six-axis robotic arm deployed in an automotive body-panel welding station. The anomaly detection algorithm 1508 may generate the asset alert 1510 in response to detecting an increase in drive-motor current in the fourth axis along with irregular encoder-position feedback during repetitive welding cycles. The alert metadata 1513 may include timestamped current and vibration measurements, joint-torque deviation profiles, encoder-drift data, and maintenance-cycle history indicating that the anomaly emerged after a scheduled lubrication service.

The asset diagnostic prompt constructor 1514 may generate the asset diagnostic prompt 1516 using the alert metadata 1513 and a set of model instructions that guide the LLM 1602 to assess mechanical and electromechanical subsystems. Based on the asset diagnostic prompt 1516, the alert enrichment service 1610 may retrieve relevant maintenance manuals, historical maintenance records, and crowd-sourced data items related to the anomalous state of the robotic arm. The LLM 1602 may then generate the asset diagnostic inference 1604, identifying the components contributing to the anomalous state as a worn harmonic-drive reducer in the fourth axis together with a partially obstructed lubrication line, and recommending reducer replacement and a lubrication-system flush.

In one embodiment, the alert enrichment service 1610 may forgo adapting the asset alert 1510 to the enriched asset alert 1608 and instead route the asset diagnostic inference 1604 to the second large language model specialized for electromechanical reliability analysis. The second large language model may assign greater analytical weight to the vibration-signature data and the historical progression of encoder-drift patterns contained in the alert metadata 1513. By applying this different reasoning strategy, the second large language model may generate the revised asset diagnostic inference 2702 that attributes the anomalous state primarily to bearing-race pitting in the fourth-axis drive assembly rather than to reduce wear. The revised asset diagnostic inference 2702 may further include a refined set of maintenance tasks, such as initiating an immediate software-level adjustment of joint-drive control parameters to damp oscillations, followed by early bearing replacement during the next scheduled maintenance shutdown.

The revised asset diagnostic inference 2702 may therefore differ from and improve upon the original asset diagnostic inference 1604 by identifying a different root-cause component, namely the bearing assembly instead of the reducer, and by prioritizing maintenance tasks that can be initiated more promptly and that address the underlying degradation more accurately. This revised asset diagnostic inference 2702 forms the basis for generating the augmented asset alert 2704, which reflects the updated components contributing to the anomalous state and the revised recommended asset maintenance tasks.

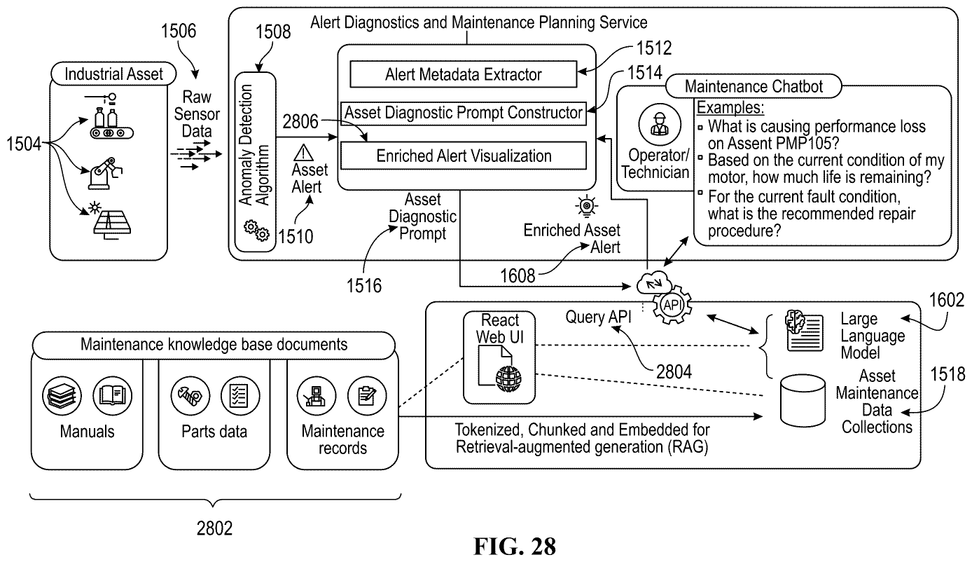

In some embodiments, the method 1400 described herein may be further implemented using a predictive maintenance pipeline as illustrated in FIG. 28. The predictive maintenance pipeline may integrate a sequence of coordinated computer applications and services that operate over one or more interconnected computing platforms. These computing platforms may include on-premises industrial controllers, edge-computing gateways, and/or cloud-hosted analytic and inference engines connected through a secure industrial network. The predictive maintenance pipeline may be deployed across a hybrid environment where low-latency signal acquisition and initial anomaly detection are performed near the edge, whereas large-scale retrieval and inference tasks leverage cloud-based resources.

At a first stage of the predictive maintenance pipeline, raw sensor data 1506 may be captured by (e.g., by the set of sensors 1502) associated with the industrial asset 1504. The industrial asset 1504 may include, by way of example and without limitation, a turbine assembly, a power distribution transformer, or a robotic arm deployed in a manufacturing line. The raw sensor data 1506 may include, without limitation, real-time vibration signatures, motor current draw, inlet and outlet pressure readings, torque measurements, joint-position encoder data, temperature profiles, or other parameters indicative of the operating state of the industrial asset 1504.

In one or more embodiments, the industrial asset 1504 may further include medical equipment that operates according to similar sensor-based monitoring principles. For example, the industrial asset 1504 may include an infusion pump that generates flow-rate telemetry and occlusion-pressure readings, an imaging system such as an X-ray generator or Magnetic Resonance Imaging (MRI) subassembly that produces temperature, coil-current, and system-load telemetry, a ventilator that produces pressure and airflow waveform data, or a sterilization chamber that reports chamber-temperature, humidity, and cycle-progress measurements. The operational characteristics of such medical equipment may be analyzed in substantially the same way as those of traditional industrial machinery, and anomalous operating states may be detected using the techniques described herein.

Alternatively, or additionally, the industrial asset 1504 may include agricultural equipment such as autonomous tractors, sprayer assemblies, irrigation pumps, grain-handling systems, or other farm management machinery that may produce telemetry values including engine load, hydraulic pressure, soil contact metrics, or implement-specific sensor data. In yet other embodiments, the industrial asset 1504 may include laboratory, pharmaceutical, or biotechnology equipment including centrifuges, bioreactor vessels, chromatography systems, or automated dispensing robots that generate sensor values reflecting temperature, rotational speed, dissolved-oxygen levels, column-pressure readings, or reagent-flow parameters during operation.

The raw sensor data 1506 may be ingested by the anomaly detection algorithm 1508 of the predictive maintenance pipeline. The anomaly detection algorithm 1508 may apply statistical deviation detection, machine-learning-based anomaly classifiers, or hybrid techniques to determine that the industrial asset 1504 is operating or is predicted to operate in an anomalous state. In response to detecting the anomalous condition, the anomaly detection algorithm 1508 may generate the asset alert 1510 that characterizes the anomalous state. The asset alert 1510 may include, for example, an alert-type identifier, a timestamp, sensor-channel identifiers, and computed deviation metrics relative to baseline operating conditions.

Upon generation of the asset alert 1510, the predictive maintenance pipeline may route the asset alert 1510 to an alert diagnostics and maintenance planning service. In some embodiments, the alert diagnostics and maintenance planning service may be deployed as a containerized microservice architecture, orchestrated by platforms such as Kubernetes® or OpenShift®, allowing for scalable and resilient processing of incoming asset alerts. The alert diagnostics and maintenance planning service may expose a secure application programming interface (API) endpoint capable of receiving alert payloads from the anomaly detection algorithm 1508. The alert payload may include the asset alert 1510 as a structured JSON or binary-encoded message containing not only the identifier of the anomaly type but also the corresponding time-series sensor data, control actuator states, environmental telemetry, and historical alarm logs.

Within the alert diagnostics and maintenance planning service, an alert pre-processing module may validate the schema of the incoming alert payload, authenticate the origin of the asset alert 1510 and perform data normalization such as unit conversion, timestamp alignment, and noise filtering. This ensures that the subsequent extraction of alert metadata 1513 by the alert metadata extractor 1512 is performed on clean and consistent data.

The alert diagnostics and maintenance planning service may maintain a contextual state store such as a key-value database to correlate the incoming asset alert 1510 with prior alerts, maintenance logs, and current asset operating conditions. By maintaining this historical and contextual view, the alert diagnostics and maintenance planning service may refine the construction of the asset diagnostic prompt 1516 to include not only instantaneous readings but also recent operational trends such as rate of change in vibration amplitude or power factor drift over time.

For example, when the industrial asset 1504 is a conveyor belt assembly in a packaging facility, the alert diagnostics and maintenance planning service may ingest the asset alert 1510 indicative of excessive belt slippage detected by the anomaly detection algorithm 1508. The asset alert 1510 may further indicate sensor values corresponding to recent environmental telemetry such as ambient humidity levels from the last 24 hours and recent operator intervention logs such as tension adjustments performed during the previous shift to enrich the asset diagnostic prompt 1516.

In some implementations, the alert diagnostics and maintenance planning service may also integrate with a feature store that may be used in machine-learning operations (MLOps) to retrieve derived features such as frequency-domain signatures, anomaly progression scores, or component-level degradation indicators. These features, when included in the asset diagnostic prompt 1516, may improve the fidelity of subsequent analysis performed by the retrieval-augmented-generation (RAG) service and the LLM 1602.

The alert metadata extractor 1512, within the alert diagnostics and maintenance planning service, may extract the alert metadata 1513 from the asset alert 1510 that is indicative of the operating state of the industrial asset 1504 at the time the anomaly detection algorithm 1508 generated the asset alert 1510. The alert metadata 1513 may include the measured values of one or more monitored parameters at the time the asset alert 1510 was generated, such as peak vibration amplitude, transient current surges, temperature gradients, or pressure fluctuations, as well as time-correlated operational-mode indicators and recent maintenance history.

The extracted alert metadata 1513 may then be provided to the asset diagnostic prompt constructor 1514, which may construct the asset diagnostic prompt 1516. The asset diagnostic prompt 1516 may combine the extracted alert metadata 1513 with a set of model instructions that instruct the LLM 1602 to perform a diagnostic assessment of the anomalous state of the industrial asset 1504. In some implementations, the asset diagnostic prompt 1516 may be transmitted, using an application programming interface (API), to a retrieval-augmented-generation (RAG) service of the predictive maintenance pipeline.

At a second stage of the predictive maintenance pipeline, the RAG service may receive the asset diagnostic prompt 1516 and automatically query one or more asset maintenance data collections 1518 based on an embedding value derived from the asset diagnostic prompt 1516. The asset maintenance data collections 1518 may include, without limitation, maintenance manual data collection (e.g., OEM maintenance manuals), maintenance record data collection (e.g., historical maintenance record data, or part-change data), and crowd-sourced data collection (e.g., community-contributed field reports), as schematically represented by the maintenance knowledge base documents 2802 in FIG. 28. In some implementations, a query API 2804 may enable the RAG service to perform semantic searches across these heterogeneous collections, which may be pre-processed (e.g., tokenized, chunked, and embedded) for similarity-based retrieval.

At a third stage of the pipeline, the LLM 1602 of the RAG service may use the retrieved set of asset maintenance data items, together with the asset diagnostic prompt 1516, to generate the asset diagnostic inference 1604. The asset diagnostic inference 1604 may include, for example, one or more components of the industrial asset 1504 determined to contribute to the anomalous state, such as a turbine bearing or a robotic-arm harmonic drive, and one or more recommended asset maintenance tasks for mitigating the anomalous state, such as bearing replacement, lubrication-system flushing, or control-parameter adjustments.

The RAG service may then adapt the asset alert 1510 into the enriched asset alert 1608 that includes the components of the industrial asset 1504 contributing to the anomalous state and the recommended asset maintenance tasks for mitigating the anomalous state. In some embodiments, the enriched asset alert 1608 may also be made available to the enriched alert visualization 2806 for display in a user-facing environment, such as a control-room dashboard or a mobile maintenance application. This enriched alert visualization 2806 visualization may enable operators, technicians, and/or maintenance planners to see not only the original alert conditions but also the actionable diagnostic guidance generated downstream in the predictive maintenance pipeline.

In some implementations, the predictive maintenance pipeline may further support a maintenance chatbot, as shown in FIG. 28. The maintenance chatbot may allow an operator or technician to issue natural-language queries regarding the enriched asset alert 1608, such as querying the likely cause of the anomaly or the recommended procedures for repair. The maintenance chatbot may invoke the same RAG service via the query API 2804 to retrieve additional relevant maintenance knowledge and generate targeted responses for display within the operator interface, e.g., asset diagnostic graphical user interface 2302.

The architecture illustrated in FIG. 28 provides a technical advantage by enabling the predictive maintenance pipeline that integrates anomaly detection, alert diagnostics and maintenance planning, and retrieval-augmented diagnostic inference into a coordinated and automated workflow. By routing the asset alert 1510 generated by the anomaly detection algorithm 1508 directly to the alert diagnostics and maintenance planning service, the predictive maintenance pipeline may minimize latency between anomaly detection and diagnostic assessment. Further, by constructing the asset diagnostic prompt 1516 using the alert metadata 1513 and invoking the RAG service through a secure API, the predictive maintenance pipeline may allow the LLM 1602 to perform diagnostic reasoning that is informed not only by the operating state of the industrial asset 1504 at the time of the anomaly but also by relevant historical maintenance records, OEM procedures, and field-derived practices.

This architecture may therefore enable improvements in precision, explainability, and timeliness of diagnostic assessments and allows the enriched asset alert 1608 to be automatically delivered to downstream visualization interfaces or to automated maintenance execution systems. As a result, the predictive maintenance pipeline reduces manual intervention, supports faster decision-making, and enables consistent application of diagnostic best practices across diverse types of industrial assets.

It shall also be noted that the system and methods of the embodiments and variations described herein can be embodied and/or implemented at least in part as a machine comprising a computer-readable medium storing computer-readable instructions. The instructions may be executed by computer-executable components integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, memory sticks (e.g., SD cards, USB flash drives), cloud-based services (e.g., cloud storage), magnetic storage devices, Solid-State Drives (SSDs), or any suitable device. The computer-executable component is preferably a general or application-specific processor, but any suitable dedicated hardware or hardware/firmware combination device can alternatively or additionally execute the instructions.

It shall be noted that, in the method(s) described herein where one or more steps (e.g., processes) are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The systems and methods of the preferred embodiments may additionally, or alternatively, be implemented on an integrated data analytics software application and/or software architecture such as those offered by SAS Institute Inc. of Cary, N.C., USA. Merely for illustration, the systems and methods of the preferred embodiments may be implemented using or integrated with one or more SAS software tools such as SAS® Viya™ which is developed and provided by SAS Institute Inc. of Cary, N.C., USA.

Although omitted for conciseness, the preferred embodiments include every combination and permutation of the implementations of the systems and methods described herein in real-time or near real-time, asynchronously (e.g., sequentially), concurrently (e.g., in parallel), or in any other suitable order by and/or using one or more instances of the systems, elements, and/or entities described herein. It shall be noted that “real-time” or “near real-time” as generally used herein may refer to generating an output or performing an action within strict time constraints. For example, in one or more embodiments, real-time may be understood to be instantaneous, on the order of milliseconds, or on the order of minutes. Of course, depending on the particular temporal nature of the system in which an embodiment is implemented, other appropriate timescales may be considered acceptable for real-time or near real-time processing.

As a person skilled in the art will recognize from the previous detailed description and from the figures and claims, modifications and changes can be made to the embodiments of the application without departing from the scope of the various described embodiments.

What is claimed is:

1. A computer-program product comprising a non-transitory machine-readable storage medium storing computer instructions that, when executed by one or more processors, perform operations comprising:
obtaining sensor data captured by a set of sensors associated with an industrial asset;
generating, by an anomaly detection algorithm, an asset alert that indicates the industrial asset is operating or will operate in an anomalous state based on the anomaly detection algorithm assessing the sensor data;
extracting, from the asset alert, alert metadata indicative of an operating state of the industrial asset at a time the anomaly detection algorithm generated the asset alert;
in response to extracting the alert metadata from the asset alert:
constructing an asset diagnostic prompt that includes the alert metadata and a set of model instructions instructing a large language model to perform a diagnostic assessment of the anomalous state;
querying one or more asset maintenance data collections based on an embedding value of the asset diagnostic prompt;
retrieving, from the one or more asset maintenance data collections, a set of asset maintenance data items related to the asset diagnostic prompt in response to the querying of the one or more asset maintenance data collections; and
generating, based on providing the asset diagnostic prompt and the set of asset maintenance data items to the large language model, an asset diagnostic inference that includes (i) one or more components of the industrial asset contributing to the anomalous state and (ii) one or more recommended asset maintenance tasks for mitigating the anomalous state; and
adapting the asset alert to an enriched asset alert that includes the one or more components of the industrial asset contributing to the anomalous state and the one or more recommended asset maintenance tasks.

2. The computer-program product according to claim 1, wherein:
the industrial asset corresponds to a physical apparatus operably configured to perform one or more tasks in a real-world environment,
the industrial asset includes a set of mechanical components, a set of electrical components, and a set of digitally controlled components that operate together to perform the one or more tasks in the real-world environment, and
the one or more components of the industrial asset contributing to the anomalous state includes at least one mechanical component of the set of mechanical components or at least one electrical component of the set of electrical components.

3. The computer-program product according to claim 1, wherein the computer instructions, when executed by the one or more processors, perform operations further comprising:
in response to adapting the asset alert to the enriched asset alert, transmitting, over a computer network, the enriched asset alert to a target entity when the one or more recommended asset maintenance tasks included in the enriched asset alert fails to satisfy automated maintenance criteria.

4. The computer-program product according to claim 1, wherein the computer instructions, when executed by the one or more processors, perform operations further comprising:
assessing the one or more recommended asset maintenance tasks generated for the industrial asset against a corpus of automated maintenance task types;
detecting that a maintenance task type of the one or more recommended asset maintenance tasks corresponds to a respective automated maintenance task type included in the corpus of automated maintenance task types; and
in response to detecting the maintenance task type of the one or more recommended asset maintenance tasks corresponds to the respective automated maintenance task type, automatically executing, using a programmable controller of the industrial asset, the one or more recommended asset maintenance tasks generated for the industrial asset.

5. The computer-program product according to claim 4, wherein:
at least one sensor of the set of sensors is operably configured to measure a target attribute of the industrial asset,
the sensor data indicates that the target attribute was measured at a first value at the time the anomaly detection algorithm generated the asset alert,
one of the one or more recommended asset maintenance tasks generated for the industrial asset relates to changing the target attribute of the industrial asset from the first value to a target value, and
in response to executing the one of the one or more recommended asset maintenance tasks, a component setting of at least one component of the one or more components is automatically adjusted to change the target attribute of the industrial asset from operating at the first value to the target value.

6. The computer-program product according to claim 1, wherein extracting the alert metadata from the asset alert includes:
instantiating a metadata selection user interface that displays a plurality of distinct pieces of alert metadata included in the asset alert when a total number of the plurality of distinct pieces of alert metadata included in the asset alert exceeds a predetermined metadata count threshold; and
detecting one or more user inputs selecting a subset of the plurality of distinct pieces of alert metadata displayed on the metadata selection user interface, wherein a total number of pieces of alert metadata included in the subset is less than the total number of the plurality of distinct pieces of alert metadata included in the asset alert, wherein:
the alert metadata indicative of the operating state of the industrial asset corresponds to the subset selected by the one or more user inputs; and
the asset diagnostic prompt is automatically constructed in response to detecting the one or more user inputs.

7. The computer-program product according to claim 1, wherein:
extracting the alert metadata from the asset alert includes:
determining that the asset alert generated by the anomaly detection algorithm corresponds to a respective asset alert type of a plurality of predefined asset alert types;
querying an asset alert type-to-asset diagnostic prompt data table using the respective asset alert type of the asset alert as a query parameter, wherein the asset alert type-to-asset diagnostic prompt data table associates each distinct asset alert type of the plurality of predefined asset alert types to a distinct set of prompt construction instructions; and
retrieving, from the asset alert type-to-asset diagnostic prompt data table, the distinct set of prompt construction instructions corresponding to the respective asset alert type of the asset alert in response to the querying of the asset alert type-to-asset diagnostic prompt data table; and
the asset diagnostic prompt is automatically constructed according to the distinct set of prompt construction instructions retrieved from the asset alert type-to-asset diagnostic prompt data table that corresponds to the respective asset alert type of the asset alert.

8. The computer-program product according to claim 7, wherein the distinct set of prompt construction instructions retrieved from the asset alert type-to-asset diagnostic prompt data table that corresponds to the respective asset alert type of the asset alert includes:
the set of model instructions that instruct the large language model to perform the diagnostic assessment of the anomalous state, and
a set of metadata extraction instructions that specifies the alert metadata to extract from the asset alert.

9. The computer-program product according to claim 1, wherein:
extracting the alert metadata from the asset alert includes:
determining that the asset alert generated by the anomaly detection algorithm corresponds to a respective asset alert type of a plurality of predefined asset alert types;
querying an asset alert type-to-asset diagnostic prompt template repository using the respective asset alert type of the asset alert as a query parameter, wherein the asset alert type-to-asset diagnostic prompt template repository associates each distinct asset alert type of the plurality of predefined asset alert types to a distinct asset diagnostic prompt template; and
retrieving, from the asset alert type-to-asset diagnostic prompt template repository, the distinct asset diagnostic prompt template that corresponds to the respective asset alert type of the asset alert in response to the querying of the asset alert type-to-asset diagnostic prompt template repository; and
the asset diagnostic prompt is automatically constructed based in part on the distinct asset diagnostic prompt template retrieved from the asset alert type-to-asset diagnostic prompt template repository that corresponds to the respective asset alert type of the asset alert.

10. The computer-program product according to claim 9, wherein:
the distinct asset diagnostic prompt template retrieved from the asset alert type-to-asset diagnostic prompt template repository that corresponds to the respective asset alert type of the asset alert includes:
the set of model instructions that instruct the large language model to perform the diagnostic assessment of the anomalous state, and
a set of asset diagnostic input data fields, wherein each distinct asset diagnostic input data field of the set of asset diagnostic input data fields is associated with a respective operating characteristic of the industrial asset, and
the asset diagnostic prompt is automatically constructed by inserting a corresponding sensor value included in the alert metadata into each asset diagnostic input data field of the set of asset diagnostic input data fields.

11. The computer-program product according to claim 1, wherein the enriched asset alert further includes a text string specifying:
one or more original equipment manufacturer (OEM) instructions for performing the one or more recommended asset maintenance tasks, and
a version of an OEM maintenance manual in which the one or more OEM instructions are documented.

12. The computer-program product according to claim 1, wherein the one or more asset maintenance data collections include:
a maintenance manual data collection that includes a tokenized representation of one or more unstructured maintenance manuals created for the industrial asset and an embedding-based representation of the one or more unstructured maintenance manuals,
a maintenance record data collection that includes a tokenized representation of a plurality of historical unstructured maintenance events performed on the industrial asset and an embedding-based representation of the plurality of historical unstructured maintenance events, and
a crowd-sourced data collection that includes a tokenized representation of content sourced from one or more web-based discussion platforms associated with diagnosing, troubleshooting, and repairing the industrial asset and an embedding-based representation of the content sourced from the one or more web-based discussion platforms.

13. The computer-program product according to claim 12, wherein:
the content sourced from the one or more web-based discussion platforms is not documented in the one or more unstructured maintenance manuals.

14. The computer-program product according to claim 12, wherein the computer instructions, when executed by the one or more processors, perform operations further comprising:
transmitting, using an application programming interface (API), the asset diagnostic prompt to an alert enrichment service; and
in response to the alert enrichment service receiving the asset diagnostic prompt, querying the one or more asset maintenance data collections, wherein querying the one or more asset maintenance data collections includes:
transmitting, to a first distinct API endpoint associated with the maintenance manual data collection, a first alert enrichment request to query the maintenance manual data collection based on the embedding value of the asset diagnostic prompt;
transmitting, to a second distinct API endpoint associated with the maintenance record data collection, a second alert enrichment request to query the maintenance record data collection based on the embedding value of the asset diagnostic prompt; and
transmitting, to a third distinct API endpoint associated with the crowd-sourced data collection, a third alert enrichment request to query the crowd-sourced data collection based on the embedding value of the asset diagnostic prompt.

15. The computer-program product according to claim 14, wherein the computer instructions, when executed by the one or more processors, perform operations further comprising:
in response to transmitting the first alert enrichment request to the first distinct API endpoint, retrieving a set of maintenance manual data items included in the maintenance manual data collection that relate to the asset diagnostic prompt,
in response to transmitting the second alert enrichment request to the second distinct API endpoint, retrieving a set of maintenance record data items included in the maintenance record data collection that relate to the asset diagnostic prompt, and
in response to transmitting the third alert enrichment request to the third distinct API endpoint, retrieving a set of crowd-sourced data items included in the crowd-sourced data collection that relate to the asset diagnostic prompt, wherein the set of asset maintenance data items related to the asset diagnostic prompt includes the set of maintenance manual data items, the set of maintenance record data items, and the set of crowd-sourced data items.

16. The computer-program product according to claim 1, wherein the computer instructions, when executed by the one or more processors, perform operations further comprising:
instantiating an asset diagnostic graphical user interface that includes:
the alert metadata indicative of the operating state of the industrial asset at the time the anomaly detection algorithm generated the asset alert,
the one or more components of the industrial asset contributing to the anomalous state,
the one or more recommended asset maintenance tasks for mitigating the anomalous state, and
a source identification data table that indicates, for each component of the one or more components of the industrial asset contributing to the anomalous state and each recommended asset maintenance task of the one or more recommended asset maintenance tasks for mitigating the anomalous state, a respective asset maintenance data collection of the one or more asset maintenance data collections used by the large language model to predict that specific component or recommended asset maintenance task.

17. The computer-program product according to claim 16, wherein the computer instructions, when executed by the one or more processors, perform operations further comprising:
receiving, at a digital assistant interface of the asset diagnostic graphical user interface, a natural language query specifying a maintenance-related question associated with the industrial asset;
querying the one or more asset maintenance data collections based on an embedding value of the natural language query;
retrieving, from the one or more asset maintenance data collections, a corpus of maintenance data items related to the natural language query in response to the querying of the one or more asset maintenance data collections based on the embedding value of the natural language query;
generating, based on providing the natural language query and the corpus of maintenance data items to the large language model, a response to the natural language query; and
displaying the response generated by the large language model within the digital assistant interface of the asset diagnostic graphical user interface.

18. The computer-program product according to claim 16, wherein:
the asset diagnostic inference further includes one or more strings of text specifying a set of suspected root causes contributing to the anomalous state, and
the asset diagnostic graphical user interface further includes the set of suspected root causes.

19. The computer-program product according to claim 1, wherein the computer instructions, when executed by the one or more processors, perform operations further comprising:
generating a digital work order in response to assessing the enriched asset alert, wherein:
the digital work order includes one or more asset maintenance tasks that, when performed on the industrial asset, mitigates the anomalous state associated with the industrial asset, and
a specified time window within which the one or more asset maintenance tasks are to be performed on the industrial asset,
and
in response to generating the digital work order, transmitting, over a computer network, the digital work order to a target entity to perform the one or more asset maintenance tasks.

20. The computer-program product according to claim 1, wherein the computer instructions, when executed by the one or more processors, perform operations further comprising:
foregoing adapting the asset alert to the enriched asset alert when the asset diagnostic inference generated by the large language model is routed to a second large language model, wherein the second large language model is different than the large language model that generated the asset diagnostic inference;
routing, to the second large language model, the asset diagnostic inference generated by the large language model;
generating, by the second large language model, a revised asset diagnostic inference in response to the second large language model assessing the asset diagnostic inference generated by the large language model; and
augmenting the asset alert to an augmented asset alert based on the revised asset diagnostic inference generated by the second large language model.

21. The computer-program product according to claim 20, wherein:
the revised asset diagnostic inference includes a revised set of components contributing to the anomalous state when compared to the one or more components included in the asset diagnostic inference generated by the large language model,
the augmented asset alert includes the revised set of components, and
transmitting, over a computer network, the augmented asset alert to a target entity.

22. The computer-program product according to claim 21, wherein:
the revised set of components includes one of an additional set of components, a reduced set of components, and a different set of components when compared to the one or more components included in the asset diagnostic inference generated by the large language model.

23. The computer-program product according to claim 20, wherein:
the revised asset diagnostic inference includes a revised set of recommended asset maintenance tasks for mitigating the anomalous state when compared to the one or more recommended asset maintenance tasks included in the asset diagnostic inference generated by the large language model,
the augmented asset alert includes the revised set of recommended asset maintenance tasks, and
transmitting, over a computer network, the augmented asset alert to a target entity.

24. The computer-program product according to claim 23, wherein:
the revised set of recommended asset maintenance tasks includes one of an additional set of recommended asset maintenance tasks, a reduced set of recommended asset maintenance tasks, and a different set of recommended asset maintenance tasks when compared to the one or more recommended asset maintenance tasks included in the asset diagnostic inference generated by the large language model.

25. The computer-program product according to claim 1, wherein the computer instructions, when executed by the one or more processors, perform operations further comprising:
in response to adapting the asset alert to the enriched asset alert, transmitting, in real-time or near real-time, the enriched asset alert to a target entity.

26. A computer-implemented method comprising:
at a first stage of a predictive maintenance pipeline:
receiving sensor data captured by a set of sensors associated with an industrial asset;
generating, by an anomaly detection application of the predictive maintenance pipeline, an asset alert that indicates the industrial asset is operating or will operate in an anomalous state based on the anomaly detection application assessing the sensor data; and
in response to the anomaly detection application generating the asset alert, routing the asset alert to an alert diagnostic and maintenance planning application of the predictive maintenance pipeline;
at a second stage of the predictive maintenance pipeline:
constructing, by the alert diagnostic and maintenance planning application, an asset diagnostic prompt in response to routing the asset alert to the alert diagnostic and maintenance planning application; and
invoking, by the alert diagnostic and maintenance planning application, a retrieval-augmented-generation (RAG) service of the predictive maintenance pipeline using an application programming interface (API); and
at a third stage of the predictive maintenance pipeline:
retrieving, by the RAG service, a set of asset maintenance data items related to the asset diagnostic prompt in response to querying one or more asset maintenance data collections;
generating, based on providing the asset diagnostic prompt and the set of asset maintenance data items to a large language model of the RAG service, an asset diagnostic inference that includes (i) one or more components of the industrial asset contributing to the anomalous state and (ii) one or more recommended asset maintenance tasks for mitigating the anomalous state; and
adapting, by the RAG service, the asset alert to an enriched asset alert that includes the one or more components of the industrial asset contributing to the anomalous state and the one or more recommended asset maintenance task.

27. The computer-implemented method according to claim 26, further comprising:
in response to adapting the asset alert to the enriched asset alert, transmitting, using the API, the enriched asset alert to the alert diagnostic and maintenance planning application of the predictive maintenance pipeline.

28. The computer-implemented method according to claim 26, wherein:
constructing the asset diagnostic prompt includes extracting alert metadata from the asset alert that is indicative of an operating state of the industrial asset at a time the anomaly detection application generated the asset alert,
the asset diagnostic prompt includes at least a set of model instructions instructing the large language model to perform a diagnostic assessment of the anomalous state associated with the industrial asset and the alert metadata extracted from the asset alert,
the querying of the one or more asset maintenance data collections is commenced in response to the alert diagnostic and maintenance planning application invoking the RAG service, and
the RAG service automatically queries the one or more asset maintenance data collections based on an embedding value of the asset diagnostic prompt.

29. A computer-implemented system comprising:
one or more processors;
a memory;
a computer-readable medium operably coupled to the one or more processors, the computer-readable medium having computer-readable instructions stored thereon that, when executed by the one or more processors, cause a computing device to perform operations comprising:
obtaining sensor data captured by a set of sensors associated with an industrial asset;
generating, by an anomaly detection algorithm, an asset alert that indicates the industrial asset is operating or will operate in an anomalous state based on the anomaly detection algorithm assessing the sensor data;
extracting, from the asset alert, alert metadata indicative of an operating state of the industrial asset at a time the anomaly detection algorithm generated the asset alert;
in response to extracting the alert metadata from the asset alert:
constructing an asset diagnostic prompt that includes the alert metadata and a set of model instructions instructing a large language model to perform a diagnostic assessment of the anomalous state;
querying one or more asset maintenance data collections based on an embedding value of the asset diagnostic prompt;
retrieving, from the one or more asset maintenance data collections, a set of asset maintenance data items related to the asset diagnostic prompt in response to the querying of the one or more asset maintenance data collections; and
generating, based on providing the asset diagnostic prompt and the set of asset maintenance data items to the large language model, an asset diagnostic inference that includes (i) one or more components of the industrial asset contributing to the anomalous state and (ii) one or more recommended asset maintenance tasks for mitigating the anomalous state; and
adapting the asset alert to an enriched asset alert that includes the one or more components of the industrial asset contributing to the anomalous state and the one or more recommended asset maintenance tasks.

30. The computer-implemented system according to claim 29, wherein:
the industrial asset corresponds to a physical apparatus operably configured to perform one or more tasks in a real-world environment,
the industrial asset includes a set of mechanical components, a set of electrical components, and a set of digitally controlled components that operate together to perform the one or more tasks in the real-world environment, and
the one or more components of the industrial asset contributing to the anomalous state includes at least one mechanical component of the set of mechanical components or at least one electrical component of the set of electrical components.
